(19) United States
(12) Patent Application Publication
(10) Pub. No.: US 2023/0323230 A1
(43) Pub. Date: Oct. 12, 2023

(54) PROCESSES AND SYSTEMS FOR PRODUCING BIOCOKE IN A KINETIC INTERFACE REACTOR, AND BIOCOKE PRODUCED THEREFROM

(71) Applicant: Carbon Technology Holdings, LLC, Oakdale, MN (US)

(72) Inventors: James A. Mennell, Brighton, UT (US); Daren Daugaard, Newburg, MO (US); Dustin Slack, Gwinn, MI (US)

(21) Appl. No.: 18/121,047

(22) Filed: Mar. 14, 2023

Related U.S. Application Data
(60) Provisional application No. 63/320,050, filed on Mar. 15, 2022.

(51) Int. Cl. C10L 5/44; B01J 6/00

(52) U.S. Cl. CPC C10L 5/447; B01J 6/008; C10L 2290/02; C10L 2290/12

(57) ABSTRACT

A process for producing biocoke is provided, comprising: providing a heated biogas stream comprising carbon-containing vapors; providing a kinetic interface media, in solid form; introducing the kinetic interface media and the heated biogas stream to a kinetic interface reactor, operated to convert at least some of the carbon-containing vapors to biocoke; removing the solid biocoke-containing kinetic interface media from the kinetic interface reactor; and recovering the solid biocoke-containing kinetic interface media. Other variations provide a process for producing biocoke, comprising: providing a bioliquid stream comprising carbon-containing liquids; providing a kinetic interface media, in solid form; introducing the kinetic interface media and the bioliquid stream to a kinetic interface reactor, operated to convert at least some of the carbon-containing liquids to biocoke; removing the solid biocoke-containing kinetic interface media from the kinetic interface reactor; and recovering the solid biocoke-containing kinetic interface media. Many embodiments are described.

### CROSS-REFERENCE TO RELATED APPLICATION

This application claims the priority benefit of U.S. Provisional Patent Application No. 63/320,050, filed on Mar. 15, 2022, which is incorporated by reference herein in its entirety.

### TECHNICAL FIELD

The present invention generally relates to processes and systems for making biocoke, and biocoke compositions obtained therefrom.

### BACKGROUND

Conventionally, coke is a hard, black form of coal that contains about 80-90 wt % carbon. Coke has many industrial uses, including metallurgical coke for metal making, such as for steel production. Coke has commercially been made from destructive distillation in which coal is heated in the absence of air.

Coke is used in foundries, the production of ferroalloys, the production of calcium carbide from calcium oxide, and as a fuel for providing energy. Coke can play an energy role, providing process heat; a chemical role, as an elemental carbon source for reduction of metal ores or for carburization of metals; or a physical role, as a support for charge materials, gas permeability of bed, or liquid metal drainage. For example, foundry coke is used as a supporting matrix, a reducing agent, and an energy carrier during the pig iron manufacturing process.

Due to rising economic, environmental, and social costs associated with fossil resources such as coal, there is a need in the field for technology providing for the use of renewable biomass to produce coke and similar carbon products.

### SUMMARY

Some variations of the disclosed technology provide a process for producing biocoke, the process comprising:
providing a heated biogas stream, wherein the heated biogas stream comprises a carbon-containing vapor;
providing a kinetic interface media, wherein the kinetic interface media is in solid form;
introducing the kinetic interface media and the heated biogas stream to a kinetic interface reactor;

converting, using the kinetic interface reactor, the carbon-containing vapor to biocoke, wherein the biocoke contains at least 75 wt % fixed carbon, wherein total carbon within the biocoke is at least 50% renewable as determined from a measurement of the ¹⁴C/¹²C isotopic ratio of the total carbon, and wherein the biocoke is chemically or physically combined with the kinetic interface media, thereby forming a solid biocoke-containing kinetic interface media;
removing the solid biocoke-containing kinetic interface media from the kinetic interface reactor; and
recovering the solid biocoke-containing kinetic interface media.

In some embodiments, the kinetic interface media is in the form of pellets. The pellets can be characterized by an average pellet effective diameter of at least about 1 millimeter to at most about 10 centimeters.

In some embodiments, the kinetic interface media is in the form of a powder. The powder can be characterized by an average particle size of at least about 1 micron to at most about 500 microns.

In some embodiments, the kinetic interface media is in the form of granules. The granules can be characterized by an average granule effective diameter of at least about 100 microns to at most about 10 millimeters.

In some embodiments, the kinetic interface media has a bed depth of at least about 10 centimeters to at most about 10 meters, within the kinetic interface reactor.

The kinetic interface media can comprise a pyrolyzed form of a first biomass feedstock. In some embodiments, the first biomass feedstock comprises softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments, the kinetic interface media comprises a raw biomass feedstock. The raw biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments, the kinetic interface media comprises a mixture of raw biomass feedstock and pyrolyzed biomass feedstock.

In some embodiments, the kinetic interface media comprises a previously formed biocoke, or another previously formed source of carbon.

In some embodiments, the process further comprises generating the heated biogas stream by pyrolyzing a second biomass feedstock, wherein the carbon-containing vapor comprises a pyrolysis vapor. The second biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments, the kinetic interface media comprises a pyrolyzed form of a first biomass feedstock, the heated biogas stream is generated during pyrolysis of the first biomass feedstock, and the kinetic interface media and the heated biogas stream are obtained from a common pyrolysis reactor.

In some embodiments, wherein the heated biogas stream comprises CO, CO₂, an alkane (e.g., methane), an olefin (e.g., ethylene), an aromatic (e.g., xylenes), an aldehyde (e.g., formaldehyde), a ketone (e.g., acetone), an acid (e.g., acetic acid), an alcohol (e.g., methanol), or a combination thereof.

In some embodiments, during the converting step, the biocoke forms on the surface of the kinetic interface media. Alternatively, or additionally, during the converting step, the biocoke forms in an internal phase of the kinetic interface media.

In some embodiments, during the converting step, effective reaction conditions comprise a coking temperature of at least about 400° C. to at most about 1200° C.

In some embodiments, during the converting step, effective reaction conditions comprise a coking pressure of at least about 1 bar to at most about 40 bar.

In some embodiments, during the converting step, effective reaction conditions comprise a coking vapor-phase residence time of at least about 1 second to at most about 1 hour.

In some embodiments, during the converting step, effective reaction conditions comprise a coking solid-phase residence time of at least about 1 minute to at most about 24 hours.

In some embodiments, during the converting step, effective reaction conditions comprise a kinetic interface media residence time of at least about 1 minute to at most about 24 hours.

In some embodiments, during the converting step, effective reaction conditions comprise coking reactions that are seeded by the kinetic interface media as a reaction matrix. In these embodiments, the kinetic interface media seeds or initiates carbon growth but does not function as a true catalyst.

In some embodiments, during the converting step, effective reaction conditions comprise coking reactions that are catalyzed by the kinetic interface media.

In certain embodiments, during the converting step, effective reaction conditions comprise coking reactions that are both catalyzed by, and seeded by, the kinetic interface media.

In some embodiments, during the converting step, effective reaction conditions comprise coking reactions that are catalyzed by a separate coking catalyst, other than the kinetic interface media, introduced to the kinetic interface reactor.

In some embodiments, the carbon conversion of the carbon-containing vapor is at least 25%, in the step of converting the carbon-containing vapor to biocoke. In certain embodiments, this carbon conversion is at least 50%, at least 75%, or at least 90%.

In some embodiments, the process further comprises separating the solid biocoke-containing kinetic interface media into a biocoke-rich product and a recovered kinetic interface media. The recovered kinetic interface media is optionally recycled, at least in part, to the kinetic interface reactor. The biocoke-rich product can be stored, sold, shipped, converted to another product, or otherwise used.

In some embodiments, the process further comprises conveying at least some of the solid biocoke-containing kinetic interface media to a pyrolysis reactor; and generating pyrolyzed solid biocoke-containing kinetic interface media. The pyrolyzed solid biocoke-containing kinetic interface media can be introduced back to the kinetic interface reactor, via an inlet.

In some embodiments, the process further comprises recovering a kinetic interface reactor off-gas stream comprising unconverted carbon-containing vapor.

The kinetic interface reactor off-gas stream can be combusted, thereby generating energy. Some embodiments utilize the energy to heat a pyrolysis reactor, such as a pyrolysis reactor configured to provide a pyrolyzed form of a biomass feedstock as kinetic interface media for the kinetic interface reactor.

Alternatively, or additionally, the kinetic interface reactor off-gas stream can be partially oxidized, thereby generating a reducing gas containing at least H₂ and/or CO.

In some embodiments, the process further comprises removing, during or after the recovering step, at least some of the biocoke from the solid biocoke-containing kinetic interface media, thereby forming a regenerated kinetic interface media; and recycling the regenerated kinetic interface media to an inlet of the kinetic interface reactor.

In some embodiments, the process further comprises removing, during or after the recovering step, at least some of the biocoke from the solid biocoke-containing kinetic interface media, thereby forming a regenerated kinetic interface media comprising carbon; and conveying the regenerated kinetic interface media to a pyrolysis reactor.

In various processes, the kinetic interface reactor is a fluidized-bed reactor, a falling-bed reactor, a gravity-driven vessel, a vertical vessel, a slanted vessel, a horizontal vessel, a rotary kiln, or a combination thereof, for example. When the kinetic interface reactor is a rotary kiln, the rotary kiln can be configured such that the kinetic interface media tumbles radially and the heated biogas stream flows axially.

In some embodiments, the kinetic interface reactor is configured with a mechanical conveyor. The mechanical conveyor can introduce the kinetic interface media into the kinetic interface reactor, or convey the kinetic interface media through the kinetic interface reactor, or both of these. Additionally, or alternatively, the mechanical conveyor can convey the solid biocoke-containing kinetic interface media out of the kinetic interface reactor, in the removing step. The mechanical conveyor can be a screw conveyor, a belt conveyor, a chain conveyor, a continuous-flow conveyor, a recirculating conveyor, or a combination thereof.

In some embodiments utilizing a heated biogas stream, the removing step is conducted continuously or semi-continuously. The removing step can be conducted immediately following the forming the solid biocoke-containing kinetic interface media. In other embodiments, there is a build-up of solid biocoke-containing kinetic interface media, and the removing step is conducted periodically or intermittently. In some embodiments utilizing a bioliquid stream, the removing step is conducted batch-wise. Whether the removing step is continuous, semi-continuous, or batch, it can be desired that the process does not result in a spatially continuous solid mass filled within the kinetic interface reactor.

In some processes, the kinetic interface media comprises at least about 25 wt % total carbon, at least about 50 wt % total carbon, or at least about 75 wt % total carbon.

In some processes, the solid biocoke-containing kinetic interface media comprises at least about 50 wt % fixed carbon, at least about 75 wt % fixed carbon, or at least about 90 wt % fixed carbon.

In some processes, the biocoke comprises at least about 80 wt % fixed carbon, at least about 90 wt % fixed carbon, at least about 95 wt % fixed carbon, or at least about 99 wt % fixed carbon. In some embodiments, the biocoke has a higher total carbon content than the kinetic interface media.

The total carbon within the biocoke can be at least about 75% renewable as determined from a measurement of the ¹⁴C/¹²C isotopic ratio of the total carbon. In some embodiments, the total carbon within the biocoke is at least about 90% renewable as determined from a measurement of the ¹⁴C/¹²C isotopic ratio of the total carbon. In certain embodiments, the total carbon within the biocoke is fully renewable as determined from a measurement of the ¹⁴C/¹²C isotopic ratio of the total carbon.

The solid biocoke-containing kinetic interface media generally has a different composition, including carbon content, compared to the biocoke itself. The total carbon within the solid biocoke-containing kinetic interface media can be at least about 50% renewable as determined from a measurement of the ¹⁴C/¹²C isotopic ratio of the total carbon. In some embodiments, the total carbon within the solid biocoke-containing kinetic interface media is at least about 90% renewable as determined from a measurement of the ¹⁴C/¹²C isotopic ratio of the total carbon. In certain embodiments, the total carbon within the solid biocoke-containing kinetic interface media is fully renewable as determined from a measurement of the ¹⁴C/¹²C isotopic ratio of the total carbon.

In some embodiments, the biocoke comprises essentially no ash. In these or other embodiments, the biocoke has a lower ash content than the kinetic interface media.

In some embodiments, the process further comprises generating free biocoke particles from the carbon-containing vapor, wherein the free biocoke particles are not chemically or physically combined with the kinetic interface media. The free biocoke particles can be derived only from the carbon-containing vapor and not directly from the kinetic interface media. Alternatively, when the kinetic interface media comprises carbon, the free biocoke particles can be derived both from the carbon-containing vapor and from the kinetic interface media. In some embodiments in which free biocoke particles are generated from the carbon-containing vapor, formation of the free biocoke particles is catalyzed or seeded by the kinetic interface media.

In some processes, a carbonization agent is added at one or more steps. The carbonization agent can comprise a metal, metal alloy, metal oxide, metal hydroxide, metal hydride, metal sulfide, metal nitride, metal halide, metal salt, mineral, natural polymer, synthetic polymer, acid, base, metal salt, non-metal salt, organic halide, inorganic halide, or a derivative or a combination thereof.

In other variations of the technology, a process for producing biocoke comprises:
providing a bioliquid stream, wherein the bioliquid stream comprises a carbon-containing liquid;
providing a kinetic interface media, wherein the kinetic interface media is in solid form;
introducing the kinetic interface media and the bioliquid stream to a kinetic interface reactor;
converting, using the kinetic interface reactor, the carbon-containing liquid to biocoke, wherein the biocoke contains at least 75 wt % fixed carbon, wherein total carbon within the biocoke is at least 50% renewable as determined from a measurement of the ¹⁴C/¹²C isotopic ratio of the total carbon, and wherein the biocoke is chemically or physically combined with the kinetic interface media, thereby forming a solid biocoke-containing kinetic interface media;
removing the solid biocoke-containing kinetic interface media from the kinetic interface reactor; and
recovering the solid biocoke-containing kinetic interface media.

In some embodiments utilizing a bioliquid stream, the kinetic interface media is in the form of pellets. The pellets can be characterized by an average pellet effective diameter of at least about 1 millimeter to at most about 10 centimeters.

In some embodiments utilizing a bioliquid stream, the kinetic interface media is in the form of a powder. The powder can be characterized by an average particle size of at least about 1 micron to at most about 500 microns.

In some embodiments utilizing a bioliquid stream, the kinetic interface media is in the form of granules. The granules can be characterized by an average granule effective diameter of at least about 100 microns to at most about 10 millimeters.

In some embodiments utilizing a bioliquid stream, the kinetic interface media has a bed depth of at least about 10 centimeters to at most about 10 meters, within the kinetic interface reactor.

In some embodiments utilizing a bioliquid stream, the kinetic interface is a pyrolyzed form of a first biomass feedstock. The first biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments utilizing a bioliquid stream, the kinetic interface media comprises a raw biomass feedstock. The raw biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments utilizing a bioliquid stream, the kinetic interface media comprises a mixture of a raw biomass feedstock and a pyrolyzed biomass feedstock. In these embodiments, the pyrolyzed biomass can be from the same type of feedstock as the raw biomass (e.g., pine and pyrolyzed pine), or they can be from different types of feedstock (e.g., unpyrolyzed pine and pyrolyzed corn stover).

In some embodiments utilizing a bioliquid stream, the kinetic interface media comprises a previously formed biocoke.

In some embodiments utilizing a bioliquid stream, the process further comprises generating the bioliquid stream from pyrolysis of a second biomass feedstock. The second biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof. The bioliquid stream can comprise condensed pyrolysis vapor, pyrolysis liquids (e.g., tars) that are not from vapor condensation, or a combination thereof.

In some embodiments utilizing a bioliquid stream, the bioliquid stream is generated from pyrolysis of the first biomass feedstock, and the kinetic interface media and the bioliquid stream are obtained from a common pyrolysis reactor.

The bioliquid stream can comprise one or more alkanes, olefins, aromatics, aldehydes, ketones, acids, alcohols, or a combination thereof. The bioliquid stream can contain tars, lignin, and/or high-molecular-weight components from biomass pyrolysis.

In some embodiments utilizing a bioliquid stream, during the converting step, the biocoke forms on the surface of the kinetic interface media. In these or other embodiments, during the converting step, the biocoke forms in an internal phase of the kinetic interface media.

In some embodiments utilizing a bioliquid stream, during the converting step, effective reaction conditions comprise a coking temperature of at least about 400° C. to at most about 1200° C.

In some embodiments utilizing a bioliquid stream, during the converting step, effective reaction conditions comprise a coking pressure of at least about 1 bar to at most about 40 bar.

In some embodiments utilizing a bioliquid stream, during the converting step, effective reaction conditions comprise a coking liquid-phase residence time of at least about 1 minute to at most about 1 hour.

In some embodiments utilizing a bioliquid stream, during the converting step, effective reaction conditions comprise a coking solid-phase residence time of at least about 1 minute to at most about 24 hours.

In some embodiments utilizing a bioliquid stream, during the converting step, effective reaction conditions comprise a kinetic interface media residence time of at least about 1 minute to at most about 24 hours.

In some embodiments utilizing a bioliquid stream, during the converting step, effective reaction conditions comprise coking reactions that are seeded by the kinetic interface media as a reaction matrix.

In some embodiments utilizing a bioliquid stream, during the converting step, effective reaction conditions comprise coking reactions that are catalyzed by the kinetic interface media.

In some embodiments utilizing a bioliquid stream, during the converting step, effective reaction conditions comprise coking reactions that are catalyzed by a separate coking catalyst, other than the kinetic interface media, introduced to the kinetic interface reactor.

The carbon conversion of the carbon-containing liquid can be at least 25%, in the step of converting the carbon-containing liquid to biocoke. In some embodiments, the carbon conversion is at least 50%, at least 75%, or at least 90%.

In some processes utilizing a bioliquid stream, the process further comprises separating the solid biocoke-containing kinetic interface media into a biocoke-rich product and a recovered kinetic interface media.

In some processes utilizing a bioliquid stream, the process further comprises conveying at least some of the solid biocoke-containing kinetic interface media to a pyrolysis reactor; and generating pyrolyzed solid biocoke-containing kinetic interface media. The pyrolyzed solid biocoke-containing kinetic interface media can be, in turn, recycled to an inlet to the kinetic interface reactor.

In some processes utilizing a bioliquid stream, the process further comprises recovering a kinetic interface reactor off-gas stream. The kinetic interface reactor off-gas stream can be combusted, thereby generating energy. The energy can be utilized to heat a pyrolysis reactor configured to provide the kinetic interface media as a pyrolyzed form of a biomass feedstock. Alternatively, or additionally, the kinetic interface reactor off-gas stream can be partially oxidized, thereby generating a reducing gas.

In some processes utilizing a bioliquid stream, the process further comprises removing, during or after the recovering step, at least some of the biocoke from the solid biocoke-containing kinetic interface media, thereby forming a regenerated kinetic interface media; and recycling the regenerated kinetic interface media to an inlet of the kinetic interface reactor.

In some processes utilizing a bioliquid stream, the process further comprises removing, during or after the recovering step, at least some of the biocoke from the solid biocoke-containing kinetic interface media, thereby forming a regenerated kinetic interface media comprising carbon; and conveying the regenerated kinetic interface media to a pyrolysis reactor.

In various embodiments utilizing a bioliquid stream, the kinetic interface reactor is a fluidized-bed reactor, a falling-bed reactor, a gravity-driven vessel, a vertical vessel, a slanted vessel, a horizontal vessel, a rotary kiln, or a combination thereof (e.g., a gravity-driven vertical falling-bed vessel). When the kinetic interface reactor is a rotary kiln, the rotary kiln can be configured such that the kinetic interface media tumbles radially and the bioliquid stream flows axially.

In some embodiments utilizing a bioliquid stream, the kinetic interface reactor is configured with a mechanical conveyor. The mechanical conveyor can introduce the kinetic interface media into the kinetic interface reactor, or convey the kinetic interface media through the kinetic interface reactor, or both of these. Additionally, or alternatively, the mechanical conveyor can convey the solid biocoke-containing kinetic interface media out of the kinetic interface reactor, in the removing step. The mechanical conveyor can be a screw conveyor, a belt conveyor, a chain conveyor, a continuous-flow conveyor, a recirculating conveyor, or a combination thereof.

In some embodiments utilizing a bioliquid stream, the removing step is conducted continuously or semi-continuously. The removing step can be conducted immediately following the forming the solid biocoke-containing kinetic interface media. In other embodiments, there is a build-up of solid biocoke-containing kinetic interface media, and the removing step is conducted periodically or intermittently. In some embodiments utilizing a bioliquid stream, the removing step is conducted batch-wise. Whether the removing step is continuous, semi-continuous, or batch, it can be desirable that the process does not result in a spatially continuous solid mass filled within the kinetic interface reactor.

In some processes utilizing a bioliquid stream, the kinetic interface media comprises at least about 25 wt % total carbon, at least about 50 wt % total carbon, or at least about 75 wt % total carbon.

In some processes utilizing a bioliquid stream, the solid biocoke-containing kinetic interface media comprises at least about 50 wt % fixed carbon, at least about 75 wt % fixed carbon, or at least about 90 wt % fixed carbon.

In some processes utilizing a bioliquid stream, the biocoke comprises at least about 80 wt % fixed carbon, at least about 90 wt % fixed carbon, at least about 95 wt % fixed carbon, or at least about 99 wt % fixed carbon. In certain embodiments, the biocoke has a higher total carbon content than the kinetic interface media.

The total carbon within the biocoke can be at least about 75% renewable as determined from a measurement of the ¹⁴C/¹²C isotopic ratio of the total carbon. In some process utilizing a bioliquid stream, the total carbon within the biocoke is at least about 90% renewable as determined from a measurement of the ¹⁴C/¹²C isotopic ratio of the total carbon. In certain embodiments, the total carbon within the biocoke is fully renewable as determined from a measurement of the ¹⁴C/¹²C isotopic ratio of the total carbon.

In processes utilizing a bioliquid stream, the solid biocoke-containing kinetic interface media generally has a different composition, including carbon content, compared to the biocoke itself. The total carbon within the solid biocoke-containing kinetic interface media can be at least about 50% renewable as determined from a measurement of the ¹⁴C/¹²C isotopic ratio of the total carbon. In some embodiments, the total carbon within the solid biocoke-containing kinetic interface media is at least about 90% renewable as determined from a measurement of the ¹⁴C/¹²C isotopic ratio of the total carbon. In certain embodiments, the total carbon within the solid biocoke-containing kinetic interface media is fully renewable as determined from a measurement of the ¹⁴C/¹²C isotopic ratio of the total carbon.

In some embodiments utilizing a bioliquid stream, the biocoke comprises essentially no ash. In these or other embodiments, the biocoke has a lower ash content than the kinetic interface media.

In some embodiments utilizing a bioliquid stream, the process further comprises generating free biocoke particles from the carbon-containing liquid, wherein the free biocoke particles are not chemically or physically combined with the kinetic interface media. The free biocoke particles can be derived only from the carbon-containing liquid and not directly from the kinetic interface media. Alternatively, when the kinetic interface media comprises carbon, the free biocoke particles can be derived both from the carbon-containing liquid and from the kinetic interface media. In some embodiments in which free biocoke particles are generated from the carbon-containing liquid, formation of the free biocoke particles is catalyzed or seeded by the kinetic interface media.

In some processes utilizing a bioliquid stream, a carbonization agent is added at one or more steps. The carbonization agent can comprise a metal, metal alloy, metal oxide, metal hydroxide, metal hydride, metal sulfide, metal nitride, metal halide, metal salt, mineral, natural polymer, synthetic polymer, acid, base, metal salt, non-metal salt, organic halide, inorganic halide, or a derivative or a combination thereof.

Biocoke products are provided by the disclosed technology. In some variations, a biocoke product is produced by a process comprising:
providing a heated biogas stream, wherein the heated biogas stream comprises a carbon-containing vapor;
providing a kinetic interface media, wherein the kinetic interface media is in solid form;
introducing the kinetic interface media and the heated biogas stream to a kinetic interface reactor;
converting, using the kinetic interface reactor, the carbon-containing vapor to biocoke, wherein the biocoke contains at least 75 wt % fixed carbon, wherein total carbon within the biocoke is at least 50% renewable as determined from a measurement of the ¹⁴C/¹²C isotopic ratio of the total carbon, and wherein the biocoke is chemically or physically combined with the kinetic interface media, thereby forming a solid biocoke-containing kinetic interface media;
removing the solid biocoke-containing kinetic interface media from the kinetic interface reactor; and
recovering a biocoke product from the solid biocoke-containing kinetic interface media.

In other variations, a biocoke product is produced by a process comprising:
providing a bioliquid stream, wherein the bioliquid stream comprises a carbon-containing liquid;
providing a kinetic interface media, wherein the kinetic interface media is in solid form;
introducing the kinetic interface media and the bioliquid stream to a kinetic interface reactor;
converting, using the kinetic interface reactor, the carbon-containing liquid to biocoke, wherein the biocoke contains at least 75 wt % fixed carbon, wherein total carbon within the biocoke is at least 50% renewable as determined from a measurement of the ¹⁴C/¹²C isotopic ratio of the total carbon, and wherein the biocoke is chemically or physically combined with the kinetic interface media, thereby forming a solid biocoke-containing kinetic interface media;
removing the solid biocoke-containing kinetic interface media from the kinetic interface reactor; and
recovering a biocoke product from the solid biocoke-containing kinetic interface media.

Still other variations provide a system for producing biocoke, wherein the system comprises:
a kinetic interface reactor;
a first inlet configured for feeding a heated biogas stream and/or a bioliquid stream into the kinetic interface reactor, wherein the heated biogas stream comprises a carbon-containing vapor, and wherein the bioliquid stream comprises a carbon-containing liquid;
a kinetic interface media contained within the kinetic interface reactor, wherein the kinetic interface media is in solid form, and wherein the kinetic interface reactor is configured to operate under effective reaction conditions to convert the carbon-containing vapor to biocoke that is chemically or physically combined with the kinetic interface media; and
a first outlet configured for withdrawing the biocoke.

In some systems, the first inlet is configured for feeding a heated biogas stream into the kinetic interface reactor. In other systems, the first inlet is configured for feeding a bioliquid stream into the kinetic interface reactor. In certain systems, the first inlet is configured for feeding a mixture of a heated biogas stream and a bioliquid stream (e.g., a supersaturated wet vapor stream) into the kinetic interface reactor. In certain systems, the first inlet is configured for feeding either a heated biogas stream or a bioliquid stream, or both, at different times, when the kinetic interface reactor is designed to operate on either a heated biogas stream, or a bioliquid stream, or a mixture thereof.

In some systems, the kinetic interface reactor is selected from a fluidized-bed reactor, a falling-bed reactor, a gravity-driven vessel, a vertical vessel, a slanted vessel, a horizontal vessel, a rotary kiln, or a combination thereof. In systems employing a rotary kiln as the kinetic interface reactor (or one of multiple kinetic interface reactors), the rotary kiln can be configured such that the kinetic interface media tumbles radially and the heated biogas stream and/or the bioliquid stream flows axially.

Some systems are configured with a mechanical conveyor to feed the kinetic interface media into and/or through and/or out of the kinetic interface reactor. The mechanical conveyor can be a screw conveyor, a belt conveyor, a chain conveyor, a continuous-flow conveyor, a recirculating conveyor, or a combination thereof.

Some variations of the technology provide a continuous process for producing biocoke, the continuous process comprising:
providing a heated biogas stream, wherein the heated biogas stream comprises carbon-containing vapor;
introducing the heated biogas stream to a kinetic interface reactor;
converting, using the kinetic interface reactor, the carbon-containing vapor to solid biocoke;
continuously withdrawing the solid biocoke;
continuously returning a recycled portion of the solid biocoke to the kinetic interface reactor, wherein the recycled portion of the solid biocoke is a kinetic interface media contained within the kinetic interface reactor; and
recovering the solid biocoke as a biocoke product, wherein the biocoke product contains at least 75 wt % fixed carbon, and wherein total carbon within the biocoke product is at least 50% renewable as determined from a measurement of the ¹⁴C/¹²C isotopic ratio of the total carbon,
wherein the process does not result in a spatially continuous solid mass filled within the kinetic interface reactor.

In some embodiments, the process further comprises generating the heated biogas stream by pyrolyzing a biomass feedstock, wherein the carbon-containing vapor is a pyrolysis vapor. The biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments, the carbon-containing vapor is selected from CO, CO₂, an alkane (e.g., ethane), an olefin (e.g., propylene), an aromatic (e.g., toluene), an aldehyde (e.g., acetaldehyde), a ketone (e.g., acetylacetone), an acid (e.g., formic acid), an alcohol (e.g., propanol), or a combination thereof.

In some embodiments, the kinetic interface media is in the form of pellets. The pellets can be characterized by an average pellet effective diameter of at least about 1 millimeter to at most about 10 centimeters.

In some embodiments, the kinetic interface media is in the form of a powder. The powder can be characterized by an average particle size of at least about 1 micron to at most about 500 microns.

In some embodiments, the kinetic interface media is in the form of granules. The granules can be characterized by an average granule effective diameter of at least about 100 microns to at most about 10 millimeters.

In some embodiments, during the converting step, the solid biocoke forms on the surface of the kinetic interface media. Alternatively, or additionally, during the converting step, the solid biocoke forms in an internal phase of the kinetic interface media.

In some embodiments, during the converting step, effective reaction conditions comprise a coking temperature of at least about 400° C. to at most about 1200° C.

In some embodiments, during the converting step, effective reaction conditions comprise a coking pressure of at least about 1 bar to at most about 40 bar.

In some embodiments, during the converting step, effective reaction conditions comprise a coking vapor-phase residence time of at least about 1 second to at most about 1 hour.

In some embodiments, during the converting step, effective reaction conditions comprise a coking solid-phase residence time of at least about 1 minute to at most about 24 hours.

In some embodiments, during the converting step, effective reaction conditions comprise a kinetic interface media residence time of at least about 1 minute to at most about 24 hours.

In some embodiments, during the converting step, effective reaction conditions comprise coking reactions that are seeded by the kinetic interface media as a reaction matrix. In these embodiments, the kinetic interface media seeds or initiates carbon growth but does not function as a true catalyst.

In some embodiments, during the converting step, effective reaction conditions comprise coking reactions that are catalyzed by the kinetic interface media.

In some embodiments, during the converting step, effective reaction conditions comprise coking reactions that are catalyzed by a separate coking catalyst, other than the kinetic interface media, introduced to the kinetic interface reactor. In certain embodiments, the separate coking catalyst is continuously or periodically regenerated for reuse in the kinetic interface reactor. For example, when the separate coking catalyst is an aluminosilicate, and the catalyst becomes inactivated by recalcitrant forms of carbon, oxidation in air can regenerate the catalyst.

In some embodiments, during the converting step, effective reaction conditions comprise uncatalyzed coking reactions that generate free biocoke particles from the carbon-containing vapor. In certain embodiments, the free biocoke particles do not become chemically or physically combined with the kinetic interface media. In other embodiments, the free biocoke particles, after being formed, become chemically or physically combined with the kinetic interface media.

In some embodiments, the carbon conversion of the carbon-containing vapor to solid biocoke is at least 25% in the converting step. In certain embodiments, the carbon conversion is at least 50%, at least 75%, or at least 90%.

In some embodiments, the process further comprises recovering a kinetic interface reactor off-gas stream comprising unconverted carbon-containing vapor. The kinetic interface reactor off-gas stream can be combusted with air or oxygen, thereby generating energy. The energy can be used to heat a pyrolysis reactor configured to provide the kinetic interface media, wherein the kinetic interface media comprises a pyrolyzed form of a first biomass feedstock. Alternatively, or additionally, the kinetic interface reactor off-gas stream can be partially oxidized with air or oxygen, thereby generating a reducing gas containing H₂ and/or CO.

In some embodiments, the kinetic interface reactor is a fluidized-bed reactor, a falling-bed reactor, a gravity-driven vessel, a vertical vessel, a slanted vessel, a horizontal vessel, or a rotary kiln. A rotary kiln can be configured such that the kinetic interface media tumbles radially and the heated biogas stream flows axially.

In some embodiments, the kinetic interface reactor is configured with a mechanical conveyor, such as to convey recycled biocoke to the kinetic interface reactor, to convey kinetic interface media through the kinetic interface reactor, and/or to convey solid biocoke product out of the kinetic interface reactor. The mechanical conveyor can be selected from a screw conveyor, a belt conveyor, a chain conveyor, a continuous-flow conveyor, or a recirculating conveyor, for example.

In some embodiments, the biocoke product comprises at least about 80 wt % fixed carbon, at least about 90 wt % fixed carbon, at least about 95 wt % fixed carbon, or at least about 99 wt % fixed carbon.

In some embodiments, total carbon within the biocoke product is at least about 75% renewable as determined from a measurement of the ¹⁴C/¹²C isotopic ratio of the total carbon. In certain embodiments, the total carbon within the biocoke product is at least about 90% renewable, or 100% (fully) renewable, as determined from a measurement of the ¹⁴C/¹²C isotopic ratio of the total carbon.

In some embodiments, the biocoke product comprises essentially no ash.

In some embodiments, in the recovering, the solid biocoke and the kinetic interface media are separated from each other.

In some embodiments, the process further comprises adding a carbonization agent, wherein the carbonization agent comprises a metal, metal alloy, metal oxide, metal hydroxide, metal hydride, metal sulfide, metal nitride, metal halide, metal salt, mineral, natural polymer, synthetic polymer, acid, base, metal salt, non-metal salt, organic halide, inorganic halide, or a derivative or a combination thereof.

Other variations of the technology provide a continuous process for producing biocoke, the continuous process comprising:
providing a bioliquid stream, wherein the bioliquid stream comprises carbon-containing liquid;
introducing the bioliquid stream to a kinetic interface reactor;
converting, using the kinetic interface reactor, the carbon-containing liquid to solid biocoke;
continuously withdrawing the solid biocoke;
continuously returning a recycled portion of the solid biocoke to the kinetic interface reactor, wherein the recycled portion of the solid biocoke is a kinetic interface media contained within the kinetic interface reactor; and
recovering the solid biocoke as a biocoke product, wherein the biocoke product contains at least 75 wt % fixed carbon, and wherein total carbon within the biocoke product is at least 50% renewable as determined from a measurement of the ¹⁴C/¹²C isotopic ratio of the total carbon,
wherein the process does not result in a spatially continuous solid mass filled within the kinetic interface reactor.

In some processes utilizing a bioliquid stream, the process further comprises generating the bioliquid stream by pyrolyzing a biomass feedstock, and collecting a condensed pyrolysis vapor as the carbon-containing liquid. The biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments utilizing a bioliquid stream, the bioliquid stream comprises one or more alkanes (e.g., n-hexane), olefins (e.g., cyclopentene), aromatics (e.g., lignin fragments), aldehydes (e.g., n-hexanal), ketones (e.g., cyclohexanone), acids (e.g., lignosulfonic acid), alcohols (e.g., cyclohexanol), or a combination thereof.

In some embodiments utilizing a bioliquid stream, the kinetic interface media is in the form of pellets. The pellets can be characterized by an average pellet effective diameter of at least about 1 millimeter to at most about 10 centimeters.

In some embodiments utilizing a bioliquid stream, the kinetic interface media is in the form of a powder. The powder can be characterized by an average particle size of at least about 1 micron to at most about 500 microns.

In some embodiments utilizing a bioliquid stream, the kinetic interface media is in the form of granules. The granules can be characterized by an average granule effective diameter of at least about 100 microns to at most about 10 millimeters.

In some embodiments utilizing a bioliquid stream, during the converting step, the solid biocoke forms on the surface of the kinetic interface media. Alternatively, or additionally, during the converting step, the solid biocoke forms in an internal phase of the kinetic interface media.

In some embodiments utilizing a bioliquid stream, during the converting step, effective reaction conditions comprise a coking temperature of at least about 400° C. to at most about 1200° C.

In some embodiments utilizing a bioliquid stream, during the converting step, effective reaction conditions comprise a coking pressure of at least about 1 bar to at most about 40 bar.

In some embodiments utilizing a bioliquid stream, during the converting step, effective reaction conditions comprise a coking liquid-phase residence time of at least about 1 minute to at most about 1 hour.

In some embodiments utilizing a bioliquid stream, during the converting step, effective reaction conditions comprise a coking solid-phase residence time of at least about 1 minute to at most about 24 hours.

In some embodiments utilizing a bioliquid stream, during the converting step, effective reaction conditions comprise a kinetic interface media residence time of at least about 1 minute to at most about 24 hours.

In some embodiments utilizing a bioliquid stream, during the converting step, effective reaction conditions comprise coking reactions that are seeded by the kinetic interface media as a reaction matrix.

In some embodiments utilizing a bioliquid stream, during the converting step, effective reaction conditions comprise coking reactions that are catalyzed by the kinetic interface media.

In some embodiments utilizing a bioliquid stream, during the converting step, effective reaction conditions comprise coking reactions that are catalyzed by a separate coking catalyst, other than the kinetic interface media, introduced to the kinetic interface reactor. In certain embodiments, the separate coking catalyst is continuously or periodically regenerated for reuse in the kinetic interface reactor. For example, when the separate coking catalyst is a metal or metal hydride, and the catalyst becomes poisoned by sulfur, regeneration in hydrogen can return the catalyst to the metal or metal hydride form.

In some embodiments utilizing a bioliquid stream, during the converting step, effective reaction conditions comprise uncatalyzed coking reactions that generate free biocoke particles from the carbon-containing vapor. In certain embodiments, the free biocoke particles do not become chemically or physically combined with the kinetic interface media. In other embodiments, the free biocoke particles, after being formed, become chemically or physically combined with the kinetic interface media.

In some embodiments utilizing a bioliquid stream, the carbon conversion of the carbon-containing vapor to solid biocoke is at least 25% in the converting step. In certain embodiments, the carbon conversion is at least 50%, at least 75%, or at least 90%.

In some embodiments utilizing a bioliquid stream, the process further comprises recovering a kinetic interface reactor off-gas stream comprising carbon-containing vapor formed within the reactor (e.g., from vaporization of bioliquid components or from chemical reactions). The kinetic interface reactor off-gas stream can be combusted with air or oxygen, thereby generating energy. The energy can be used to heat a pyrolysis reactor configured to provide a kinetic interface media comprising a pyrolyzed form of a first biomass feedstock. Alternatively, or additionally, the kinetic interface reactor off-gas stream can be partially oxidized with air or oxygen, thereby generating a reducing gas containing H₂ and/or CO.

In some embodiments utilizing a bioliquid stream, the kinetic interface reactor is a fluidized-bed reactor, a falling-bed reactor, a gravity-driven vessel, a vertical vessel, a slanted vessel, a horizontal vessel, or a rotary kiln. A rotary kiln can be configured such that the kinetic interface media tumbles radially and the bioliquid stream flows axially.

In some embodiments utilizing a bioliquid stream, the kinetic interface reactor is configured with a mechanical conveyor, such as to convey recycled biocoke to the kinetic interface reactor, to convey kinetic interface media through the kinetic interface reactor, and/or to convey solid biocoke product out of the kinetic interface reactor. The mechanical conveyor can be selected from a screw conveyor, a belt conveyor, a chain conveyor, a continuous-flow conveyor, or a recirculating conveyor, for example.

In some embodiments utilizing a bioliquid stream, the biocoke product comprises at least about 80 wt % fixed carbon, at least about 90 wt % fixed carbon, at least about 95 wt % fixed carbon, or at least about 99 wt % fixed carbon.

In some embodiments utilizing a bioliquid stream, total carbon within the biocoke product is at least about 75% renewable as determined from a measurement of the ¹⁴C/¹²C isotopic ratio of the total carbon. In certain embodiments, the total carbon within the biocoke product is at least about 90% renewable, or 100% (fully) renewable, as determined from a measurement of the ¹⁴C/¹²C isotopic ratio of the total carbon.

In some embodiments utilizing a bioliquid stream, the biocoke product comprises essentially no ash.

In some embodiments utilizing a bioliquid stream, in the recovering step, the solid biocoke and the kinetic interface media are separated from each other.

In some embodiments utilizing a bioliquid stream, the process further comprises adding a carbonization agent, wherein the carbonization agent comprises a metal, metal alloy, metal oxide, metal hydroxide, metal hydride, metal sulfide, metal nitride, metal halide, metal salt, mineral, natural polymer, synthetic polymer, acid, base, metal salt, non-metal salt, organic halide, inorganic halide, or a derivative or a combination thereof.

Still other variations provide a biocoke product produced by a continuous process comprising:
providing a heated biogas stream, wherein the heated biogas stream comprises carbon-containing vapor;
introducing the heated biogas stream to a kinetic interface reactor;
converting, using the kinetic interface reactor, the carbon-containing vapor to solid biocoke;
continuously withdrawing the solid biocoke;
continuously returning a recycled portion of the solid biocoke to the kinetic interface reactor, wherein the recycled portion of the solid biocoke is a kinetic interface media contained within the kinetic interface reactor; and
recovering the solid biocoke as a biocoke product, wherein the biocoke product contains at least 75 wt % fixed carbon, and wherein total carbon within the biocoke product is at least 50% renewable as determined from a measurement of the ¹⁴C/¹²C isotopic ratio of the total carbon,
wherein the process does not result in a spatially continuous solid mass filled within the kinetic interface reactor.

Yet other variations provide a biocoke product produced by a continuous process comprising:
providing a bioliquid stream, wherein the bioliquid stream comprises carbon-containing liquid;
introducing the bioliquid stream to a kinetic interface reactor;
converting, using the kinetic interface reactor, the carbon-containing liquid to solid biocoke;
continuously withdrawing the solid biocoke;
continuously returning a recycled portion of the solid biocoke to the kinetic interface reactor, wherein the recycled portion of the solid biocoke is a kinetic interface media contained within the kinetic interface reactor; and
recovering the solid biocoke as a biocoke product, wherein the biocoke product contains at least 75 wt % fixed carbon, and wherein total carbon within the biocoke product is at least 50% renewable as determined from a measurement of the ¹⁴C/¹²C isotopic ratio of the total carbon,
wherein the process does not result in a spatially continuous solid mass filled within the kinetic interface reactor.

Certain variations provide a system for continuously producing biocoke, wherein the system comprises a kinetic interface reactor, wherein the kinetic interface reactor comprises a first inlet configured for feeding a heated biogas stream and/or a bioliquid stream into the kinetic interface reactor, wherein the heated biogas stream comprises a carbon-containing vapor, and wherein the bioliquid stream comprises a carbon-containing liquid, wherein the kinetic interface reactor is configured to operate under effective reaction conditions to convert the carbon-containing vapor and/or the carbon-containing liquid to solid biocoke, wherein the kinetic interface reactor comprises a first outlet configured for continuously or semi-continuously withdrawing the solid biocoke, wherein the kinetic interface reactor comprises a second inlet configured for feeding at least some of the solid biocoke that was withdrawn from the outlet, and wherein the first outlet, or a second outlet, is configured for withdrawing and recovering a biocoke product.

In some systems designed for continuously producing biocoke, the first inlet is configured for feeding a heated biogas stream into the kinetic interface reactor. In other systems, the first inlet is configured for feeding a bioliquid stream into the kinetic interface reactor. In certain systems, the first inlet is configured for feeding a mixture of a heated biogas stream and a bioliquid stream (e.g., a liquid stream entrained with bubbles of heated biogas) into the kinetic interface reactor. In certain systems, the first inlet is configured for feeding either a heated biogas stream or a bioliquid stream, or both, at different times, when the kinetic interface reactor is designed to operate on either a heated biogas stream, or a bioliquid stream, or a mixture thereof.

In some systems designed for continuously producing biocoke, the kinetic interface reactor is selected from a fluidized-bed reactor, a falling-bed reactor, a gravity-driven vessel, a vertical vessel, a slanted vessel, a horizontal vessel, a rotary kiln, or a combination thereof. In systems employing a rotary kiln as the kinetic interface reactor (or one of multiple kinetic interface reactors), the rotary kiln can be configured such that the kinetic interface media tumbles radially and the heated biogas stream and/or the bioliquid stream flows axially.

In some systems designed for continuously producing biocoke, the system contains a mechanical conveyor configured to feed the kinetic interface media into and/or through and/or out of the kinetic interface reactor. The mechanical conveyor can be a screw conveyor, a belt conveyor, a chain conveyor, a continuous-flow conveyor, a recirculating conveyor, or a combination thereof.

### BRIEF DESCRIPTION OF THE DRAWINGS

FIG. 1 is an exemplary process schematic depicting the coking of biogas onto carbon pellets as kinetic interface media, thereby producing high-yield carbon pellets.

FIG. 2 is an exemplary process block-flow diagram depicting the use of a kinetic interface reactor to form biocoke from heated biogas derived from biomass pyrolysis.

FIG. 3 is an exemplary process block-flow diagram depicting the use of a kinetic interface reactor to form biocoke from heated biogas.

FIG. 4 is an exemplary process block-flow diagram depicting the use of a kinetic interface reactor to form biocoke from a bioliquid derived from biomass pyrolysis.

FIG. 5 is an exemplary process block-flow diagram depicting the use of a kinetic interface reactor to form biocoke from a bioliquid.

FIG. 6 is an exemplary process block-flow diagram depicting the use of a kinetic interface reactor to form biocoke from heated biogas, where there is internal recirculation of biocoke as kinetic interface media.

FIG. 7 is an exemplary process block-flow diagram depicting the use of a kinetic interface reactor to form biocoke from bioliquid, where there is internal recirculation of biocoke as kinetic interface media.

### DETAILED DESCRIPTION

Carbon is a platform element in a wide variety of industries and has a vast number of chemical, material, and fuel uses. Carbon is used as fuel to produce energy, including electricity. Carbon also has tremendous chemical value for various commodities and advanced materials, including metals, metal alloys, composites, carbon fibers, electrodes, and catalyst supports. For metal making, carbon, as used in a specific form, for example, coke, is useful as a reactant. Specifically, for reducing metal oxides to metals during processing; as a fuel, to provide heat for processing; and as a component of a metal alloy.

Coke is a carbon-rich material with many industrial uses. Blast-furnace ironmaking conventionally utilizes coke as the major source for both energy and reduction of iron oxides. In the blast furnace process, coke has multiple functions and plays an important role as reductant, burden support, and fuel. Fuel-grade coke (shot coke or sponge coke) is used in the production of cement and with fluidized-bed boilers for generation of steam and electricity. Partial oxidation of coke in a gasification process enables production of syngas. Combustion of coke enables production of steam and electricity. Some calcined coke is used in production of titanium dioxide, such as in the chloride process; as a feedstock for continuous thermal desulfurization for special low-sulfur carbon raiser, such as steel ladle additive; or as carbon raiser in cast iron and steel making. Coke suitable for calcination is employed in making carbon anodes for the aluminum industry. High-quality coke can be used for graphite electrodes in steel arc furnaces.

Most cokers are delayed cokers. Delayed coking is a thermal, non-catalyzed process, performed at a temperature of about 500° C., to cause a heavy petroleum-based feedstock to crack into a range of lighter components and a significant amount of petroleum coke, which can be in the form of solid carbon. Short residence time in furnace tubes cause the coking reaction to be “delayed” until the coke reaches large coking drums. In the large drums, the solid coke is allowed to settle and the lighter liquid or vapor is drawn off and sent to a fractionator. When a drum fills with coke, the feed is switched to another drum. The full drum is cooled with water, then opened such that the solid coke can be drilled out using high-pressure water jets. The coke can be cut directly into rail cars, cut into a crusher car and the coke pumped hydraulically, or cut into a pit or pad with cranes or end loaders moving the coke.

Coke can be produced, in theory, from virtually any carbonaceous material. Carbonaceous materials commonly include fossil resources, which include natural gas, petroleum, coal, and lignite. Carbonaceous materials also include renewable resources, such as lignocellulosic biomass and various carbon-rich waste materials. Energy made from biocoke, which is coke derived from biomass, causes lower net CO₂ emissions compared to coke derived from coal or petroleum. Materials (such as metal alloys) made using biocoke have lower carbon intensity compared to materials made using coke derived from coal or petroleum. There is a commercial interest in biocoke as a replacement for conventional coke, and to enable new applications. Improved processes and systems for producing coke, and in particular biocoke, are desired. It is especially desired to produce biocoke without the need to periodically remove a large mass of solid carbon from a reactor, which in the case of coke made from crude oil, conventionally requires water blasting, mechanical cutting, or even explosives to recover the coke from delayed coker drums.

### Definitions

As used herein, where the indefinite article “a” or “an” is used with respect to a statement or description of the presence of a step in a process disclosed herein, unless the statement or description explicitly provides to the contrary, the use of such indefinite article does not limit the presence of the step in the process to one in number. As used herein, when an amount, concentration, or other value or parameter is given as either a range, or a list of upper values and lower values, this is to be understood as specifically disclosing all ranges formed from any pair of any upper range limit or value and any lower range limit or value, regardless of whether ranges are separately disclosed.

Where a range of numerical values is recited herein, unless otherwise stated, the range is intended to include the endpoints thereof, and all integers and fractions within the range. It is not intended that the scope of the invention be limited to the specific values recited when defining a range.

As used herein, the terms “comprise,” “comprising,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus. Such terms also include, but is not equivalent to, the terms “consists essentially of” or “consists of.” Accordingly, where the term “comprises” is found, it can be replaced with “consists essentially of” or “consists of.”

Further, unless expressly stated to the contrary, “or” refers to an inclusive or and not to an exclusive or. Unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and both A and B. Where the context permits, singular or plural terms can also include the plural or singular term, respectively.

As used herein, the term “about” refers to variation in the reported numerical quantity that can occur. The term “about” means within 10%, 9%, 8%, 7%, 6%, 5%, 4%, 3%, 2%, or 1% of the reported numerical value.

Furthermore, as used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness can in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

An “additive” or “additives” can be introduced throughout the process, before, during, or after any step disclosed herein. The additives can be broadly classified as process additives, selected to improve process performance such as carbon yield or pyrolysis time/temperature to achieve a desired carbon purity; and product additives, selected to improve one or more properties of the high-carbon biogenic reagent, or a downstream product incorporating the reagent. Certain additives can provide enhanced process and product (biogenic reagents or products containing biogenic reagents) characteristics.

Additives can be added before, during, or after any one or more steps of the process, including into the feedstock itself at any time, before or after it is harvested. Additive treatment can be incorporated prior to, during, or after feedstock sizing, drying, or other preparation. Additives can be incorporated at or on feedstock supply facilities, transport trucks, unloading equipment, storage bins, conveyors (including open or closed conveyors), dryers, process heaters, or any other units. Additives can be added anywhere into the pyrolysis process itself, using suitable means for introducing additives. Additives can be added after carbonization, or even after pulverization, if desired.

In the art, “coke” usually refers to the product derived from low-ash and low-sulfur bituminous coal by a process called coking. A similar product called petroleum coke, or pet coke, is obtained from crude oil in oil refineries. The definition of “coke” in this specification includes coke produced from either coal or from crude oil, but not from biomass. As used herein, “biocoke” refers to coke produced from biomass, or from a mixture of biomass and another source of carbon, which can be biogenic carbon, non-biogenic carbon, or a mixture of biogenic and non-biogenic carbon.

As used herein, “biogenic” is a material (whether a feedstock, product, or intermediate) that contains an element, such as carbon, that is renewable on time scales of months, years, or decades. Non-biogenic materials (e.g., fossil fuels) can be non-renewable, or can be renewable on time scales of centuries, thousands of years, millions of years, or even longer geologic time scales.

As used herein, “biomass” describes any biologically produced matter, or biogenic matter. The chemical energy contained in biomass is derived from solar energy using the natural process of photosynthesis. Photosynthesis is the process by which plants take in carbon dioxide and water from their surroundings and, using energy from sunlight, convert them into sugars, starches, cellulose, hemicellulose, and lignin. Of all the renewable energy sources, biomass is unique in that it is, effectively, stored solar energy. Furthermore, biomass is the only renewable source of carbon.

There are three naturally occurring isotopes of carbon, ¹²C, ¹³C, and ¹⁴C. ¹²C and ¹³C are stable, occurring in a natural proportion of approximately 93:1. ¹⁴C is produced by thermal neutrons from cosmic radiation in the upper atmosphere, and is transported down to earth to be absorbed by living biological material. Isotopically, ¹⁴C constitutes a negligible part; but, since it is radioactive with a half-life of 5,700 years, it is radiometrically detectable. Dead tissue does not absorb ¹⁴C, so a measurement of the amount of ¹⁴C can be used for radiometric dating of biological material.

Plants take up ¹⁴C by fixing atmospheric carbon through photosynthesis. Animals then take ¹⁴C into their bodies when they consume plants or consume other animals that consume plants. Accordingly, living plants and animals have the same ratio of ¹⁴C to ¹²C as the atmospheric CO₂. Once an organism dies, it stops exchanging carbon with the atmosphere, and thus no longer takes up new ¹⁴C. Radioactive decay then gradually depletes the ¹⁴C in the organism. This effect is the basis of radiocarbon dating.

Fossil fuels, such as coal, are made primarily of plant material that was deposited millions of years ago. This period of time equates to thousands of half-lives of ¹⁴C; therefore, essentially all of the ¹⁴C in fossil fuels has decayed. Fossil fuels also are depleted in ¹³C relative to the atmosphere, because they were originally formed from living organisms. Therefore, the carbon from fossil fuels is depleted in both ¹³C and ¹⁴C compared to biogenic carbon.

This difference between the carbon isotopes of recently deceased organic matter, such as that from renewable resources, and the carbon isotopes of fossil fuels, such as coal or crude oil, allows for a determination of the source of carbon in a composition. Specifically, the analysis of carbon isotopes can show whether the carbon in the composition was derived from a renewable resource or from a fossil fuel—in other words, whether a renewable resource or a fossil fuel was used in the production of the composition.

Hardgrove Grindability Index (“HGI”) is a measure of the grindability of a material, such as biomass or coal. The HGI parameter for coal is important in power applications, such as pulverized coal boilers where coal is pulverized and burned in suspension, and in iron making, such as in pulverized coal injection where pulverized coal is injected through a lance into a blast furnace where pulverized coal can displace coke to reduce iron ores to metallic iron.

As used herein, a “pellet” is an agglomerated object rather than a loose powder. The pellet geometry is not limited to spherical or approximately spherical. Also, in this disclosure, “pellet” is synonymous with “briquette”. The pellet geometry can be spherical (round or ball shape), cylindrical, cube (square), octagon, hexagon, honeycomb/beehive shape, oval shape, egg shape, column shape, bar shape, pillow shape, random shape, or a combination thereof. For convenience of disclosure, the term “pellet” will generally be used for any object containing a powder agglomerated with a binder. This invention is by no means limited to any of the disclosed compositions being in the form of pellets.

As used herein, the unmodified term “reagent” broadly refers to a material, such as a fuel, a chemical, a material, a compound, an additive, a blend component, or a solvent. A reagent is not necessarily a chemical reagent that causes or participates in a chemical reaction. In some embodiments, a reagent is a chemical reactant that is consumed in a reaction. A reagent can be a chemical catalyst for a particular reaction. A reagent can cause or participate in adjusting a mechanical, physical, or hydrodynamic property of a material to which the reagent can be added. For example, a reagent can be introduced to a metal to impart certain strength properties to the metal. A reagent can be a substance of sufficient purity (which, in the current context, is typically carbon purity) for use in chemical analysis or physical testing.

As used herein, “low fixed carbon” and “high fixed carbon” describe materials that can be produced by processes and systems disclosed herein. Limitations as to carbon content, or any other concentrations, shall not be imputed from the term itself, but rather only by reference to particular embodiments and equivalents thereof.

In this disclosure, a “product” can be a composition, a material, an object, or a structure, for example. The term “product” shall not be limited by its commercial fate, such as whether it is sold, stored, traded, further processed, sold to another party as an intermediate for further processing, etc.

### Processes for Producing Biocoke Using Biogas Streams

Disclosed herein are processes for producing biocoke. Processes for producing biocoke can comprise: providing a heated biogas stream, wherein the heated biogas stream comprises a carbon-containing vapor; providing a kinetic interface media, wherein the kinetic interface media is in solid form; introducing the kinetic interface media and the heated biogas stream to a kinetic interface reactor; converting, using the kinetic interface reactor, the carbon-containing vapor to biocoke, wherein the biocoke is chemically or physically combined with the kinetic interface media, thereby forming a solid biocoke-containing kinetic interface media; removing the solid biocoke-containing kinetic interface media from the kinetic interface reactor; and recovering the solid biocoke-containing kinetic interface media.

A “kinetic interface media” is a material that is effective to cause, enhance, or support coke formation on a surface of the material, or within the material, or both on the surface of the material and within the material. Carbon atoms are transported across an interface formed with an external vapor, liquid, or solid phase that contains a carbon source, such that upon or after entry into the material or onto a material surface, solid biocoke is kinetically and/or thermodynamically formed.

Some variations of the disclosed technology provide a process for producing biocoke, the process comprising:
providing a heated biogas stream, wherein the heated biogas stream comprises a carbon-containing vapor;
providing a kinetic interface media, wherein the kinetic interface media is in solid form;
introducing the kinetic interface media and the heated biogas stream to a kinetic interface reactor;
converting, using the kinetic interface reactor, the carbon-containing vapor to biocoke, wherein the biocoke contains at least 75 wt % fixed carbon, wherein total carbon within the biocoke is at least 50% renewable as determined from a measurement of the ¹⁴C/¹²C isotopic ratio of the total carbon, and wherein the biocoke is chemically or physically combined with the kinetic interface media, thereby forming a solid biocoke-containing kinetic interface media;
removing the solid biocoke-containing kinetic interface media from the kinetic interface reactor; and
recovering the solid biocoke-containing kinetic interface media.

In some embodiments, the kinetic interface media is in the form of pellets. The pellets can be characterized by an average pellet effective diameter of at least about 1 millimeter to at most about 10 centimeters. In various embodiments, the average pellet effective diameter can be about, at least about, or at most about 1 mm, 2 mm, 3 mm, 4 mm, 5 mm, 6 mm, 7 mm, 8 mm, 9 mm, 1 cm, 1.5 cm, 2 cm, 3 cm, 4 cm, 5 cm, 6 cm, 7 cm, 8 cm, 9 cm, or 10 cm, including all intervening ranges.

In some embodiments, the kinetic interface media is in the form of a powder. The powder can be characterized by an average particle size of at least about 1 micron to at most about 500 microns. In various embodiments, the average particle size of the powder is about, at least about, or at most about 1, 2, 3, 4, 5, 10, 15, 20, 25, 30, 40, 50, 60, 70, 80, 90, 100, 125, 150, 175, 200, 250, 300, 350, 400, 450, or 500 microns, including all intervening ranges.

In some embodiments, the kinetic interface media is in the form of granules. The granules can be characterized by an average granule effective diameter of at least about 100 microns to at most about 10 millimeters. In various embodiments, the average granule effective diameter is about, at least about, or at most about 100, 125, 150, 175, 200, 250, 300, 350, 400, 450, 500, 600, 700, 800, 900, or 1000 microns, including all intervening ranges. In various embodiments, the average granule effective diameter is about, at least about, or at most about 1 mm, 2 mm, 3 mm, 4 mm, 5 mm, 6 mm, 7 mm, 8 mm, 9 mm, or 10 mm, including all intervening ranges.

Particle sizes can be measured by a variety of techniques, including dynamic light scattering, laser diffraction, image analysis, or sieve separation, for example. Dynamic light scattering is a non-invasive, well-established technique for measuring the size and size distribution of particles typically in the submicron region, down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images. Finally, sieving is a conventional technique of separating particles by size.

The kinetic interface media can be analyzed using an imaging technique. Imaging techniques include, but are not limited to, optical microscopy; dark-field microscopy; scanning electron microscopy (SEM); transmission electron microscopy (TEM); and X-ray tomography (XRT), for example. Spectroscopy techniques can Alternatively or additionally, be utilized in various embodiments. Spectroscopy techniques include, but are not limited to, energy dispersive X-ray spectroscopy (EDS), X-ray fluorescence (XRF), infrared (IR) spectroscopy, and nuclear magnetic resonance (NMR) spectroscopy, for example.

In some embodiments, the kinetic interface media has a bed depth of at least about 10 centimeters to at most about 10 meters. The “bed depth” is defined as the distance from the top to the bottom of the fixed or fluidized bed of kinetic interface media, in the maximum dimension (which can be vertical or horizontal). In various embodiments, the kinetic interface media bed depth is about, at least about, or at most about 10 cm, 25 cm, 50 cm, 100 cm, 250 cm, 500 cm, 750 cm, 1 m, 1.5 m, 2 m, 2.5 m, 3 m, 4 m, or 5 m, including all intervening ranges.

In some embodiments, the kinetic interface media comprises a pyrolyzed form of a first biomass feedstock. The first biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments, the kinetic interface media comprises a previously formed biocoke. The previously formed biocoke can be fed to the kinetic interface reactor. The previously formed biocoke can have been formed according to any method disclosed herein, or another method of making biocoke. Alternatively, or additionally, the kinetic interface media can be another type of coke that is not necessarily biocoke.

In some embodiments, the kinetic interface media comprises a raw biomass feedstock. The raw biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In many embodiments, the kinetic interface media contains carbon. In other embodiments, the kinetic interface media does not contain carbon. For example, in certain embodiments, the kinetic interface media contains a metal, a metal alloy, a metal oxide, a metal hydride, a metal nitride, or a combination thereof. Examples include, but are not limited to, iron, nickel, nickel oxide, cobalt, cobalt oxide, copper, copper oxide, zinc, zinc oxide, silica, sand, alumina, silica-alumina composites, or combinations thereof. In certain embodiments, biomass ash (generally rich in silica) is utilized as the kinetic interface media. For example, biomass ash can be recovered from a process that combusts, partially oxidizes, and/or pyrolyzes biomass. In certain embodiments, the kinetic interface media contains carbon but only as a compound with a metal. Examples include iron carbide, nickel carbide, cobalt carbide, zinc carbide, silicon carbide (silicon is considered a metal herein), aluminum carbide, or combinations thereof. The carbon in these metal-carbide materials is not coke; biocoke formed on or within metal carbides would be both readily observable using analytical techniques as well as recoverable via separation for biocoke recovery.

In some embodiments, the process can further comprise generating the heated biogas stream (rather than receiving from an external source). Generating the heated biogas stream can be achieved by pyrolyzing a second biomass feedstock. The second biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments, the carbon-containing vapor comprises pyrolysis vapor. Pyrolysis vapors can include such as CO, CO₂, alkanes, olefins, aromatics, aldehydes, ketones, acids, alcohols, or a combination thereof. Exemplary alkanes include, but are not limited to, methane, ethane, propane, butanes, and pentanes. Exemplary olefins include, but are not limited to, ethylene, propylene, butenes, and butadienes. Exemplary aromatics include, but are not limited to, benzene, toluene, xylenes, and lignin. Exemplary aldehydes include, but are not limited to, formaldehyde, acetaldehyde, and furfural. Exemplary ketones include, but are not limited to, acetone and butanones. Exemplary acids include, but are not limited to, formic acid, acetic acid, and levulinic acid. Exemplary alcohols include, but are not limited to, methanol, ethanol, and propanols.

In certain embodiments, the heated biogas stream is generated during pyrolysis of a biomass feedstock that is the same biomass feedstock as also used to make the kinetic interface media via pyrolysis.

In some embodiments, the kinetic interface media comprises a pyrolyzed form of a first biomass feedstock, wherein the heated biogas stream is generated during pyrolysis of the first biomass feedstock, and wherein the kinetic interface media and the heated biogas stream are obtained from a common pyrolysis reactor. The heated biogas stream can comprise CO, CO₂, alkanes, olefins, aromatics, aldehydes, ketones, acids, alcohols, or a combination thereof. Alternatively or additionally, the heated biogas stream can comprise non-carbon-containing gases, such as hydrogen or water vapor.

Various classes of compounds can be present in the heated biogas stream. There can be C₁ compounds, including (but not limited to) carbon monoxide, carbon dioxide, methane, formic acid, methanol, and formaldehyde. There can be C₂-C₄ linear hydroxyl-substituted and oxo-substituted aldehydes and ketones, such as (but not limited to) hydroxyacetaldehyde and hydroxyacetone. There can be C₂-C₄ acids, such as (but not limited to) acetic acid or butyric acid. There can be C₅-C₆ hydroxyl-, hydroxymethyl-, or oxo-substituted furans, furanones, lactones, and pyranones. Anhydrosugars, including C₅ and C₆ anhydrosugars (such as levoglucosan), can be present. There can be monomeric methoxyl-substituted phenols. Lignin or lignin fragments can be present. Water vapor can be present in the heated biogas stream. Hydrogen can be present in the heated biogas stream.

The heated biogas, prior to being introduced into the kinetic interface reactor, can be at a biogas temperature from about 50° C. to about 800° C., for example. In various embodiments, the heated biogas is at a temperature of about, at least about, or at most about 50° C., 75° C., 100° C., 150° C., 200° C., 250° C., 300° C., 350° C., 400° C., 450° C., 500° C., 550° C., 600° C., 650° C., 700° C., 750° C., or 800° C., including any intervening ranges. It will be recognized that some components of the heated biogas stream will be a vapor at the heated-biogas temperature but would be a liquid at an ambient temperature of 25° C. (e.g., methanol is a vapor at 100° C. but a liquid at 25° C., each at a pressure of 1 bar), while other components (such as CO) will be a vapor at any temperature in the range of 25-800° C. This will depend on the liquid-vapor thermodynamic equilibrium properties of the particular species and conditions (including temperature and pressure), as well as multicomponent thermodynamics involved.

In some embodiments, during the converting, the biocoke forms on the surface of the kinetic interface media. In some embodiments, during the converting, the biocoke forms in an internal phase of the kinetic interface media. When the biocoke forms in an internal phase, the biocoke can be in the same material phase as the kinetic interface media solid phase, forming a solid solution or alloy, for example. Alternatively, the biocoke can phase-segregate and form its own solid phase within the kinetic interface media. The separate phase can be located at or near the surface of the kinetic interface media, which is beneficial for downstream separation.

In this specification, “during the converting” is synonymous with “during the converting step”, it being understood that converting can be actually carried out in one or more process steps. Likewise, this equivalence (i.e., the presence of “step” or the implied presence of the word “step”) applies with respect to other process steps, such as providing, introducing, removing, recovering, etc.

In some embodiments, during the converting, effective reaction conditions used to achieve the converting comprise a coking temperature of at least about 400° C. to at most about 1200° C., for example, about, at least about, or at most about 400° C., 450° C., 500° C., 550° C., 600° C., 650° C., 700° C., 750° C., 800° C., 850° C., 900° C., 950° C., 1000° C., 1050° C., 1100° C., 1150° C., or 1200° C., including any intervening ranges. Generally speaking, higher temperatures promote the coking reaction, but other factors should be considered, including time, pressure, and catalytic effects.

In some embodiments, during the converting, effective reaction conditions used to achieve the converting comprise a coking pressure of at least about 1 bar to at most about 40 bar; for example, about, at least about, or at most about 1, 2, 3, 4, 5, 6, 7, 8, 9, 10, 15, 20, 25, 30, 35, or 40 bar, including any intervening ranges.

In some embodiments, during the converting, effective reaction conditions used to achieve the converting comprise a coking vapor-phase residence time of at least about 1 second to at most about 1 hour; for example, about, at least about, or at most about 1 s, 5 s, 10 s, 15 s, 20 s, 30 s, 45 s, 1 min, 2 min, 3 min, 4 min, 5 min, 10 min, 15 min, 20 min, 25 min, 30 min, 40 min, 50 min, or 60 min, including any intervening ranges. Generally speaking, longer vapor-phase residence times promote the coking reaction, but other factors should be considered, including temperature, pressure, and catalytic effects.

In some embodiments, during the converting, effective reaction conditions used to achieve the converting comprise a coking solid-phase residence time of at least about 1 minute to at most about 24 hours; for example, of about, at least about, or at most about 1 min, 5 min, 10 min, 15 min, 30 min, 45 min, 60 min, 1.5 hr, 2 hr, 3 hr, 4 hr, 8 hr, 12 hr, 16 hr, 20 hr, or 24 hr, including any intervening ranges. The coking solid-phase residence time is an independent parameter from the vapor-phase residence time, as is known in multiphase reactor engineering.

In some embodiments, during the converting, effective reaction conditions used to achieve the converting comprise a kinetic interface media residence time of at least about 1 minute to at most about 24 hours; for example, about, at least about, or at most about 1 min, 5 min, 10 min, 15 min, 30 min, 45 min, 60 min, 1.5 hr, 2 hr, 3 hr, 4 hr, 8 hr, 12 hr, 16 hr, 20 hr, or 24 hr, including any intervening ranges. The kinetic interface media residence time can be the same as the coking solid-phase residence time. Alternatively, the kinetic interface media residence time can be higher than the coking solid-phase residence time, or lower than the coking solid-phase residence time. The kinetic interface media residence time is an independent parameter from the coking solid-phase residence time, although practically they will tend to be coupled at least to some extent.

In some embodiments, during the converting, effective reaction conditions used to achieve the converting comprise coking reactions that are seeded by the kinetic interface media as a reaction matrix. Alternatively or additionally, during the converting, effective reaction conditions used to achieve the converting can comprise coking reactions that are catalyzed by the kinetic interface media. In some embodiments, during the converting, effective reaction conditions used to achieve the converting comprise coking reactions that are catalyzed by a separate coking catalyst introduced to the kinetic interface reactor.

A separate coking catalyst can comprise iron, nickel, nickel oxide, cobalt, cobalt oxide, copper, copper oxide, zinc, zinc oxide, silica, alumina, silica-alumina composites, sand, aluminosilicates, zeolites (e.g., ZSM-5 zeolite), silicon carbide, or combinations thereof, for example.

In many hydrocarbon processes industrially or in a laboratory, catalyst coking is avoided. For example, in methane partial oxidation over Pt-containing catalysts to produce syngas, generation of solid carbon quickly deactivates the catalyst and essentially stops syngas production. However, in this disclosure, when a separate coking catalyst is utilized, biocoke is an intended product. It is possible that the separate coking catalyst eventually becomes deactivated by formation of recalcitrant carbon (e.g., glassy carbon) or poisoned (e.g., by sulfur), in which case the coking catalyst can be regenerated, if desired.

In some embodiments, in the converting step, carbon conversion of the carbon-containing vapor is about, or at least about 25%, 30%, 35%, 40%, 45%, 50%, 55%, 60%, 65%, 70%, 75%, 80%, 85%, 90%, 95%, or 99%, including any intervening ranges. For example, the converting step can be optimized to achieve a conversion of about 25-75% of the carbon-containing vapor to solid biocoke.

In some embodiments, the processes further comprise conveying at least some of the solid biocoke-containing kinetic interface media to a pyrolysis reactor. In some embodiments, conveying at least some of the solid biocoke-containing interface media to the pyrolysis reactor leads to generation of pyrolyzed solid biocoke-containing kinetic interface media. Some or all of the pyrolyzed solid biocoke-containing kinetic interface media can optionally be introduced back to the kinetic interface reactor.

In some embodiments, the processes further comprise introducing the pyrolyzed solid biocoke-containing kinetic interface media to the kinetic interface reactor.

In some embodiments, the processes further comprise recovering a kinetic interface reactor off-gas stream comprising unconverted carbon-containing vapor. In some embodiments, the processes further comprise combusting the kinetic interface reactor off-gas stream, thereby generating energy. The process can further comprise utilizing the energy, thereby heating a pyrolysis reactor, and that pyrolysis reactor can be configured to provide the kinetic interface media, in which case the kinetic interface media can comprise a pyrolyzed form of a first biomass feedstock. Alternative or additionally, the processes can further comprise partially oxidizing the kinetic interface reactor off-gas stream, thereby generating a reducing gas, which generally contains H₂ and/or CO. In some embodiments, the processes further comprise recycling some or all of the kinetic interface reactor off-gas stream to an inlet of the kinetic interface reactor, such as to increase biocoke yield.

In some embodiments, the processes further comprise recycling the solid biocoke-containing kinetic interface media to an inlet of the kinetic interface reactor.

In some embodiments, the processes further comprise removing, during or after the recovering, at least some of the biocoke from the solid biocoke-containing kinetic interface media, thereby forming a regenerated kinetic interface media; and recycling the regenerated kinetic interface media to an inlet of the kinetic interface reactor.

In some embodiments, the processes further comprise removing, during or after the recovering, at least some of the biocoke from the solid biocoke-containing kinetic interface media, thereby forming a regenerated kinetic interface media, wherein the regenerated kinetic interface media comprises carbon; and conveying the regenerated kinetic interface media to a pyrolysis reactor.

In some embodiments, the processes further comprise carbonizing, in the kinetic interface reactor, a carbon-containing kinetic interface media, wherein the carbonizing is separate from converting the carbon-containing vapor to the biocoke. In other words, in some embodiments in which the kinetic interface media comprises carbon, additional carbonization of the kinetic interface media can occur in the kinetic interface reactor, separately from the carbon-containing vapors being converted to the biocoke. In these embodiments, the kinetic interface media can be or can comprise a raw biomass feedstock, a pyrolyzed form thereof, or a combination of the foregoing.

The kinetic interface reactor can be a fluidized-bed reactor, a falling-bed reactor, a gravity-driven vessel, a rotary kiln, or another type of reactor. The kinetic interface reactor can be a vertical vessel, a horizontal vessel, or a slanted vessel. The kinetic interface reactor can be stationary or can rotate. When the kinetic interface reactor is a rotary kiln, the rotary kiln can be configured such that the kinetic interface media tumbles radially and the heated biogas stream flows axially.

In some embodiments, the kinetic interface reactor is configured with a mechanical conveyor. In some embodiments, the mechanical conveyor is a screw conveyor, a belt conveyor, a chain conveyor, a continuous-flow conveyor, a recirculating conveyor. In some embodiments, the conveyor is another type of conveyor known in the art. The mechanical conveyor can introduce the kinetic interface media into the kinetic interface reactor, or convey the kinetic interface media through the kinetic interface reactor, or both of these. Additionally, or alternatively, the mechanical conveyor can convey the solid biocoke-containing kinetic interface media out of the kinetic interface reactor, in the removing step. There can be multiple mechanical conveyors within a single kinetic interface reactor.

In some embodiments, the process does not result in a spatially continuous solid mass filled within the kinetic interface reactor. A “spatially continuous solid mass” refers to a mass that is filled entirely within a vessel, up to the walls, and which cannot be easily removed without severe mechanical means such as drilling or water jetting. A spatially continuous solid mass can be avoided by removing the solid biocoke-containing kinetic interface media before it has filled entirely within the open volume of the kinetic interface reactor.

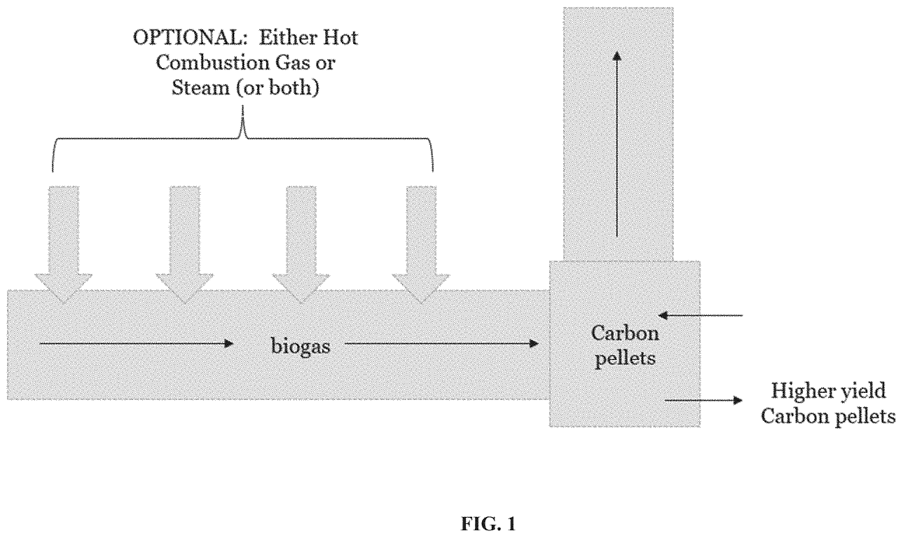

In some embodiments, the removing step is conducted continuously or semi-continuously. In some embodiments, such as in FIG. 1, the removing is conducted simultaneously with the converting (and forming) step. In some embodiments, the removing is conducted immediately following the forming the solid biocoke-containing kinetic interface media. In other embodiments, the removing is conducted only periodically or intermittently, but still before a spatially continuous solid mass is formed.

In some embodiments, the removing is conducted batch-wise. For example, after a period of time to cause biocoke formation in the converting (and forming) step, the reaction can be stopped and the reactor opened up to remove the solid biocoke-containing kinetic interface media. However, even in batch mode, it can be desirable that a spatially continuous solid mass has not formed.

In some embodiments, the kinetic interface media comprises at least about 5, 10, 15, 20, 25, 30, 35, 40, 45, 50, 55, 60, 65, 70, 75, 80, 85, 90, 91, 92, 93, 94, 95, 96, 97, 98, or 99 wt % total carbon, including any intervening ranges. In various embodiments, the kinetic interface media comprises at least about 10 wt %, at least about 25 wt %, at least about 50 wt %, at least about 75, or at least about 90 wt % total carbon. Total carbon includes fixed carbon and volatile carbon.

In some embodiments, the kinetic interface media comprises at least about 20, 25, 30, 35, 40, 45, 50, 55, 60, 65, 70, 75, 80, 85, 90, 91, 92, 93, 94, 95, 96, 97, 98, or 99 wt % fixed carbon, including any intervening ranges. In various embodiments, the kinetic interface media comprises at least about 25 wt %, at least about 50 wt %; at least about 70 wt %, at least about 80 wt %, or at least about 90 wt % fixed carbon.

In some embodiments, the kinetic interface media comprises at most about 1, 2, 3, 4, 5, 6, 7, 8, 9, 10, 11, 12, 13, 14, 15, 20, 25, 30, 35, 40, 45, or 50 wt % volatile carbon, including any intervening ranges.

In some embodiments, the solid biocoke-containing kinetic interface media comprises at least about 40, 45, 50, 55, 60, 65, 70, 71, 72, 73, 74, 75, 76, 77, 78, 79, 80, 81, 82, 83, 84, or 85 wt % fixed carbon, including any intervening ranges. For example, the solid biocoke-containing kinetic interface media can contain at least about 50 wt % or at least about 80 wt % fixed carbon.

In some embodiments, the biocoke comprises at least about 70, 75, 80, 85, 90, 91, 92, 93, 94, 95, 96, 97, 98, or 99 wt % fixed carbon, including any intervening ranges. For example, the biocoke can contain at least about 80 wt %, at least about 90 wt %, at least about 95 wt %, or at least about 99 wt % fixed carbon.

In some embodiments, the biocoke has a higher carbon content than kinetic interface media. It is also possible for the carbon content of the biocoke to be about the same as the average carbon content of the solid biocoke-containing kinetic interface media.

In some embodiments, the biocoke contains essentially no ash. In some embodiments, the biocoke has a lower ash content than kinetic interface media.

In some embodiments, the processes further comprise generating free biocoke particles from the carbon-containing vapor, wherein the free biocoke particles are not chemically or physically combined with the kinetic interface media. In some embodiments, the free biocoke particles are derived only from the carbon-containing vapor and not directly from the kinetic interface media. In some embodiments, the kinetic interface media comprises carbon, wherein the free biocoke particles are derived both from the carbon-containing vapor and from the kinetic interface media. In some embodiments, the free biocoke particles are derived from the carbon-containing vapor, wherein formation of the free biocoke particles is catalyzed or seeded by the kinetic interface media.

In some embodiments, total carbon within the solid biocoke-containing kinetic interface media is about or at least about 40, 45, 50, 55, 60, 65, 70, 75, 80, 85, 90, 91, 92, 93, 94, 95, 96, 97, 98, or 99%, or is 100% (“fully”) renewable as determined from a measurement of the ¹⁴C/¹²C isotopic ratio of the total carbon. In certain embodiments, total carbon within the solid biocoke-containing kinetic interface media is at least about 50%, at least about 90%, or fully renewable as determined from a measurement of the ¹⁴C/¹²C isotopic ratio of the total carbon.

In some embodiments, total carbon within the biocoke is at least about 40, 45, 50, 55, 60, 65, 70, 75, 80, 85, 90, 91, 92, 93, 94, 95, 96, 97, 98, 99, 100% renewable as determined from a measurement of the ¹⁴C/¹²C isotopic ratio of the total carbon. In certain embodiments, total carbon within the biocoke is at least about 50%, at least about 90%, at least about 95%, at least about 99%, or about 100% renewable as determined from a measurement of the ¹⁴C/¹²C isotopic ratio of the total carbon. Even when the biocoke itself is fully renewable, the remainder of the solid biocoke-containing kinetic interface media is optionally not fully renewable.

The process can be a continuous process, a semi-continuous process, a batch process, or a combination thereof. A combination means, for example, that one step can be batch and then other steps are continuous, or that the process can be started up in batch but then operated continuously at steady state for a period of time.

In some embodiments, the processes further comprise adding a carbonization agent, wherein the carbonization agent comprises a metal, a metal alloy, a metal oxide, a metal hydroxide, a metal hydride, a metal sulfide, a metal nitride, a metal halide, a metal salt, a mineral, a natural polymer, a synthetic polymer, an acid, a base, a non-metal salt, an organic halide, an inorganic halide, or a derivative or a combination thereof.

### Processes for Producing Biocoke Using Bioliquid Streams

Disclosed herein are additional processes for producing biocoke. These processes for producing biocoke can comprise: providing a bioliquid stream, wherein the bioliquid stream comprises a carbon-containing liquid; providing a kinetic interface media, wherein the kinetic interface media is in solid form; introducing the kinetic interface media and the bioliquid stream to a kinetic interface reactor; converting, using the kinetic interface reactor, the carbon-containing liquid to biocoke, wherein the biocoke is chemically or physically combined with the kinetic interface media, thereby forming a solid biocoke-containing kinetic interface media; removing the solid biocoke-containing kinetic interface media from the kinetic interface reactor; and recovering the solid biocoke-containing kinetic interface media.

In some embodiments of the technology, a process for producing biocoke comprises:
providing a bioliquid stream, wherein the bioliquid stream comprises a carbon-containing liquid;
providing a kinetic interface media, wherein the kinetic interface media is in solid form;
introducing the kinetic interface media and the bioliquid stream to a kinetic interface reactor;
converting, using the kinetic interface reactor, the carbon-containing liquid to biocoke, wherein the biocoke contains at least 75 wt % fixed carbon, wherein total carbon within the biocoke is at least 50% renewable as determined from a measurement of the ¹⁴C/¹²C isotopic ratio of the total carbon, and wherein the biocoke is chemically or physically combined with the kinetic interface media, thereby forming a solid biocoke-containing kinetic interface media;
removing the solid biocoke-containing kinetic interface media from the kinetic interface reactor; and
recovering the solid biocoke-containing kinetic interface media.

In some embodiments, the kinetic interface media is in the form of pellets. The pellets can be characterized by an average pellet effective diameter of at least about 1 millimeter to at most about 10 centimeters. In various embodiments, the average pellet effective diameter can be about, at least about, or at most about 1 mm, 2 mm, 3 mm, 4 mm, 5 mm, 6 mm, 7 mm, 8 mm, 9 mm, 1 cm, 1.5 cm, 2 cm, 3 cm, 4 cm, 5 cm, 6 cm, 7 cm, 8 cm, 9 cm, or 10 cm, including all intervening ranges.

In some embodiments, the kinetic interface media is in the form of a powder. The powder can be characterized by an average particle size of at least about 1 micron to at most about 500 microns. In various embodiments, the average particle size of the powder is about, at least about, or at most about 1, 2, 3, 4, 5, 10, 15, 20, 25, 30, 40, 50, 60, 70, 80, 90, 100, 125, 150, 175, 200, 250, 300, 350, 400, 450, or 500 microns, including all intervening ranges.

In some embodiments, the kinetic interface media is in the form of granules. The granules can be characterized by an average granule effective diameter of at least about 100 microns to at most about 10 millimeters. In various embodiments, the average granule effective diameter is about, at least about, or at most about 100, 125, 150, 175, 200, 250, 300, 350, 400, 450, 500, 600, 700, 800, 900, or 1000 microns, including all intervening ranges. In various embodiments, the average granule effective diameter is about, at least about, or at most about 1 mm, 2 mm, 3 mm, 4 mm, 5 mm, 6 mm, 7 mm, 8 mm, 9 mm, or 10 mm, including all intervening ranges.

In some embodiments, the kinetic interface media has a bed depth of at least about 10 centimeters to at most about 10 meters. In various embodiments, the kinetic interface media bed depth is about, at least about, or at most about 10 cm, 25 cm, 50 cm, 100 cm, 250 cm, 500 cm, 750 cm, 1 m, 1.5 m, 2 m, 2.5 m, 3 m, 4 m, or 5 m, including all intervening ranges.

In some embodiments, the kinetic interface media is a pyrolyzed form of a first biomass feedstock. The first biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments, the kinetic interface media comprises a previously formed biocoke. Alternatively or additionally, the kinetic interface media can be another type of coke that is not necessarily biocoke.

In some embodiments, the kinetic interface media comprises, or consists essentially of, a raw biomass feedstock. The raw biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In many embodiments using a bioliquid stream, the kinetic interface media contains carbon. In other embodiments, the kinetic interface media does not contain carbon. For example, in certain embodiments, the kinetic interface media contains a metal, a metal alloy, a metal oxide, a metal hydride, a metal nitride, or a combination thereof. Examples include, but are not limited to, iron, nickel, nickel oxide, cobalt, cobalt oxide, copper, copper oxide, zinc, zinc oxide, silica, sand, alumina, silica-alumina composites, or combinations thereof. In certain embodiments, biomass ash (generally rich in silica) is utilized as the kinetic interface media. In certain embodiments, the kinetic interface media contains carbon but only as a compound with a metal. Examples include iron carbide, nickel carbide, cobalt carbide, zinc carbide, silicon carbide (silicon is considered a metal herein), aluminum carbide, or combinations thereof. The carbon in these materials is not coke, and biocoke formed on or within metal carbides would be both readily observable using analytical techniques as well as recoverable via separation for biocoke recovery.

In some embodiments, the processes further comprise generating the bioliquid stream, rather than obtaining the bioliquid stream from an external source. The generation of the bioliquid stream can be achieved by pyrolyzing a second biomass feedstock. The second biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments, the bioliquid stream is generated from pyrolysis of the first biomass feedstock, in which case the bioliquid stream can comprise heavy pyrolysis liquids (e.g., tars) and/or condensed pyrolysis vapors. The bioliquid stream optionally further comprises uncondensed pyrolysis vapors, such as entrained bubbles or dissolved gases. Condensed pyrolysis vapors can be alkanes, olefins, aromatics, aldehydes, ketones, acids, alcohols, water, or a combination thereof, for example. Condensing pyrolysis vapors can utilize a condensing system with one or multiple condenser stages. The condenser liquid can be a condensed product of an individual stage (e.g., a first stage) of the multiple condenser stages.

In some embodiments, the kinetic interface media is a pyrolyzed form of a first biomass feedstock, wherein the bioliquid stream is generated from pyrolysis of the first biomass feedstock, and wherein the kinetic interface media and the bioliquid stream are obtained from a common pyrolysis reactor.

In some embodiments, the bioliquid stream comprises a/an alkane, olefin, aromatic, aldehyde, ketone, acid, alcohol, or a combination thereof. In some embodiments, the bioliquid stream further comprises a non-carbon-containing species, such as water. The bioliquid stream can be characterized in that it is substantially a liquid at a pressure of 1 bar and a temperature of 25° C. or at another temperature, such as a temperature of a bioliquid feed stream that is fed into the kinetic interface reactor. The bioliquid feed stream can be at a temperature of about, at least about, or at most about 25° C., 30° C., 40° C., 50° C., 60° C., 70° C., 80° C., 90° C., 100° C., 110° C., 120° C., 130° C., 140° C., 150° C., 160° C., 170° C., 180° C., 190° C., or 200° C., or more, including any intervening ranges. By “substantially a liquid” is it meant that the bioliquid stream can be pumped using a liquid pump (e.g., a positive-displacement pump, a centrifugal pump, or an axial-flow pump), or gravity-fed into the kinetic interface reactor. It will be recognized that the liquid will usually be in equilibrium with a vapor, dictated by the vapor-liquid phase equilibrium of the bioliquid stream.

Various classes of compounds can be present in the bioliquid stream. There can be C₁ compounds, including (but not limited to) formic acid, methanol, and formaldehyde. There can be C₂-C₄ linear hydroxyl-substituted and oxo-substituted aldehydes and ketones, such as (but not limited to) hydroxyacetaldehyde and hydroxyacetone. There can be C₂-C₄ acids, such as (but not limited to) acetic acid and levulinic acid. There can be C₅-C₆ hydroxyl-, hydroxymethyl-, or oxo-substituted furans, furanones, lactones, and pyranones. Anhydrosugars, including C₅ and C₆ anhydrosugars (such as levoglucosan), and anhydrooligosaccharides can be present. There can be monomeric methoxyl-substituted phenols. There can be water-soluble carbohydrate-derived oligomeric and polymeric species. Various forms of lignin, such as monomeric lignin, low-molecular-weight lignin, high-molecular-weight lignin, condensed lignin, or pyrolytic lignin can be present. Water can be present.

In some embodiments, in the step of providing a bioliquid stream, a combination of a biogas and a bioliquid is provided, comprising both carbon-containing vapors as well as carbon-containing liquids. In such embodiments, the carbon-containing liquids can be condensed carbon-containing vapors, or other liquids from another source. The carbon-containing vapors can be derived from vaporization of carbon-containing liquids. The carbon-containing vapors and carbon-containing liquids can be in equilibrium. Alternatively, the carbon-containing vapors and the carbon-containing liquids can be present in a non-equilibrium state, such as a state that is kinetically controlled or mass-transfer limited.

In some embodiments, during the converting, the biocoke forms on the surface of the kinetic interface media. Alternatively or additionally, during the converting, the biocoke forms in an internal phase of the kinetic interface media. When the biocoke forms in an internal phase, the biocoke can be in the same material phase as the kinetic interface media solid phase, forming a solid solution or alloy, for example. Alternatively, the biocoke can phase-segregate and form its own solid phase within the kinetic interface media. The separate phase can be located at or near the surface of the kinetic interface media, which is beneficial for downstream separation.

In some embodiments, during the converting, effective reaction conditions for the converting comprise a coking temperature of at least about 400° C. to at most about 1200° C., for example, about, at least about, or at most about 400° C., 450° C., 500° C., 550° C., 600° C., 650° C., 700° C., 750° C., 800° C., 850° C., 900° C., 950° C., 1000° C., 1050° C., 1100° C., 1150° C., or 1200° C., including any intervening ranges.

In some embodiments, during the converting, effective reaction conditions for the converting comprise a coking pressure of at least about 1 bar to at most about 40 bar; for example, about, at least about, or at most about 1, 2, 3, 4, 5, 6, 7, 8, 9, 10, 15, 20, 25, 30, 35, or 40 bar, including any intervening ranges.

In some embodiments, during the converting, effective reaction conditions for the converting comprise a coking liquid-phase residence time of at least about 1 minute to at most about 8 hours; for example about, at least about, or at most about 1 min, 2 min, 3 min, 4 min, 5 min, 10 min, 15 min, 20 min, 25 min, 30 min, 40 min, 50 min, or 60 min, or 1 hr, 2 hr, 3 hr, 4 hr, 6 hr, or 8 hr, including any intervening ranges.

In some embodiments, during the converting, effective reaction conditions for the converting comprise a coking solid-phase residence time of at least about 1 minute to at most about 24 hours; for example, about, at least about, or at most about 1 min, 5 min, 10 min, 15 min, 30 min, 45 min, 60 min, 1.5 hr, 2 hr, 3 hr, 4 hr, 8 hr, 12 hr, 16 hr, 20 hr, or 24 hr, including any intervening ranges.

In some embodiments, during the converting, effective reaction conditions for the converting comprise a kinetic interface media residence time of at least about 1 minute to at most about 24 hours; for example, about, at least about, or at most about 1 min, 5 min, 10 min, 15 min, 30 min, 45 min, 60 min, 1.5 hr, 2 hr, 3 hr, 4 hr, 8 hr, 12 hr, 16 hr, 20 hr, or 24 hr, including any intervening ranges. The kinetic interface media residence time can be the same as the coking solid-phase residence time. Alternatively, the kinetic interface media residence time can be higher than the coking solid-phase residence time, or lower than the coking solid-phase residence time.

In some embodiments, during the converting, effective reaction conditions for the converting comprise coking reactions that are seeded by the kinetic interface media as a reaction matrix. Alternatively or additionally, the effective reaction conditions comprise coking reactions that are catalyzed by the kinetic interface media. Alternatively or additionally, the effective reaction conditions can comprise coking reactions that are catalyzed by a separate coking catalyst introduced to the kinetic interface reactor.

In some embodiments, in (i.e., as a result of) the converting, carbon conversion of the carbon-containing liquid to biocoke is about, or at least about 25%, 30%, 35%, 40%, 45%, 50%, 55%, 60%, 65%, 70%, 75%, 80%, 85%, 90%, 95%, or 99%, including any intervening ranges.

In some embodiments, the processes further comprise conveying at least some of the solid biocoke-containing kinetic interface media to a pyrolysis reactor; and generating pyrolyzed solid biocoke-containing kinetic interface media. Optionally, that pyrolyzed solid biocoke-containing kinetic interface media can be introduced back to the kinetic interface reactor.

In some embodiments, the processes further comprise recovering a kinetic interface reactor off-gas stream, wherein the kinetic interface reactor off-gas stream comprises carbon-containing vapor. The kinetic interface reactor off-gas stream can be combusted to generate energy. The energy can be utilized to heat a pyrolysis reactor configured to provide the kinetic interface media comprising or consisting essentially of a pyrolyzed form of a first biomass feedstock, for example. The kinetic interface reactor off-gas stream can be partially oxidized to generate a reducing gas. The kinetic interface reactor off-gas stream can be recycled to an inlet of the kinetic interface reactor.

In some embodiments, the processes further comprise recycling the solid biocoke-containing kinetic interface media to an inlet of the kinetic interface reactor.

In some embodiments, the processes further comprise removing, during or after the recovering, at least some of the biocoke from the solid biocoke-containing kinetic interface media, thereby forming a regenerated kinetic interface media; and recycling the regenerated kinetic interface media to an inlet of the kinetic interface reactor.

In some embodiments, the processes further comprise removing, during or after the recovering, at least some of the biocoke from the solid biocoke-containing kinetic interface media, thereby forming a regenerated kinetic interface media, wherein the regenerated kinetic interface media comprises carbon; and conveying the regenerated kinetic interface media to a pyrolysis reactor.

In some embodiments, the processes further comprise carbonizing, in the kinetic interface reactor, the kinetic interface media, wherein the kinetic interface media comprises carbon, and wherein the carbonizing is separate from the converting the carbon-containing vapor to the biocoke.

In some embodiments, the kinetic interface media comprises or consists essentially of a raw biomass feedstock. In some embodiments, the kinetic interface media comprises a mixture of raw biomass and pyrolyzed biomass, or another type of pretreated biomass with or without raw biomass present.

In some embodiments, the kinetic interface reactor is a fluidized-bed reactor, a falling-bed reactor, a gravity-driven vessel, or a rotary kiln. In some embodiments, the kinetic interface reactor is a vertical vessel or a slanted vessel, or a horizontal vessel. Where the kinetic interface reactor is a rotary kiln, the rotary kiln can be configured such that the kinetic interface media tumbles radially and the bioliquid stream flows axially.

In some embodiments, the kinetic interface reactor is configured with a mechanical conveyor. In some embodiments, the mechanical conveyor is a screw conveyor, a belt conveyor, a chain conveyor, a continuous-flow conveyor, or a recirculating conveyor. The mechanical conveyor moves solid material into, through, and/or out of the kinetic interface reactor.

In some embodiments, the process does not result in a spatially continuous solid mass filled within the kinetic interface reactor.

In some embodiments, the removing is conducted continuously or semi-continuously. In some embodiments, the removing is conducted with the forming. In some embodiments, the removing is conducted batch-wise.

In some embodiments, the entire process (i.e., all process steps) is a continuous or semi-continuous process.

In some embodiments, the kinetic interface media comprises at least about 5, 10, 15, 20, 25, 30, 35, 40, 45, 50, 55, 60, 5, 70, 75, 80, 81, 82, 83, 84, 85, 86, 87, 88, 89, 90, 91, 92, 93, 94, or 95 wt % total carbon, including all intervening ranges.

In some embodiments, the kinetic interface media comprises at least about 20, 25, 30, 35, 40, 45, 50, 55, 60, 5, 70, 75, 80, 81, 82, 83, 84, 85, 86, 87, 88, 89, 90, 91, 92, 93, 94, or 95 wt % fixed carbon, including all intervening ranges.

In some embodiments, the solid biocoke-containing kinetic interface media comprises at least about 40, 45, 50, 55, 60, 65, 70, 71, 72, 73, 74, 75, 76, 77, 78, 79, 80, 81, 82, 83, 84, or 85 wt % fixed carbon, including all intervening ranges.

In various embodiments, the solid biocoke-containing kinetic interface media comprises about, at least about, or at most about 50, 55, 60, 65, 70, 75, 80, 85, 90, or 95 wt % fixed carbon.

In some embodiments, the biocoke comprises about, or at least about 70, 75, 80, 85, 90, 91, 92, 93, 94, 95, 96, 97, 98, or 99 wt % fixed carbon, including all intervening ranges.

It is not uncommon that the biocoke has a higher carbon content than kinetic interface media. It is also possible for the carbon content of the biocoke to be about the same as the average carbon content of the solid biocoke-containing kinetic interface media.

In some embodiments, the biocoke comprises essentially no ash. In some embodiments, the biocoke has a lower ash content than kinetic interface media.

In some embodiments, the processes further comprise generating free biocoke particles from the carbon-containing liquid, wherein the free biocoke particles are not chemically or physically combined with the kinetic interface media. In some embodiments, the free biocoke particles are derived only from the carbon-containing liquid and not directly from the kinetic interface media. In other embodiments, the free biocoke particles are derived both from the carbon-containing liquids as well as from the kinetic interface media (when it initially or transiently contains carbon).

In some embodiments, the kinetic interface media comprises carbon, wherein the free biocoke particles are derived both from the carbon-containing liquid and from the kinetic interface media. In some embodiments, the free biocoke particles are derived from the carbon-containing vapor, wherein formation of the free biocoke particles is catalyzed or seeded by the kinetic interface media.

The total carbon within the solid biocoke-containing kinetic interface media can be at least about 40, 45, 50, 55, 60, 65, 70, 75, 80, 85, 90, 91, 92, 93, 94, 95, 96, 97, 98, 99%, 100% (“fully”) renewable as determined from a measurement of the ¹⁴C/¹²C isotopic ratio of the total carbon in the solid biocoke-containing kinetic interface media.

The total carbon within the biocoke can be at least about 40, 45, 50, 55, 60, 65, 70, 75, 80, 85, 90, 91, 92, 93, 94, 95, 96, 97, 98, 99%, or 100% renewable as determined from a measurement of the ¹⁴C/¹²C isotopic ratio of the total carbon in the solid biocoke.

In some embodiments, the processes further comprise adding a carbonization agent, The carbonization agent can comprise a metal, a metal alloy, a metal oxide, a metal hydroxide, a metal hydride, a metal sulfide, a metal nitride, a metal halide, a metal salt, a mineral, a natural polymer, a synthetic polymer, an acid, a base, a non-metal salt, an organic halide, an inorganic halide, or a derivative or a combination thereof.

### Continuous or Semi-Continuous Processes for Producing Biocoke Utilizing a Biogas Stream

Disclosed herein are continuous or semi-continuous processes for producing biocoke. Such processes can comprise: providing a heated biogas stream, wherein the heated biogas stream comprises carbon-containing vapor; introducing the heated biogas stream to a kinetic interface reactor; converting, using the kinetic interface reactor, the carbon-containing vapor to solid biocoke; withdrawing, continuously or semi-continuously, the solid biocoke; returning, continuously, semi-continuously, or periodically, a recycled portion of the solid biocoke to the kinetic interface reactor, wherein the recycled portion of the solid biocoke is a kinetic interface media comprised within the kinetic interface reactor; and recovering the solid biocoke as a biocoke product; wherein the process does not result in a spatially continuous solid mass filled within the kinetic interface reactor.

In some embodiments, such processes can comprise generating the heated biogas stream, wherein the generating is achieved by pyrolyzing a biomass feedstock. The heated biogas stream can comprise pyrolysis vapors, where the pyrolysis vapors can comprise CO, CO₂, an alkane, an olefin, an aromatic, an aldehyde, a ketone, an acid, an alcohol, or a combination thereof. Pyrolysis vapors that do not comprise carbon can also be present, such as (but not limited to) H₂, H₂O, and N₂.

In some embodiments, during the converting, carbon conversion of the carbon-containing vapor is at least about: 45, 50, 40, 45, 50, 55, 60, 65, 70, 75, 80, 85, 90, 91, 92, 93, 94, 95, 96, 97, 98, or 99%, including all intervening ranges; for example, at least about 50% or at least about 75%.

In some embodiments, the biocoke product comprises at least about: 85, 90, 91, 92, 93, 94, 95, 96, 97, 98, 99, 99.5, 99.9, or 100 wt % fixed carbon, including all intervening ranges. For example, at least about 90 wt % fixed carbon.

In some embodiments, total carbon within the biocoke product is 85, 90, 91, 92, 93, 94, 95, 96, 97, 98, or 99%, or is 100% (or “fully”), including all intervening ranges, renewable as determined from a measurement of the ¹⁴C/¹²C isotopic ratio of the total carbon. For example, is fully renewable as determined from a measurement of the ¹⁴C/¹²C isotopic ratio of the total carbon.

### Continuous Processes for Producing Biocoke Using Heated Biogas

Also disclosed herein are continuous or processes for producing biocoke. These continuous processes for producing biocoke can comprise: providing a bioliquid stream, wherein the bioliquid stream comprises a carbon-containing liquid; introducing the bioliquid stream to a kinetic interface reactor; converting, using the kinetic interface reactor, the carbon-containing liquid to solid biocoke; continuously withdrawing the solid biocoke from the kinetic interface reactor; continuously returning a recycled portion of the solid biocoke to the kinetic interface reactor, wherein the recycled portion of the solid biocoke is a kinetic interface media contained within the kinetic interface reactor; and recovering the solid biocoke as a biocoke product; wherein the continuous process does not result in a spatially continuous solid mass filled within the kinetic interface reactor.

Some variations of the technology provide a continuous process for producing biocoke, the continuous process comprising:
providing a heated biogas stream, wherein the heated biogas stream comprises carbon-containing vapor;
introducing the heated biogas stream to a kinetic interface reactor;
converting, using the kinetic interface reactor, the carbon-containing vapor to solid biocoke;
continuously withdrawing the solid biocoke;
continuously returning a recycled portion of the solid biocoke to the kinetic interface reactor, wherein the recycled portion of the solid biocoke is a kinetic interface media contained within the kinetic interface reactor; and
recovering the solid biocoke as a biocoke product, wherein the biocoke product contains at least 75 wt % fixed carbon, and wherein total carbon within the biocoke product is at least 50% renewable as determined from a measurement of the ¹⁴C/¹²C isotopic ratio of the total carbon,
wherein the process does not result in a spatially continuous solid mass filled within the kinetic interface reactor.

In some embodiments, the process further comprises generating the heated biogas stream by pyrolyzing a biomass feedstock, wherein the carbon-containing vapor is a pyrolysis vapor. The biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments, the carbon-containing vapor is selected from CO, 002, an alkane (e.g., ethane), an olefin (e.g., propylene), an aromatic (e.g., toluene), an aldehyde (e.g., acetaldehyde), a ketone (e.g., acetylacetone), an acid (e.g., formic acid), an alcohol (e.g., propanol), or a combination thereof. Pyrolysis liquids that do not contain carbon can also be present—for example, water.

In some embodiments, the kinetic interface media is in the form of pellets. The pellets can be characterized by an average pellet effective diameter of at least about 1 millimeter to at most about 10 centimeters.

In some embodiments, the kinetic interface media is in the form of a powder. The powder can be characterized by an average particle size of at least about 1 micron to at most about 500 microns.

In some embodiments, the kinetic interface media is in the form of granules. The granules can be characterized by an average granule effective diameter of at least about 100 microns to at most about 10 millimeters.

In some embodiments, during the converting step, the solid biocoke forms on the surface of the kinetic interface media. Alternatively, or additionally, during the converting step, the solid biocoke forms in an internal phase of the kinetic interface media.

In some embodiments, during the converting step, effective reaction conditions comprise a coking temperature of at least about 400° C. to at most about 1200° C.

In some embodiments, during the converting step, effective reaction conditions comprise a coking pressure of at least about 1 bar to at most about 40 bar.

In some embodiments, during the converting step, effective reaction conditions comprise a coking vapor-phase residence time of at least about 1 second to at most about 1 hour.

In some embodiments, during the converting step, effective reaction conditions comprise a coking solid-phase residence time of at least about 1 minute to at most about 24 hours.

In some embodiments, during the converting step, effective reaction conditions comprise a kinetic interface media residence time of at least about 1 minute to at most about 24 hours.

In some embodiments, during the converting step, effective reaction conditions comprise coking reactions that are seeded by the kinetic interface media as a reaction matrix. In these embodiments, the kinetic interface media seeds or initiates carbon growth but does not function as a true catalyst.

In some embodiments, during the converting step, effective reaction conditions comprise coking reactions that are catalyzed by the kinetic interface media.

In some embodiments, during the converting step, effective reaction conditions comprise coking reactions that are catalyzed by a separate coking catalyst, other than the kinetic interface media, introduced to the kinetic interface reactor. In certain embodiments, the separate coking catalyst is continuously or periodically regenerated for reuse in the kinetic interface reactor. For example, when the separate coking catalyst is an aluminosilicate, and the catalyst becomes inactivated by recalcitrant forms of carbon, oxidation in air can regenerate the catalyst.

In some embodiments, during the converting step, effective reaction conditions comprise uncatalyzed coking reactions that generate free biocoke particles from the carbon-containing vapor. In certain embodiments, the free biocoke particles do not become chemically or physically combined with the kinetic interface media. In other embodiments, the free biocoke particles, after being formed, become chemically or physically combined with the kinetic interface media.

In some embodiments, the carbon conversion of the carbon-containing vapor to solid biocoke is at least 25% in the converting step. In certain embodiments, the carbon conversion is at least 50%, at least 75%, or at least 90%. In various embodiments, during the converting, carbon conversion of the carbon-containing liquid is at least about 45, 50, 40, 45, 50, 55, 60, 65, 70, 75, 80, 85, 90, 91, 92, 93, 94, 95, 96, 97, 98, or 99%, including any intervening ranges.

In some embodiments, the process further comprises recovering a kinetic interface reactor off-gas stream comprising unconverted carbon-containing vapor. The kinetic interface reactor off-gas stream can be combusted with air or oxygen, thereby generating energy. The energy can be used to heat a pyrolysis reactor configured to provide the kinetic interface media, wherein the kinetic interface media comprises a pyrolyzed form of a first biomass feedstock. Alternatively, or additionally, the kinetic interface reactor off-gas stream can be partially oxidized with air or oxygen, thereby generating a reducing gas containing H₂ and/or CO.

In some embodiments, the kinetic interface reactor is a fluidized-bed reactor, a falling-bed reactor, a gravity-driven vessel, a vertical vessel, a slanted vessel, a horizontal vessel, or a rotary kiln. A rotary kiln can be configured such that the kinetic interface media tumbles radially and the heated biogas stream flows axially.

In some embodiments, the kinetic interface reactor is configured with a mechanical conveyor, such as to convey recycled biocoke to the kinetic interface reactor, to convey kinetic interface media through the kinetic interface reactor, and/or to convey solid biocoke product out of the kinetic interface reactor. The mechanical conveyor can be selected from a screw conveyor, a belt conveyor, a chain conveyor, a continuous-flow conveyor, or a recirculating conveyor, for example.

In some embodiments, the biocoke product comprises at least about 80 wt % fixed carbon, at least about 90 wt % fixed carbon, at least about 95 wt % fixed carbon, or at least about 99 wt % fixed carbon. In various embodiments, the biocoke product comprises about, or at least about 80, 85, 90, 91, 92, 93, 94, 95, 96, 97, 98, 99, 99.5, or 99.9 wt % fixed carbon, including any intervening ranges.

In some embodiments, total carbon within the biocoke product is at least about 75% renewable as determined from a measurement of the ¹⁴C/¹²C isotopic ratio of the total carbon. In certain embodiments, the total carbon within the biocoke product is at least about 90% renewable, or 100% (fully) renewable, as determined from a measurement of the ¹⁴C/¹²C isotopic ratio of the total carbon. In various embodiments, total carbon within the biocoke product is 85, 90, 91, 92, 93, 94, 95, 96, 97, 98, 99%, or 100% renewable as determined from a measurement of the ¹⁴C/¹²C isotopic ratio of the total carbon.

In some embodiments, the biocoke product comprises essentially no ash.

In some embodiments, in the recovering, the solid biocoke and the kinetic interface media are separated from each other.

In some embodiments, the process further comprises adding a carbonization agent, wherein the carbonization agent comprises a metal, a metal alloy, a metal oxide, a metal hydroxide, a metal hydride, a metal sulfide, a metal nitride, a metal halide, a metal salt, a mineral, a natural polymer, a synthetic polymer, an acid, a base, a non-metal salt, an organic halide, an inorganic halide, or a derivative or a combination thereof.

### Continuous Processes for Producing Biocoke Using Bioliquid

Other variations of the technology provide a continuous process for producing biocoke, the continuous process comprising:
providing a bioliquid stream, wherein the bioliquid stream comprises carbon-containing liquid;
introducing the bioliquid stream to a kinetic interface reactor;
converting, using the kinetic interface reactor, the carbon-containing liquid to solid biocoke;
continuously withdrawing the solid biocoke;
continuously returning a recycled portion of the solid biocoke to the kinetic interface reactor, wherein the recycled portion of the solid biocoke is a kinetic interface media contained within the kinetic interface reactor; and
recovering the solid biocoke as a biocoke product, wherein the biocoke product contains at least 75 wt % fixed carbon, and wherein total carbon within the biocoke product is at least 50% renewable as determined from a measurement of the isotopic ratio of the total carbon,
wherein the process does not result in a spatially continuous solid mass filled within the kinetic interface reactor.

In some processes utilizing a bioliquid stream, the process further comprises generating the bioliquid stream by pyrolyzing a biomass feedstock, and collecting a condensed pyrolysis vapor as the carbon-containing liquid. The biomass feedstock can comprise softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

In some embodiments utilizing a bioliquid stream, the bioliquid stream comprises one or more alkanes (e.g., n-hexane), olefins (e.g., cyclopentene), aromatics (e.g., lignin fragments), aldehydes (e.g., n-hexanal), ketones (e.g., cyclohexanone), acids (e.g., lignosulfonic acid), alcohols (e.g., cyclohexanol), or a combination thereof.

In some embodiments utilizing a bioliquid stream, the kinetic interface media is in the form of pellets. The pellets can be characterized by an average pellet effective diameter of at least about 1 millimeter to at most about 10 centimeters.

In some embodiments utilizing a bioliquid stream, the kinetic interface media is in the form of a powder. The powder can be characterized by an average particle size of at least about 1 micron to at most about 500 microns.

In some embodiments utilizing a bioliquid stream, the kinetic interface media is in the form of granules. The granules can be characterized by an average granule effective diameter of at least about 100 microns to at most about 10 millimeters.

In some embodiments utilizing a bioliquid stream, during the converting step, the solid biocoke forms on the surface of the kinetic interface media. Alternatively, or additionally, during the converting step, the solid biocoke forms in an internal phase of the kinetic interface media.

In some embodiments utilizing a bioliquid stream, during the converting step, effective reaction conditions comprise a coking temperature of at least about 400° C. to at most about 1200° C.

In some embodiments utilizing a bioliquid stream, during the converting step, effective reaction conditions comprise a coking pressure of at least about 1 bar to at most about 40 bar.

In some embodiments utilizing a bioliquid stream, during the converting step, effective reaction conditions comprise a coking liquid-phase residence time of at least about 1 minute to at most about 1 hour.

In some embodiments utilizing a bioliquid stream, during the converting step, effective reaction conditions comprise a coking solid-phase residence time of at least about 1 minute to at most about 24 hours.

In some embodiments utilizing a bioliquid stream, during the converting step, effective reaction conditions comprise a kinetic interface media residence time of at least about 1 minute to at most about 24 hours.

In some embodiments utilizing a bioliquid stream, during the converting step, effective reaction conditions comprise coking reactions that are seeded by the kinetic interface media as a reaction matrix.

In some embodiments utilizing a bioliquid stream, during the converting step, effective reaction conditions comprise coking reactions that are catalyzed by the kinetic interface media.

In some embodiments utilizing a bioliquid stream, during the converting step, effective reaction conditions comprise coking reactions that are catalyzed by a separate coking catalyst, other than the kinetic interface media, introduced to the kinetic interface reactor. In certain embodiments, the separate coking catalyst is continuously or periodically regenerated for reuse in the kinetic interface reactor. For example, when the separate coking catalyst is a metal or metal hydride, and the catalyst becomes poisoned by sulfur, regeneration in hydrogen can return the catalyst to the metal or metal hydride form.

In some embodiments utilizing a bioliquid stream, during the converting step, effective reaction conditions comprise uncatalyzed coking reactions that generate free biocoke particles from the carbon-containing vapor. In certain embodiments, the free biocoke particles do not become chemically or physically combined with the kinetic interface media. In other embodiments, the free biocoke particles, after being formed, become chemically or physically combined with the kinetic interface media.

In some embodiments utilizing a bioliquid stream, the carbon conversion of the carbon-containing vapor to solid biocoke is at least 25% in the converting step. In certain embodiments, the carbon conversion is at least 50%, at least 75%, or at least 90%. In various embodiments, during the converting, carbon conversion of the carbon-containing liquid is at least about 45, 50, 40, 45, 50, 55, 60, 65, 70, 75, 80, 85, 90, 91, 92, 93, 94, 95, 96, 97, 98, or 99%, including any intervening ranges.

In some embodiments utilizing a bioliquid stream, the process further comprises recovering a kinetic interface reactor off-gas stream comprising carbon-containing vapor formed within the reactor (e.g., from vaporization of bioliquid components or from chemical reactions). The kinetic interface reactor off-gas stream can be combusted with air or oxygen, thereby generating energy. The energy can be used to heat a pyrolysis reactor configured to provide a kinetic interface media comprising a pyrolyzed form of a first biomass feedstock. Alternatively, or additionally, the kinetic interface reactor off-gas stream can be partially oxidized with air or oxygen, thereby generating a reducing gas containing H₂ and/or CO.

In some embodiments utilizing a bioliquid stream, the kinetic interface reactor is a fluidized-bed reactor, a falling-bed reactor, a gravity-driven vessel, a vertical vessel, a slanted vessel, a horizontal vessel, or a rotary kiln. A rotary kiln can be configured such that the kinetic interface media tumbles radially and the bioliquid stream flows axially.

In some embodiments utilizing a bioliquid stream, the kinetic interface reactor is configured with a mechanical conveyor, such as to convey recycled biocoke to the kinetic interface reactor, to convey kinetic interface media through the kinetic interface reactor, and/or to convey solid biocoke product out of the kinetic interface reactor. The mechanical conveyor can be selected from a screw conveyor, a belt conveyor, a chain conveyor, a continuous-flow conveyor, or a recirculating conveyor, for example.

In some embodiments utilizing a bioliquid stream, the biocoke product comprises at least about 80 wt % fixed carbon, at least about 90 wt % fixed carbon, at least about 95 wt % fixed carbon, or at least about 99 wt % fixed carbon. In various embodiments, the biocoke product comprises about, or at least about 80, 85, 90, 91, 92, 93, 94, 95, 96, 97, 98, 99, 99.5, or 99.9 wt % fixed carbon, including any intervening ranges.

In some embodiments utilizing a bioliquid stream, total carbon within the biocoke product is at least about 75% renewable as determined from a measurement of the ¹⁴C/¹²C isotopic ratio of the total carbon. In certain embodiments, the total carbon within the biocoke product is at least about 90% renewable, or 100% (“fully”) renewable, as determined from a measurement of the ¹⁴C/¹²C isotopic ratio of the total carbon. In various embodiments, total carbon within the biocoke product is 85, 90, 91, 92, 93, 94, 95, 96, 97, 98, 99%, or 100% renewable as determined from a measurement of the ¹⁴C/¹²C isotopic ratio of the total carbon.

In some embodiments utilizing a bioliquid stream, the biocoke product comprises essentially no ash.

In some embodiments utilizing a bioliquid stream, in the recovering step, the solid biocoke and the kinetic interface media are separated from each other.

In some embodiments utilizing a bioliquid stream, the process further comprises adding a carbonization agent, wherein the carbonization agent comprises a metal, a metal alloy, a metal oxide, a metal hydroxide, a metal hydride, a metal sulfide, a metal nitride, a metal halide, a metal salt, a mineral, a natural polymer, a synthetic polymer, an acid, a base, a non-metal salt, an organic halide, an inorganic halide, or a derivative or a combination thereof.

### Systems for Producing Biocoke

Disclosed herein are systems configured for carrying out any of the disclosed process.

Still other variations provide a system for producing biocoke, wherein the system comprises:
a kinetic interface reactor;
a first inlet configured for feeding a heated biogas stream and/or a bioliquid stream into the kinetic interface reactor, wherein the heated biogas stream comprises a carbon-containing vapor, and wherein the bioliquid stream comprises a carbon-containing liquid;
a kinetic interface media contained within the kinetic interface reactor, wherein the kinetic interface media is in solid form, and wherein the kinetic interface reactor is configured to operate under effective reaction conditions to convert the carbon-containing vapor to biocoke that is chemically or physically combined with the kinetic interface media; and
a first outlet configured for withdrawing the biocoke.

In some systems, the first inlet is configured for feeding a heated biogas stream into the kinetic interface reactor. In other systems, the first inlet is configured for feeding a bioliquid stream into the kinetic interface reactor. In certain systems, the first inlet is configured for feeding a mixture of a heated biogas stream and a bioliquid stream (e.g., a supersaturated wet vapor stream) into the kinetic interface reactor. In certain systems, the first inlet is configured for feeding either a heated biogas stream or a bioliquid stream, or both, at different times, when the kinetic interface reactor is designed to operate on either a heated biogas stream, or a bioliquid stream, or a mixture thereof.

In some systems, the kinetic interface reactor is selected from a fluidized-bed reactor, a falling-bed reactor, a gravity-driven vessel, a vertical vessel, a slanted vessel, a horizontal vessel, a rotary kiln, or a combination thereof. In systems employing a rotary kiln as the kinetic interface reactor (or one of multiple kinetic interface reactors), the rotary kiln can be configured such that the kinetic interface media tumbles radially and the heated biogas stream and/or the bioliquid stream flows axially.

Some systems are configured with a mechanical conveyor to feed the kinetic interface media into and/or through and/or out of the kinetic interface reactor. The mechanical conveyor can be a screw conveyor, a belt conveyor, a chain conveyor, a continuous-flow conveyor, a recirculating conveyor, or a combination thereof.

Certain variations provide a system for continuously producing biocoke, wherein the system comprises a kinetic interface reactor, wherein the kinetic interface reactor comprises a first inlet configured for feeding a heated biogas stream and/or a bioliquid stream into the kinetic interface reactor, wherein the heated biogas stream comprises a carbon-containing vapor, and wherein the bioliquid stream comprises a carbon-containing liquid, wherein the kinetic interface reactor is configured to operate under effective reaction conditions to convert the carbon-containing vapor and/or the carbon-containing liquid to solid biocoke, wherein the kinetic interface reactor comprises a first outlet configured for continuously or semi-continuously withdrawing the solid biocoke, wherein the kinetic interface reactor comprises a second inlet configured for feeding at least some of the solid biocoke that was withdrawn from the outlet, and wherein the first outlet, or a second outlet, is configured for withdrawing and recovering a biocoke product.

In some systems designed for continuously producing biocoke, the first inlet is configured for feeding a heated biogas stream into the kinetic interface reactor. In other systems, the first inlet is configured for feeding a bioliquid stream into the kinetic interface reactor. In certain systems, the first inlet is configured for feeding a mixture of a heated biogas stream and a bioliquid stream (e.g., a liquid stream entrained with bubbles of heated biogas) into the kinetic interface reactor. In certain systems, the first inlet is configured for feeding either a heated biogas stream or a bioliquid stream, or both, at different times, when the kinetic interface reactor is designed to operate on either a heated biogas stream, or a bioliquid stream, or a mixture thereof.

In some systems designed for continuously producing biocoke, the kinetic interface reactor is selected from a fluidized-bed reactor, a falling-bed reactor, a gravity-driven vessel, a vertical vessel, a slanted vessel, a horizontal vessel, a rotary kiln, or a combination thereof. In systems employing a rotary kiln as the kinetic interface reactor (or one of multiple kinetic interface reactors), the rotary kiln can be configured such that the kinetic interface media tumbles radially and the heated biogas stream and/or the bioliquid stream flows axially.

In some systems designed for continuously producing biocoke, the system contains a mechanical conveyor configured to feed the kinetic interface media into and/or through and/or out of the kinetic interface reactor. The mechanical conveyor can be a screw conveyor, a belt conveyor, a chain conveyor, a continuous-flow conveyor, a recirculating conveyor, or a combination thereof.

### Compositions and Products

Disclosed herein are biocoke compositions produced according to any of the processes disclosed herein, where such compositions can also be described as “biocoke products”.

In some variations, a biocoke product is produced by a process comprising:
providing a heated biogas stream, wherein the heated biogas stream comprises a carbon-containing vapor;
providing a kinetic interface media, wherein the kinetic interface media is in solid form;
introducing the kinetic interface media and the heated biogas stream to a kinetic interface reactor;
converting, using the kinetic interface reactor, the carbon-containing vapor to biocoke, wherein the biocoke contains at least 75 wt % fixed carbon, wherein total carbon within the biocoke is at least 50% renewable as determined from a measurement of the ¹⁴C/¹²C isotopic ratio of the total carbon, and wherein the biocoke is chemically or physically combined with the kinetic interface media, thereby forming a solid biocoke-containing kinetic interface media;
removing the solid biocoke-containing kinetic interface media from the kinetic interface reactor; and
recovering a biocoke product from the solid biocoke-containing kinetic interface media.

In other variations, a biocoke product is produced by a process comprising:
providing a bioliquid stream, wherein the bioliquid stream comprises a carbon-containing liquid;
providing a kinetic interface media, wherein the kinetic interface media is in solid form;
introducing the kinetic interface media and the bioliquid stream to a kinetic interface reactor;
converting, using the kinetic interface reactor, the carbon-containing liquid to biocoke, wherein the biocoke contains at least 75 wt % fixed carbon, wherein total carbon within the biocoke is at least 50% renewable as determined from a measurement of the ¹⁴C/¹²C isotopic ratio of the total carbon, and wherein the biocoke is chemically or physically combined with the kinetic interface media, thereby forming a solid biocoke-containing kinetic interface media;
removing the solid biocoke-containing kinetic interface media from the kinetic interface reactor; and
recovering a biocoke product from the solid biocoke-containing kinetic interface media.

A biocoke product can be in the form of a powder or a pellet, for example. A pellet can utilize a pellet binder. When the kinetic interface media is in the form of a pellet, or when a biocoke product is in the form of a pellet, a pellet binder can be present.

A binder can comprise or consist essentially of starch, thermoplastic starch, crosslinked starch, starch polymer, cellulose, cellulose ether, hemicellulose, methylcellulose, chitosan, lignin, lactose, sucrose, dextrose, maltodextrin, banana flour, wheat flour, wheat starch, soy flour, corn flour, wood flour, coal tar, coal fines, met coke, asphalt, coal-tar pitch, petroleum pitch, bitumen, pyrolysis tar, gilsonite, bentonite clay, borax, limestone, lime, wax, vegetable wax, baking soda, baking powder, sodium hydroxide, potassium hydroxide, iron ore concentrate, silica fume, gypsum, Portland cement, guar gum, xanthan gum, polyvidone, polyacrylamide, polylactide, formaldehyde, phenol-formaldehyde resin, vegetable resin, recycled shingle, recycled tires, peat, sphagnum peat, a derivative thereof, or any combination of the foregoing, for example. In certain embodiments, a binder is selected from starch, thermoplastic starch, crosslinked starch, starch polymer, a derivative thereof, or a combination of the foregoing.

In some embodiments, no external binder is used. In these embodiments, materials already present, such as lignin or condensed vapors, can act as an in situ binder for the pellet.

When the kinetic interface media comprises pyrolyzed biomass, the pyrolyzed biomass can be obtained by subjecting biomass to a pyrolysis temperature of at least about 300° C. to at most about 1200° C., for a pyrolysis time of at least about 10 seconds to at most about 24 hours. Pyrolysis conditions are discussed in more detail further herein.

In some embodiments, pyrolyzed biomass, solid biocoke-containing kinetic interface media, or solid biocoke are milled utilizing a mechanical-treatment apparatus. The mechanical-treatment apparatus can comprise a hammer mill, an extruder, an attrition mill, a disc mill, a pin mill, a ball mill, a cone crusher, a jaw crusher, or a combination thereof, for example. In some embodiments, the intermediate material can be milled utilizing a mechanical-treatment apparatus, such as a hammer mill, an extruder, an attrition mill, a disc mill, a pin mill, a ball mill, a cone crusher, a jaw crusher, or a combination thereof, for example.

A biocoke composition can comprise at least about 50 wt % fixed carbon, at least about 60 wt % fixed carbon, at least about 70 wt % fixed carbon, at least about 75 wt % fixed carbon, at least about 80 wt % fixed carbon, at least about 85 wt % fixed carbon, or at least about 90 wt % fixed carbon. In various embodiments, the biocoke composition comprises about, at least about, or at most about 55, 60, 65, 70, 75, 80, 85, or 90 wt % fixed carbon.

The biocoke composition can comprise at least about 55 wt % total carbon, at least about 60 wt % total carbon, at least about 70 wt % total carbon, at least about 75 wt % total carbon, at least about 80 wt % total carbon, at least about 85 wt % total carbon, at least about 90 wt % total carbon, or at least about 95 wt % total carbon. In various embodiments, the biocoke composition comprises about, at least about, or at most about 60, 65, 70, 75, 80, 85, 90, or 95 wt % total carbon, including all intervening ranges.

In some embodiments, the biocoke composition comprises at most about 10 wt % ash, at most about 5 wt % ash, at most about 2 wt % ash, or at most about 1 wt % ash. In various embodiments, the biocoke composition contains about, or at most about, 10, 9, 8, 7, 6, 5, 4, 3, 2, 1, 0.5, 0.2, or 0.1 wt % ash, including all intervening ranges.

In some processes, the biocoke composition is characterized by a Hardgrove Grindability Index of at least 30 or at least 50. In various embodiments, the biocoke composition is characterized by a Hardgrove Grindability Index of about, at least about, or at most about 20, 25, 30, 35, 40, 45, 50, 55, 60, 65, 70, 75, 80, 85, 90, 95, or 100, including all intervening ranges.

In some processes, the biocoke composition is characterized by a bulk density of at least about 35 lb/ft³ on a dry basis, or at least about 45 lb/ft³ on a dry basis. In various embodiments, the bulk density of the biocoke composition is about, or at least about, 25, 30, 35, 40, 45, or 50 lb/ft³ on a dry basis, including all intervening ranges.

In some processes, the biocoke composition is characterized as hydrophobic biocoke or partially hydrophobic biocoke.

In some processes, the biocoke composition in pellet form is characterized by a crush strength of at least 1 psi pursuant to ASTM D4179. In various embodiments, the crush strength is about, or at least about, 1, 2, 3, 4, 5, 6, 7, 8, 9, 10, 11, 12, 13, 14, 15, 16, 17, 18, 19, 20 psi or more pursuant to ASTM D4179.

In some processes, the biocoke composition is characterized as non-self-heating when subjected to a self-heating test according to Manual of Tests and Criteria, Seventh revised edition 2019, United Nations, Page 375, 33.4.6 Test N.4: “Test method for self-heating substances.”

In some processes, the biocoke composition is characterized by a lack of odor generation at 25° C. for 24 hours. In some embodiments, the biocoke composition is characterized by a lack of odor generation at 50° C. for 24 hours. In some embodiments, the biocoke composition is characterized by a lack of odor generation at 25° C. for 48 hours. “Odor generation” in this context refers to organic molecules being vaporized from the biocarbon composition, wherein such organic molecules are ordinarily detectible by humans. Examples include formaldehyde, acetic acid, ethanol, methanol, and mercaptan.

In any of the processes disclosed herein, a carbonization agent can be added at a point (or at points) of the process. The carbonization agent can remain in the final composition produced. A “carbonization agent” is a material that enhances the rate, selectivity, or yield of biocoke formation from a carbon-containing precursor. The carbonization agent can be a reactant, a catalyst, a promoter, a functional filler, or another material that enhances the rate, selectivity, or yield of biocoke formation.

A wide variety of carbonization agents can be utilized. Classes of carbonization agents include (but are not limited to) metals, metal alloys, metal oxides, metal hydroxides, metal hydrides, metal sulfides, metal nitrides, metal halides, minerals, natural polymers, synthetic polymers, acids, bases, salts (metal salts or non-metal salts), organic halides (e.g., organic chlorides or fluorides), inorganic halides (e.g., inorganic chlorides or fluorides), and derivatives or combinations thereof.

A carbonization agent can comprise or consist essentially of iron, steel, nickel, cobalt, copper, zinc, aluminum, manganese, magnesium, iron ore concentrate, alloys thereof, salts thereof, oxides thereof, hydroxides thereof, hydrides thereof, nitrides thereof, or a derivative, or a combination of the foregoing, for example.

Alternatively or additionally, a carbonization agent can comprise or consist essentially of silica, alumina, silica-alumina, sand, aluminosilicates, zeolites (e.g., ZSM-5 zeolite), gilsonite, bentonite clay, borax (sodium borate), limestone, lime, silica fume, gypsum, fly ash, or a derivative, or a combination thereof, for example.

Alternatively or additionally, a carbonization agent can comprise or consist essentially of starch, crosslinked starch, starch polymer, cellulose, cellulose ether, hemicellulose, methylcellulose, chitosan, lignin, lactose, sucrose, dextrose, maltodextrin, banana flour, wheat flour, wheat starch, soy flour, corn flour, wood flour, wax, vegetable wax, guar gum, xanthan gum, polyvidone, polyacrylamide, polylactide, formaldehyde, phenol-formaldehyde resin, vegetable resin, or a derivative, or a combination thereof, for example.

Alternatively or additionally, a carbonization agent can comprise or consist essentially of sodium bicarbonate, sodium hydroxide, potassium hydroxide, ammonium chloride, ammonium hydroxide, magnesium oxide, hydrogen bromide, hydrogen chloride, sodium silicate, potassium permanganate, diammonium phosphate, potassium phosphate, sodium phosphate, calcium phosphate, magnesium phosphate, magnesium, manganese, aluminum, nickel, chromium, silicon, boron, cerium, molybdenum, phosphorus, tungsten, vanadium, iron halide, iron chloride, iron bromide, dolomite, dolomitic lime, fluorite, fluorospar, bentonite, calcium oxide, lime, kaolin, olivine, augite, hornblende, biotite, anorthite, albite, orthoclase, muscovite, quartz, and calcite, or a derivative, or a combination thereof, for example.

In some embodiments, a carbonization agent comprises or consists essentially of a metal halide. Metal halides are compounds between metals and halogens (fluorine, chlorine, bromine, iodine, and astatine). The halogens can form many compounds with metals. Metal halides are generally obtained by direct combination, or more commonly, neutralization of basic metal salt with a hydrohalic acid. In some embodiments, a carbonization agent comprises or consists essentially of iron chloride (FeCl₂ or FeCl₃), iron bromide (FeBr₂ or FeBr₃), or a hydrate thereof, or a combination thereof.

Alternatively or additionally, a carbonization agent can be a carbon-rich material, such as (but not limited to) a/an coal tar, coal fines, met coke, asphalt, coal-tar pitch, petroleum pitch, bitumen, pyrolysis tar, activated carbon, carbon black (e.g., recovered from recycled tires), graphite, graphene, graphene oxide, holey graphene, graphene platelet, carbon nanotube, fullerene, carbon fiber, pitch coke, petroleum coke, amorphous carbon, glassy carbon, pyrolyzed carbon-containing molecule, pyrolyzed parylene (e.g., parylene-N, parylene-C, or parylene-AF-4), polyaromatic hydrocarbon (e.g., pentacene, rubrene, hexabenzocoronene, or coronene), peat, sphagnum peat, or a derivative, or a combination thereof.

The carbonization agent can be introduced to the process in the form of solid particulates or as a solution, suspension, or slurry. The carbonization agent can be combined with a solvent or liquid carrier, such as water or a hydrocarbon, to add to the process. In certain embodiments, it is can be desirable that the solvent or liquid carrier contains significant carbon, further contributing to carbon formation in the kinetic interface reactor. For example, pyrolysis liquid can be used to dissolve or suspend a carbonization agent.

The carbonization agent can be introduced directly to the kinetic interface reactor. Alternatively or additionally, the carbonization agent can be introduced to a pyrolysis reactor. Alternatively or additionally, the carbonization agent can be applied to the initial biomass prior to pyrolysis. Alternatively or additionally, the carbonization agent can be introduced to a pelletizing unit (the carbonization agent can function also as a binder, in certain embodiments). Alternatively or additionally, the carbonization agent can be introduced to the biocoke recovery unit; the recovered kinetic interface media can be recycled to the kinetic interface reactor such that the recycled carbonization agent is present in the reactor. Alternatively or additionally, the carbonization agent can be added to a heated biogas stream. For example, a liquid form of the carbonization agent can be sprayed into the heated biogas stream, or a solid form of the carbonization agent can be entrained as powder into the heated biogas stream. Alternatively or additionally, the carbonization agent can be added to a bioliquid stream. A carbonization agent can be added at any other point in the process.

A biocoke product can be a material obtained from a biocoke recovery unit, or from elsewhere within a process. A biocoke product necessarily contains biocoke, but the concentration of biocoke can vary widely. In some embodiments, a biocoke-containing kinetic interface media is recovered as a product and stored, marketed, or sold.

An additive (e.g., a carbonization agent) can reduce the reactivity of a biocoke product compared to an otherwise-equivalent biocoke product without the additive. The reactivity can be thermal reactivity. For example, the biocoke product with an additive can have a lower self-heating compared to the otherwise-equivalent biocarbon composition without the additive. Alternatively or additionally, the reactivity is chemical reactivity with oxygen, water, hydrogen, carbon monoxide, or metals (e.g., iron).

When the additive is present, the additive (or at least one additive, where more than one additive is present) can be pore-filling within the biocoke product. Alternatively or additionally, an additive can be disposed on an outer surface of the biocoke product.

In some embodiments, the biocoke product is in the form of powder. In other embodiments, the biocoke product is in the form of pellets. When the form is pellets, an additive can include a binder for the pellets. Alternatively or additionally, pellets can utilize the low-fixed-carbon material itself as a binder within the pellets.

In some embodiments, the biocoke product is characterized as non-self-heating when subjected to a self-heating test according to Manual of Tests and Criteria, Seventh revised edition 2019, United Nations, Page 375, 33.4.6 Test N.4: “Test method for self-heating substances,” which is incorporated by reference herein.

The fixed-carbon concentration can be an important parameter of the biocoke-containing product. The present disclosure allows fixed-carbon concentration to be maximized—or optimized, but not necessarily maximized—in various embodiments.

In some embodiments, the fixed-carbon concentration of the biocoke-containing product, and optionally the additive type or concentration, are selected to optimize energy content associated with the biocoke product.

In some embodiments, the fixed-carbon concentration of the biocoke-containing product, and optionally the additive type or concentration, are selected to optimize bulk density associated with the biocoke product.

In some embodiments, the fixed-carbon concentration of the biocoke-containing product, and optionally the additive type or concentration, are selected to optimize hydrophobicity associated with the biocoke product.

In some embodiments, the fixed-carbon concentration of the biocoke-containing product, and optionally the additive type or concentration, are selected to optimize pore sizes associated with the biocoke product.

In some embodiments, the fixed-carbon concentration of the biocoke-containing product, and optionally the additive type or concentration, are selected to optimize ratios of pore sizes associated with the biocoke product.

In some embodiments, the fixed-carbon concentration of the biocoke-containing product, and optionally the additive type or concentration, are selected to optimize surface area associated with the biocoke product.

In some embodiments, the fixed-carbon concentration of the biocoke-containing product, and optionally the additive type or concentration, are selected to optimize reactivity associated with the biocoke product.

In some embodiments, the fixed-carbon concentration of the biocoke-containing product, and optionally the additive type or concentration, are selected to optimize ion-exchange capacity associated with the biocoke product.

In some embodiments, the biocoke-containing product is in the form of pellets, and the fixed-carbon concentration, and optionally the additive type or concentration, are selected to optimize Hardgrove Grindability Index associated with the pellets.

In some embodiments, the biocoke-containing product is in the form of pellets, and the fixed-carbon concentration, and optionally the additive type or concentration, are selected to optimize Pellet Durability Index associated with the pellets.

In some embodiments, varying the fixed-carbon content enables optimization of the Hardgrove Grindability Index (“HGI”). The incorporation of binders or other additives also can enable HGI adjustability for a biocoke product.

The ability to adjust the HGI of biocoke pellets is beneficial because downstream applications (e.g., replacement of coal in boilers) that utilize pellets have varying HGI requirements. HGI adjustability address well-known problems industrially: the difficulty to grind raw biomass, and the difficulty to grind pellets. Furthermore, because there are so many downstream uses of biocarbon pellets, each having its own requirements, it is highly advantageous to be able to adjust the grindability of the pellets. It is desirable to be able to adjust HGI to suit a particular application, such as combustion in boilers, metal-making, or gasification to make syngas.

For many applications, pellets are preferred over powders (isolated biomass particles) due to advantages in shipping, storage, safety. Ultimately, the pellets can be converted back to powders, or at least smaller objects, at some point, where desired. Grindability of the pellets is thus often an important parameter that impacts operating costs and capital costs.

In some embodiments, pellets need to be ground or pulverized to a powder, such as when the boiler or gasifier utilizes a fluidized bed or a suspension of carbon particles. Another example is pulverized carbon injection into a blast furnace, for reducing metal ores to metals. In these embodiments, high grindability of the pellets is desired, but not too high such that the pellets fall apart during shipping and handling. In other embodiments, it is desired to feed pellets themselves to a process, such as a metal-making process. In these embodiments, lower grindability can be desirable since some pellet strength can be necessary to support a material bed in the reactor. Different technologies have different pellet grindability requirements.

The Hardgrove Grindability Index of the biocoke-containing pellets can be at least about 30, at least about 40, at least about 50, at least about 60, at least about 70, at least about 80, at least about 90, or at least about 100. In some embodiments, the Hardgrove Grindability Index is from about 30 to about 50 or from about 50 to about 70. ASTM-Standard D 409/D 409M for “Standard Test Method for Grindability of Coal by the Hardgrove-Machine Method” is incorporated by reference herein in its entirety. Unless otherwise indicated, all references in this disclosure to Hardgrove Grindability Index or HGI are in reference to ASTM-Standard D 409/D 409M.

In various embodiments, the Hardgrove Grindability Index is about, at least about, or at most about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, including all intervening ranges (e.g., 25-40, 30-60, etc.).

The biocoke-containing pellet can be characterized by a Pellet Durability Index of at least about 80%, at least about 85%, at least about 90%, at least about 95%, or at least about 99%. The biocarbon pellet can be characterized by a Pellet Durability Index of at most about 99%, of at most about 95%, of at most about 90%, of at most about 85%, or of at most about 80%. Unless otherwise indicated, all references in this disclosure to Pellet Durability Index are in reference to ISO 17831-1:2015 “Solid biofuels—Determination of mechanical durability of pellets and briquettes—Part 1: Pellets”, which is hereby incorporated by reference herein in its entirety.

In some embodiments, the biocoke-containing pellets are utilized as a starting material to make smaller objects, which can also be referred to as biocarbon pellets since “pellet” does not limit the geometry. For example, initial pellets that are 10 mm in average pellet diameter can be fabricated. Then, these initial pellets can be crushed using various mechanical means (e.g., using a hammer mill). The crushed pellets can be separated according to size, such as by screening. In this manner, smaller pellets can be produced, with an average pellet diameter of about, at least about, or at most about 50, 100, 150, 200, 300, 400, 500, 600, 700, 800, 900, 1000, 1500, 2000, 3000, 4000, or 5000 microns, for example. The average pellet diameter of the smaller pellets is preferably larger than the average particle diameter of the initial carbon-containing particles that were used to make the pellets with the binder.

When the biocarbon pellets are crushed to generate smaller pellets, a step of crushing (and optionally screening) can be integrated with another process step, including potentially at a site of industrial use. The optional step to generate smaller pellets can utilize a crushing apparatus, such as a hammer mill, an attrition mill, a disc mill, a pin mill, a ball mill, a cone crusher, a jaw crusher, a rock crusher, or a combination thereof.

In various embodiments, the Hardgrove Grindability Index is at least about 40, at least about 50, at least about 60, at least about 70, at least about 80, at least about 90, or at least about 100. For example, the Hardgrove Grindability Index can be at least about 30 to at most about 50 or at least about 50 to at most about 70.

In various processes, the process conditions are selected and optimized to generate a final biocoke-containing pellet with a Hardgrove Grindability Index of about, at least about, or at most about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, including all intervening ranges (e.g., 30-60, 33-47, etc.).

In some processes, the biocoke-containing pellet is characterized by a Pellet Durability Index of at least about 80%, at least about 90%, or at least about 95%.

In some embodiments, the process comprises pre-selecting a Hardgrove Grindability Index for biocoke-containing pellets, adjusting process conditions based on the pre-selected Hardgrove Grindability Index, and achieving within ±20% of the pre-selected Hardgrove Grindability Index for the biocarbon pellets, wherein the adjusting process conditions comprises adjusting one or more of pyrolysis temperature, pyrolysis time, mechanical-treatment conditions, pelletizing conditions, binder type, binder concentration, binding conditions, or drying. The process of certain embodiments can achieve within ±10%, or within ±5%, of the pre-selected Hardgrove Grindability Index for the pellets.

The size and geometry of the biocoke-containing pellet (or other object) can vary. The biocoke-containing pellets can be characterized by an average pellet diameter, which is the true diameter in the case of a sphere or cylinder, or an equivalent diameter in the case of any other 3D geometry. The equivalent diameter of a non-spherical pellet is the diameter of a sphere of equivalent volume to the actual pellet. In some embodiments, the average pellet diameter is about, or at least about, 1, 2, 3, 4, 5, 6, 7, 8, 9, 10, 11, 12, 13, 14, 15, 20, or 25 millimeters, including all intervening ranges. In some embodiments, the average pellet diameter is about, or at least about, 500, 1000, 1500, 2000, 2500, 3000, 3500, 4000, 4500, 5000, 5500, 6000, or 6500 microns, including all intervening ranges.

In some embodiments, there is a plurality of pellets (which can also be referred to merely as “pellets”) that is relatively uniform in size, such as a standard deviation of at most about ±100%, of at most about ±50%, of at most about ±25%, of at most about ±10%, or of at most about ±5% of the average pellet diameter. In other embodiments, there is a wide range of sizes of pellets, which can be advantageous in some applications.

Biocoke-containing pellets can contain moisture. The moisture present in a pellet can be water that is chemically bound to carbon or a binder, water that is physically bound (absorbed or adsorbed) to carbon or a binder, free water present in an aqueous phase that is not chemically or physically bound to carbon or a binder, or a combination thereof. Where moisture is desired during the binding process, it can be preferred that such moisture is chemically or physically bound to carbon or a binder, rather than being free water.

Various moisture levels can be present. For example, the pellet can comprise at least about 1 wt % to at most about 30 wt % (e.g., 32 wt %) moisture, such as at least about 5 wt % to at most about 15 wt % moisture, at least about 2 wt % to at most about 10 wt % moisture, or at least about 0.1 wt % to at most about 1 wt % moisture. In some embodiments, the pellet comprises at least about 4 to at most about 8 wt % moisture. In various embodiments, the pellet comprises about, at least about, or at most about 0.5, 1, 1.5, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 wt % moisture, including all intervening ranges. Moisture levels of the pellets can be optimized to vary the densification within the pellets.

For some market applications, such as in agriculture, higher moisture levels are desirable for dust control or other reasons. For other market applications, such as metallurgy, lower moisture levels can be desirable (e.g., 1 wt % moisture or even less). Note that although water can be present during the process of making pellets, those pellets are then optionally dried, which means the final pellets do not necessarily contain moisture.

In some biocoke-containing pellets, the pellets comprise at least about 2 wt % to at most about 25 wt % of binder, at least about 5 wt % to at most about 20 wt % of binder, or at least about 1 wt % to at most about 5 wt % of binder. In various embodiments, the pellet comprises about, at least about, or at most about 0.5, 1, 1.5, 2, 3, 4, 5, 6, 7, 8, 9, 10, 11, 12, 13, 14, 15, 20, 25, or 30 wt % binder, including all intervening ranges. In some embodiments, there is an inverse relationship between moisture content and binder concentration.

The binder can be pore-filling within the carbon. Alternatively or additionally, the binder can be disposed on the surfaces of the carbon, such as pore walls.

The binder can be an organic binder or an inorganic binder. In some embodiments, the binder comprises or consists essentially of a renewable material. In some embodiments, the binder comprises or consists essentially of a biodegradable material. In some embodiments, the binder is capable of being partially oxidized or combusted.

In various embodiments, the binder comprises starch, crosslinked starch, starch polymer, cellulose, cellulose ether, hemicellulose, methylcellulose, chitosan, lignin, lactose, sucrose, dextrose, maltodextrin, banana flour, wheat flour, wheat starch, soy flour, corn flour, wood flour, coal tar, coal fines, peat, sphagnum peat, met coke, asphalt, coal-tar pitch, petroleum pitch, bitumen, pyrolysis tars, gilsonite, bentonite clay, borax, limestone, lime, wax, vegetable wax, baking soda, baking powder, sodium hydroxide, potassium hydroxide, iron ore concentrate, silica fume, gypsum, Portland cement, guar gum, xanthan gum, polyvidone, polyacrylamide, polylactide, formaldehyde, phenol-formaldehyde resin, vegetable resin, recycled shingles, recycled tires, a derivative thereof, or a combination of the foregoing. The binder can comprise or consist essentially of a grindable plasticizer.

In certain embodiments, the binder comprises starch, thermoplastic starch, crosslinked starch, starch-based polymer (e.g., polymers based on amylose and amylopectin), a derivative thereof, or a combination of the foregoing. Starch can be non-ionic starch, anionic starch, cationic starch, or zwitterionic starch.

Starch is one of the most abundant biopolymers. It is completely biodegradable, inexpensive, renewable, and can be easily chemically modified. The cyclic structure of the starch molecules together with strong hydrogen bonding gives starch a rigid structure and leads to highly ordered crystalline and granular regions. Starch in its granular state is generally unsuitable for thermoplastic processing. To obtain thermoplastic starch, the semi-crystalline starch granules can be broken down by thermal and mechanical forces. Since the melting point of pure starch is considerably higher than its decomposition temperature, plasticizers such as water or glycols can be added. The natural crystallinity can then be disrupted by vigorous mixing (shearing) at elevated temperatures, which yields thermoplastic starch. Starch can be plasticized (destructurized) by relatively low levels of molecules that are capable of hydrogen bonding with the starch hydroxyl groups, such as water, glycerol, or sorbitol.

Thermoplastic starch can be chemically modified or blended with other biopolymers to produce a tougher and more ductile and resilient bioplastic. For example, starch can be blended with a natural or a synthetic (biodegradable) polyester such as polylactic acid, polycaprolactone, or polyhydroxybutyrate. To improve the compatibility of the starch/polyester blend, a suitable compatibilizer such as poly(ethylene-co-vinyl alcohol) or polyvinyl alcohol can be added. The hydrophilic hydroxyl groups (—OH) of starch can be replaced with hydrophobic (reactive) groups, such as by esterification or etherification.

In some embodiments, a starch-containing binder comprises or consists essentially of a crosslinked starch. Various methods for crosslinking starch are known in the art. A starch material can be crosslinked under acidic or alkaline conditions after dissolving or dispersing it in an aqueous medium, for example. An aldehyde (e.g., glutaraldehyde or formaldehyde) can be used to crosslink starch.

One example of a crosslinked starch is a reaction product of starch and glycerol or another polyol, such as (but not limited to) ethylene glycol, propylene glycol, glycerol, butanediols, butanetriols, erythritol, xylitol, sorbitol, or a combination thereof. The reaction product can be formed from a crosslinking reaction that is catalyzed by an acid, such as (but not limited to) formic acid, acetic acid, lactic acid, citric acid, oxalic acid, uronic acids, glucuronic acids, or combinations thereof. An inorganic acid, such as sulfuric acid, can also be utilized to catalyze the crosslinking reaction. In some embodiments, the thermoplasticizing or crosslinking reaction product can be formed from a crosslinking reaction that is catalyzed instead by a base, such as (but not limited to) ammonia or sodium borate.

In some embodiments, a binder is designed to be a water-resistant binder. For example, in the case of starch, hydrophilic groups can be replaced by hydrophobic groups that better resist water.

In some embodiments, the binder serves other purposes, such as (but not limited to) water retention in the biocarbon pellet, a food source for microorganisms, etc.

In some embodiments, the binder reduces the reactivity of the biocarbon pellet compared to an otherwise-equivalent biocarbon pellet without the binder. Reactivity can refer to thermal reactivity or chemical reactivity.

In the case of thermal reactivity, the biocarbon pellet can have lower self-heating compared to the otherwise-equivalent biocarbon pellet without the binder. “Self-heating” refers to biocarbon pellet undergoing spontaneous exothermic reactions, in absence of any external ignition, at relatively low temperatures and in an oxidative atmosphere, to cause the internal temperature of a biocarbon pellet to rise.

Chemical reactivity can be reactivity with oxygen, water, hydrogen, carbon monoxide, metals (e.g., iron), or a combination thereof. Chemical reactivity can be associated with reactions with or to CO, CO₂, H₂O, pyrolysis oils, or heat, for example.

Optionally, pellets comprise an additive (that is not necessarily a binder), such as a/an inorganic bentonite clay, limestone, starch, cellulose, lignin, or acrylamide. When lignin is used as a binder or other additive, the lignin can be obtained from the same biomass feedstock as used in the pyrolysis process. For example, a starting biomass feedstock can be subjected to a lignin-extraction step, removing a quantity of lignin for use as a binder or additive.

Other possible additives including fluxing agents, such as inorganic chlorides, inorganic fluorides, or lime. In some embodiments, additives are selected from acids, bases, or salts thereof. In some embodiments, an additive comprises or consists essentially of a metal, a metal oxide, a metal hydroxide, a metal halide, or a derivative, or a combination thereof. For example, an additive can comprise sodium hydroxide, potassium hydroxide, magnesium oxide, hydrogen bromide, hydrogen chloride, sodium silicate, potassium permanganate, magnesium, manganese, aluminum, nickel, chromium, silicon, boron, cerium, molybdenum, phosphorus, tungsten, vanadium, iron halide, iron chloride, iron bromide, dolomite, dolomitic lime, fluorite, fluorospar, bentonite, calcium oxide, lime, or a derivative or a combination thereof. Additives can be added before, during, or after any one or more steps of the process, including into the feedstock itself at any time, before or after it is harvested.

Biocoke-containing pellets disclosed herein have a wide variety of downstream uses. The pellets can be stored, sold, shipped, and converted to other products. The pellets can be pulverized for use in a boiler, to combust the carbon and generate electrical energy or heat. The pellets can be pulverized, crushed, or milled for feeding into a furnace, such as a blast furnace in metal making. The pellets can be fed directly into a furnace, such as a Tecnored furnace in metal making. The pellets can be pulverized, crushed, or milled for feeding into a gasifier for purposes of making syngas from the biocarbon pellets.

In many embodiments, the biocoke-containing pellets are fed to a furnace, either directly or following a step to pulverize, crush, mill, or otherwise reduce particle size. A furnace can be a blast furnace, a top-gas recycling blast furnace, a shaft furnace, a reverberatory furnace (also known as an air furnace), a crucible furnace, a muffling furnace, a retort furnace, a flash furnace, a Tecnored furnace, an Ausmelt furnace, an ISASMELT furnace, a puddling furnace, a Bogie hearth furnace, a continuous chain furnace, a pusher furnace, a rotary hearth furnace, a walking beam furnace, an electric arc furnace, an induction furnace, a basic oxygen furnace, a puddling furnace, a Bessemer furnace, a direct-reduced-metal furnace, or a combination or derivative thereof.

Note that regardless of the Hardgrove Grindability Index of the biocoke-containing pellets, they are not necessarily later subjected to a grinding process. For example, the pellets can be used directly in an agricultural application. As another example, the pellets can be directly incorporated into an engineered structure, such as a landscaping wall. At the end-of-life of a structure containing pellets, the pellets can then be ground, combusted, gasified, or otherwise reused or recycled.

In some embodiments, it is preferable that the total carbon within the biocoke-containing product is at least 50% renewable as determined from a measurement of the ¹⁴C/¹²C isotopic ratio of the total carbon. In some embodiments, the total carbon is at least 90% renewable as determined from a measurement of the ¹⁴C/¹²C isotopic ratio of the total carbon. In certain embodiments, the total carbon is fully renewable as determined from a measurement of the ¹⁴C/¹²C isotopic ratio of the total carbon.

The surface area of the biocoke can vary widely. Exemplary surface areas (e.g., BET surface areas) for the biocoke can range from about 400 m²/g to about 2000 m²/g or higher, such as about 500 m²/g, 600 m²/g, 800 m²/g, 1000 m²/g, 1200 m²/g, 1400 m²/g, 1600 m²/g, or 1800 m²/g, including any intervening range. The biocoke surface area can be important for a range of commercial applications that rely on the kinetic availability of carbon, or that are carbon mass-transfer limited, for example. Sometimes, a low biocoke surface area is desired, such as for better gas permeability through a biocoke bed. Other times, a high biocoke surface area is desired, such as when the biocoke is a chemical reducing agent in metallurgy.

In the disclosed technology, the use of biomass to generate biocoke leads to a low carbon intensity of the biocoke product and process. The “carbon intensity” of a product (or a process) is the net quantity by weight of carbon dioxide generated per ton of product, or sometimes per ton of feedstock processed to make the product. A “CO₂-equivalent carbon intensity” can also be defined, as the net quantity of carbon dioxide equivalent generated per ton of product. The “carbon dioxide equivalent” or “CO₂e” signifies the amount of CO₂ which would have the equivalent global-warming impact. The typical units of carbon intensity are kilograms carbon dioxide equivalent per metric ton (1000 kg) of product.

A greenhouse gas (or “GHG”) is any gas in the atmosphere which absorbs and re-emits heat, and thereby keeps the planet's atmosphere warmer than it otherwise would be. The main GHGs in the Earth's atmosphere are water vapor, carbon dioxide, methane, nitrous oxide, and ozone. By convention, the global-warming potential of CO₂ is defined to be 1. The global-warming potential of CH₄ is about 30, i.e., methane is 30× more potent than CO₂ as a greenhouse gas. See “IPCC Fourth Assessment Report: Climate Change 2007”, Intergovernmental Panel on Climate Change, Cambridge University Press, Cambridge (2007), which is hereby incorporated by reference herein.

In order to calculate the carbon intensity of a product and process in general, the carbon intensities of the starting materials need to be estimated, as do the carbon intensities associated with the conversion of starting materials to intermediates, and the carbon intensities associated with the conversion of intermediates to final products. One skilled in the art of chemical engineering is able to make these calculations, which can be aided by software, such as life-cycle analysis software (e.g., GREET® or SimaPro® software). Life-cycle assessment (LCA) is a known method used to evaluate the environmental impact of a product through its life cycle, encompassing processing of the raw materials, manufacturing, distribution, use, recycling, and final disposal. When multiple products are produced, allocation rules are used to calculate LCA impacts attributed to each product.

In some embodiments of this technology, the biocoke product is characterized by a carbon intensity less about 500 kg CO₂e per metric ton of the biocoke product, such about, or as less than about 400, 300, 200, 100, 50, 25, or 0 kg CO₂e per metric ton of the biocoke product. In various embodiments of this technology, the biocoke product is characterized by a negative carbon intensity less than 0 kg CO₂e per metric ton of the biocoke product, such as a carbon intensity less than about −100, −200, −300, −400, or −500 kg CO₂e per metric ton of the biocoke product.

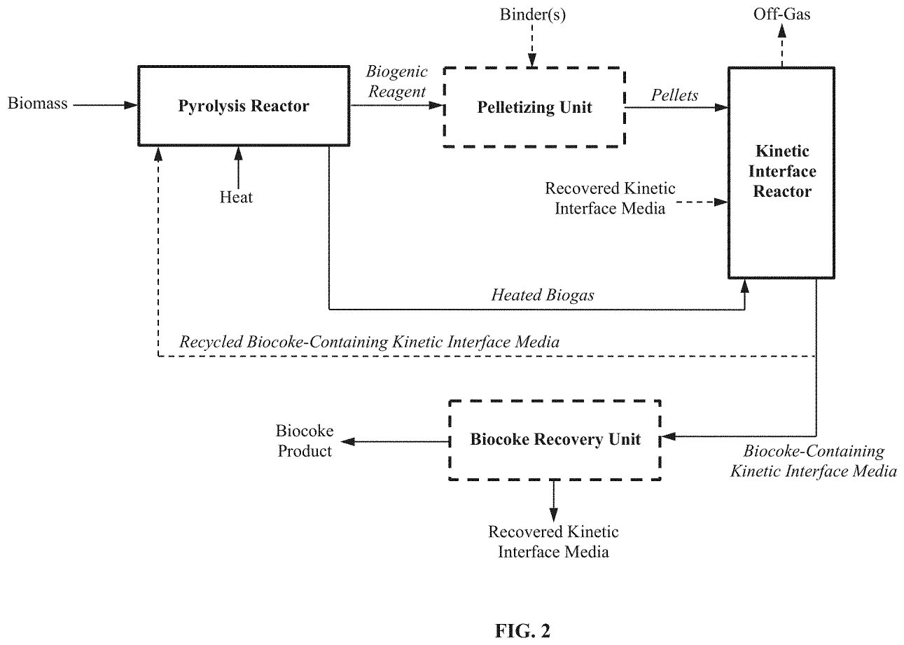

While renewable biocarbon compositions can be desired, the principles of the invention can be applied to non-renewable materials. In certain embodiments, a biomass-containing feedstock includes biomass (such as a biomass source recited herein) as well as a non-renewable feedstock, such as coal. Thus, a biomass—coal mixture can be utilized as biomass-containing feedstock—which can replace “biomass” in any of FIG. 2, 4, or 6, for example. Other non-biomass feedstocks that can be used in feedstock mixtures include pyrolyzed coal, coke, petroleum coke, metallurgical coke, activated carbon, carbon black, graphite, graphene, pyrolyzed polymers, or a derivative, or a combination thereof, for example.

Disclosed herein are systems configured to perform the processes disclosed herein.

Some embodiments of the invention will be described with reference to the accompanying drawings, FIGS. 1 to 7, which illustrate various processes and systems. In the block-flow diagrams, dotted boxes and lines denote optional units and streams, respectively.

FIG. 1 is an exemplary process schematic depicting the coking of biogas onto carbon pellets as kinetic interface media, to produce high-yield carbon pellets. Hot combustion gas or steam can be directly injected into the biogas. Alternatively or additionally, the heat content of hot combustion gas or steam can be indirectly transferred to the biogas stream, to thereby raise its temperature.

FIG. 2 is an exemplary process block-flow diagram depicting the use of a kinetic interface reactor to form biocoke from heated biogas derived from biomass pyrolysis. A biomass feedstock is pyrolyzed to form a biogenic reagent and a biogas stream. The biogenic reagent is optionally pelletized and introduced into the kinetic interface reactor, along with the heated biogas. The biogas is heated from the heat injected into the pyrolysis reactor, and optionally further heated such as via direct or indirect steam heating. A biocoke-containing kinetic interface media is recovered from the reactor and optionally is sent to a biocoke recovery unit, to produce a biocoke product.

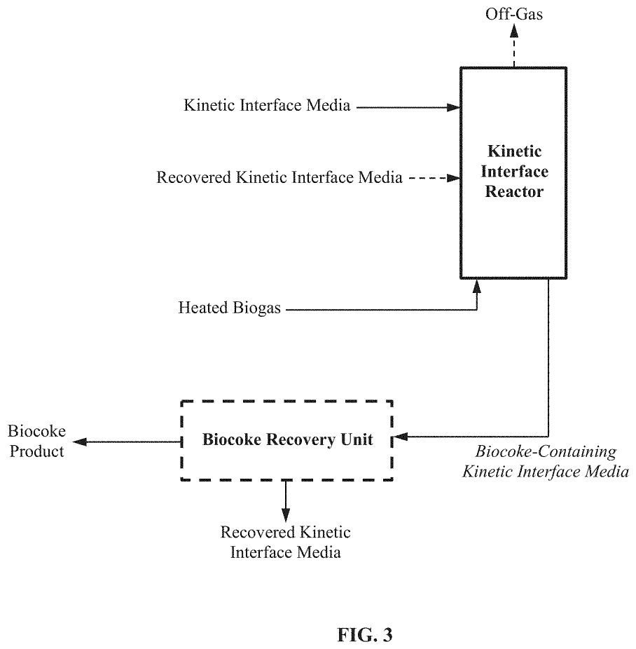

FIG. 3 is an exemplary process block-flow diagram depicting the use of a kinetic interface reactor to form biocoke from heated biogas. A kinetic interface media is introduced into a kinetic interface reactor, along with heated biogas. A biocoke-containing kinetic interface media is recovered from the reactor and optionally is sent to a biocoke recovery unit, to thereby produce a biocoke product.

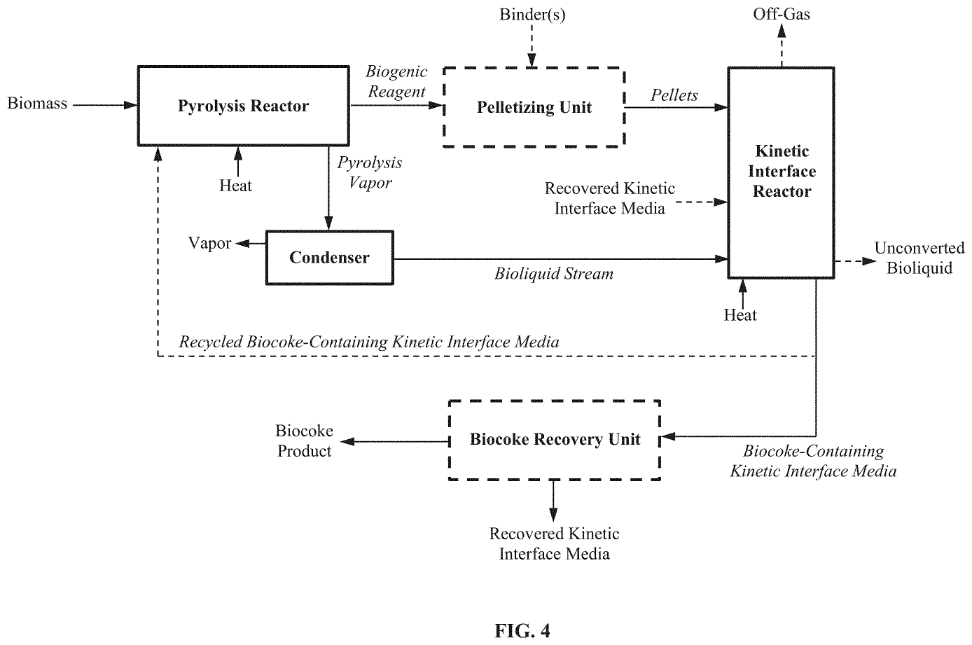

FIG. 4 is an exemplary process block-flow diagram depicting the use of a kinetic interface reactor to form biocoke from a bioliquid derived from biomass pyrolysis. A biomass feedstock is pyrolyzed to form a biogenic reagent and a pyrolysis vapor. The biogenic reagent is optionally pelletized and introduced into the kinetic interface reactor, along with a bioliquid stream from a condenser for the pyrolysis vapor. A biocoke-containing kinetic interface media is recovered from the reactor and optionally is sent to a biocoke recovery unit, to thereby produce a biocoke product.

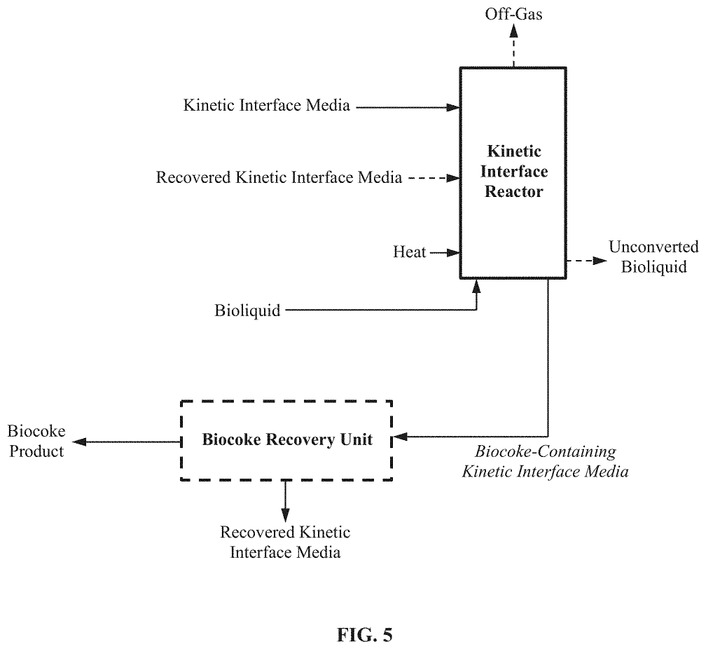

FIG. 5 is an exemplary process block-flow diagram depicting the use of a kinetic interface reactor to form biocoke from a bioliquid. A biocoke-containing kinetic interface media is recovered from the reactor and optionally is sent to a biocoke recovery unit, to thereby produce a biocoke product.

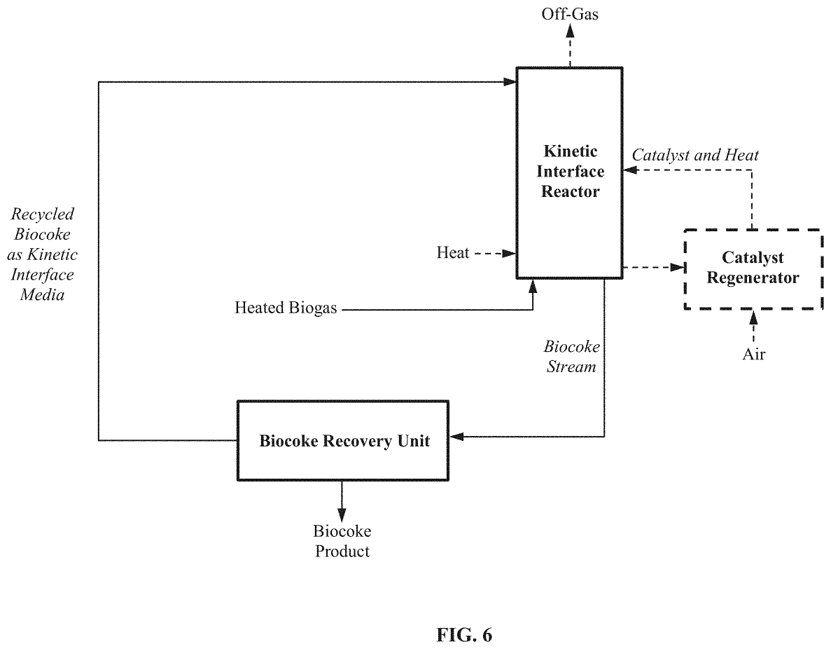

FIG. 6 is an exemplary process block-flow diagram depicting the use of a kinetic interface reactor to continuously form biocoke from heated biogas, with internal recirculation of biocoke as kinetic interface media. Optionally, the kinetic interface reactor can employ a coking catalyst (e.g., a metal, a metal alloy, a metal oxide, a metal hydride, a metal carbide, an aluminosilicate) that is different than the kinetic interface media. The coking catalyst can be regenerated if desired. A biocoke product can be obtained from a biocoke recovery unit. The catalyst can be a carbonization agent as described above, or another catalyst. In some embodiments where the catalyst regeneration is performed using air oxidation as shown in FIG. 6, the catalyst preferably is not a carbon-rich catalyst (e.g., graphite) as the catalyst itself would likely be oxidized. Also, in FIG. 6, there can also be a carbonization agent, in addition to the kinetic interface media and catalyst, as distinct materials.

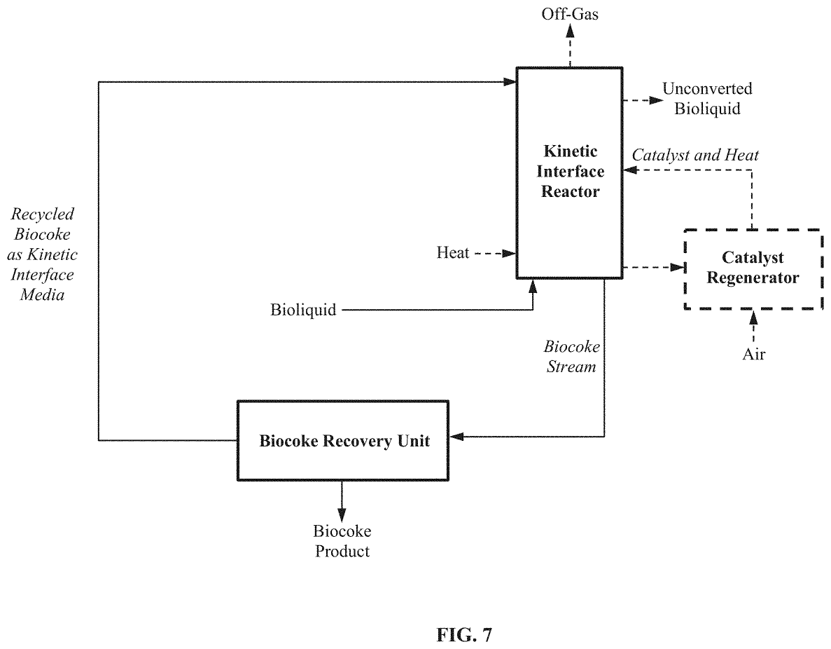

FIG. 7 is an exemplary process block-flow diagram depicting the use of a kinetic interface reactor to form biocoke from bioliquid, with internal recirculation of biocoke as kinetic interface media. Optionally, the kinetic interface reactor can employ a coking catalyst that is different than the kinetic interface media. A coking catalyst can be a metal, a metal alloy, a metal oxide, a metal hydride, a metal carbide, or an aluminosilicate, for example. The coking catalyst can be regenerated, if desired. A biocoke product can be obtained from a biocoke recovery unit. The catalyst can be a carbonization agent as described herein, or another catalyst. In some embodiments where the catalyst regeneration is performed using air oxidation as shown in FIG. 7, the catalyst preferably is not a carbon-rich catalyst as the catalyst itself would likely be oxidized. (Note that a carbon-rich catalyst refers to a material with carbon in readily oxidizable form. Thus a mixture of 1 wt % silica and 99 wt % graphite would be a carbon-rich catalyst, while silicon carbide would not be considered a carbon-rich catalyst.) Also, in FIG. 7, there can also be a carbonization agent, in addition to the kinetic interface media and catalyst, as distinct materials.

In some processes, at least two distinct pyrolysis reactors are employed. In such embodiments, the pyrolysis reactors are typically all conducted continuously or all conducted in batch, but in principle, a mixture of reaction modes can be used. Also, when distinct pyrolysis reactors are employed, they can be at a common site or they can be at different sites.

In some embodiments, a process is conducted in a common pyrolysis reactor at different times, such as in distinct production campaigns. When a single pyrolysis reactor is used, it can be operated in batch mode with distinct batches of low-fixed-carbon material and high-fixed-carbon material, for example, or using different pyrolysis conditions. Alternatively, a single pyrolysis reactor can be operated continuously or semi-continuously, such that a first material is produced for a first period of time and then a second material is produced for a second period of time, after which the reactor can be switched back to producing the first material or something else.

In some process embodiments, a first pyrolysis reactor is operated at a first pyrolysis temperature of at least about 250° C. to at most about 1250° C., such as from at least about 300° C. to at most about 700° C. A second pyrolysis reactor can be operated at a second pyrolysis temperature of at least about 250° C. to at most about 1250° C., such as at least about 300° C. to at most about 700° C. The second pyrolysis temperature can be the same as, or different from, the first pyrolysis temperature.

In some embodiments, a first pyrolysis reactor is operated for a first pyrolysis time of at least about 10 seconds to at most about 24 hours. In these or other embodiments, a second pyrolysis reactor can be operated for a second pyrolysis time of at least about 10 seconds to at most about 24 hours. The second pyrolysis time can be the same as, or different from, the first pyrolysis time.

Some embodiments are predicated on optimized pyrolysis of biomass along with carbon recapture—using principles taught herein—to generate a carbon substrate, mechanical size reduction of the carbon substrate, and use of a binder to agglomerate the carbon substrate to form biocarbon pellets. The carbon substrate can comprise or consist essentially of a blend of low-fixed-carbon material and high-fixed-carbon material.

### Pyrolysis Processes and Systems

Processes and systems suitable for pyrolyzing a biomass feedstock are now further described in detail. Descriptions of a pyrolysis reactor (or reaction) will be understood as references to a reactor (or reaction) specifically for producing a kinetic interface media, or a precursor thereof, in some instances.

As used herein, “pyrolysis” and “pyrolyze” refer to thermal decomposition of a carbonaceous material. In pyrolysis, less oxygen is present than is required for complete combustion of the material, such as less than about 10%, 5%, 1%, 0.5%, 0.1%, or 0.01% of the oxygen (02 molar basis) that is required for complete combustion. In some embodiments, pyrolysis is performed in the absence of oxygen.

Exemplary changes that can occur during pyrolysis include any of the following: (i) heat transfer from a heat source increases the temperature inside the feedstock; (ii) the initiation of primary pyrolysis reactions at this higher temperature releases volatiles and forms a char; (iii) the flow of hot volatiles toward cooler solids results in heat transfer between hot volatiles and cooler unpyrolyzed feedstock; (iv) condensation of some of the volatiles in the cooler parts of the feedstock, followed by secondary reactions, can produce tar; (v) autocatalytic secondary pyrolysis reactions proceed while primary pyrolytic reactions simultaneously occur in competition; and (vi) further thermal decomposition, reforming, water-gas shift reactions, free-radical recombination, or dehydrations can also occur, which are a function of the residence time, temperature, and pressure profile.

Pyrolysis can at least partially dehydrate a starting feedstock (e.g., lignocellulosic biomass). In various embodiments, pyrolysis removes greater than about 50%, 75%, 90%, 95%, 99%, or more of the water from the starting feedstock.

In some embodiments, a starting biomass feedstock is selected from softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, lignin, animal manure, municipal solid waste, municipal sewage, or a combination thereof. Note that typical biomass feedstock comprises at least carbon, hydrogen, and oxygen.

The biogenic reagent can comprise at least about 50 wt %, at least about 75 wt %, or at least about 90 wt % total carbon. In various embodiments, the biogenic reagent contains about, at least about, or at most about 20, 25, 30, 35, 40, 45, 50, 55, 60, 65, 70, 75, 80, 85, 90, 95, or 99 wt % carbon. The total carbon is fixed carbon plus non-fixed carbon that is present in volatile matter. In some embodiments, component weight percentages are on an absolute basis, which is assumed unless stated otherwise. In other embodiments, component weight percentages are on a moisture-free and ash-free basis. Compositions of low-fixed-carbon materials and high-fixed-carbon materials have been discussed in detail above.

The pyrolysis conditions can be varied widely, depending on the desired compositions for the biogenic reagent and pyrolysis off-gas, the starting feedstock, the reactor configuration, and other factors.

In some embodiments, multiple reactor zones are designed and operated in a way that optimizes carbon yield and product quality from pyrolysis, while maintaining flexibility and adjustability for feedstock variations and product requirements.

In some non-limiting embodiments, the temperatures and residence times are selected to achieve relatively slow pyrolysis chemistry. The benefit is potentially the substantial preservation of cell walls contained in the biomass structure, which means the final product can retain some, most, or all of the shape and strength of the starting biomass. In order to maximize this potential benefit, it is preferred to utilize apparatus that does not mechanically destroy the cell walls or otherwise convert the biomass particles into small fines. Certain suitable reactor configurations are discussed following the process description below.

Additionally, if the feedstock is a milled or sized feedstock, such as wood chips or pellets, it can be desirable for the feedstock to be carefully milled or sized. Careful initial treatment will tend to preserve the strength and cell-wall integrity that is present in the native feedstock source (e.g., trees). This can also be important when the final product should retain some, most, or all of the shape and strength of the starting biomass.

In some embodiments, a first zone of a pyrolysis reactor is configured for feeding biomass (or another carbon-containing feedstock) in a manner that does not “shock” the biomass, which would rupture the cell walls and initiate fast decomposition of the solid phase into vapors and gases. This first zone can be thought of as mild pyrolysis.

In some embodiments, a second zone of a pyrolysis reactor is configured as the primary reaction zone, in which preheated biomass undergoes pyrolysis chemistry to release gases and condensable vapors, leaving a significant amount of solid material which is a high-carbon reaction intermediate. Biomass components (primarily cellulose, hemicellulose, and lignin) decompose and create vapors, which escape by penetrating through pores or creating new nanopores. The latter effect contributes to the creation of porosity and surface area.

In some embodiments, a third zone of a pyrolysis reactor is configured for receiving the high-carbon reaction intermediate and cooling down the solids to some extent. Typically, the third zone will be a lower temperature than the second zone. In the third zone, the chemistry and mass transport can be surprisingly complex. Without being limited by any particular theory or proposed mechanisms, it is believed that secondary reactions can occur in the third zone. Essentially, carbon-containing components that are in the gas phase can decompose to form additional fixed carbon or become adsorbed onto the carbon. Thus, in some embodiments, the final carbonaceous material is not simply the solid, devolatilized residue of the processing steps, but rather can include additional carbon that has been deposited from the gas phase, such as by decomposition of organic vapors (e.g., tars) that can form carbon.

Certain embodiments extend the concept of additional carbon formation by including a separate unit in which cooled carbon is subjected to an environment including carbon-containing species, to enhance the carbon content of the final product. When the temperature of this unit is below pyrolysis temperatures, the additional carbon is expected to be in the form of adsorbed carbonaceous species, rather than additional fixed carbon.

There are a large number of options as to intermediate input and output (purge or probe) streams of one or more phases present in any particular zone, various mass and energy recycle schemes, various additives that can be introduced anywhere in the process, adjustability of process conditions including both reaction and separation conditions in order to tailor product distributions, and so on. Zone-specific input and output streams enable good process monitoring and control, such as through FTIR sampling and dynamic process adjustments.

Some embodiments do not employ fast pyrolysis, and some embodiments do not employ slow pyrolysis. Surprisingly high-quality carbon materials, including compositions with very high fractions of fixed carbon, can be obtained from the disclosed processes and systems.

In some embodiments, a pyrolysis process for producing a biogenic reagent comprises the following steps:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) pyrolyzing the feedstock in the presence of a substantially inert gas phase for at least 10 minutes and with at least one temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) cooling the hot pyrolyzed solids to generate cooled pyrolyzed solids; and
(g) recovering a biogenic reagent comprising at least a portion of the cooled pyrolyzed solids.

The present invention can also be used for carbon-containing feedstocks other than biomass, such as a fossil fuel (e.g., coal or petroleum coke), or any mixtures of biomass and fossil fuels (such as biomass/coal blends). In some embodiments, a biogenic feedstock is, or includes, coal, oil shale, crude oil, asphalt, or solids from crude-oil processing (such as petcoke). Feedstocks can include waste tires, recycled plastics, recycled paper, construction waste, deconstruction waste, and other waste or recycled materials. For the avoidance of doubt, any method, apparatus, or system described herein can be used with any carbonaceous feedstock. Carbon-containing feedstocks can be transportable by any known means, such as by truck, train, ship, barge, tractor trailer, or any other vehicle or means of conveyance.

Selection of a particular feedstock or feedstocks is not regarded as technically critical, but is carried out in a manner that tends to favor an economical process. Typically, regardless of the feedstocks chosen, there can be (in some embodiments) screening to remove undesirable materials. The feedstock can optionally be dried prior to processing.

The feedstock employed can be provided or processed into a wide variety of particle sizes or shapes. For example, the feed material can be a fine powder, or a mixture of fine and coarse particles. The feed material can be in the form of large pieces of material, such as wood chips or other forms of wood (e.g., round, cylindrical, square, etc.). In some embodiments, the feed material comprises pellets or other agglomerated forms of particles that have been pressed together or otherwise bound, such as with a binder.

It is noted that size reduction is a costly and energy-intensive process. Pyrolyzed material can be sized with significantly less energy input—that is, it can be preferred to reduce the particle size of the product, and not the feedstock. This is an option in the present invention because the process does not require a fine starting material, and there is not necessarily any significant particle-size reduction during processing. The ability to process very large pieces of feedstock is a significant economic advantage of this invention. Notably, some market applications of the high-carbon product actually require large sizes (e.g., on the order of centimeters), so that in some embodiments, large pieces are fed, produced, and sold.

When it is desired to produce a final carbonaceous biogenic reagent that has structural integrity, such as in the form of cylinders, there are at least two options in the context of this invention. First, the material produced from the process can be collected and then further process mechanically into the desired form. For example, the product can be pressed or pelletized, with a binder. The second option is to utilize feed materials that generally possess the desired size or shape for the final product, and employ processing steps that do not destroy the basic structure of the feed material. In some embodiments, the feed and product have similar geometrical shapes, such as spheres, cylinders, or cubes.

The ability to maintain the approximate size of feed material throughout the process is beneficial when product strength is important. Also, this avoids the difficulty and cost of pelletizing high fixed-carbon materials.

The starting feed material can be provided with a range of moisture levels, as will be appreciated. In some embodiments, the feed material can already be sufficiently dry that it need not be further dried before pyrolysis. Typically, it will be desirable to utilize commercial sources of biomass which will usually contain moisture, and feed the biomass through a drying step before introduction into the pyrolysis reactor. However, in some embodiments a dried feedstock can be utilized.

It is usually desirable to provide a relatively low-oxygen environment in the pyrolysis reactor, such as about, or at most about, 10 mol %, 5 mol %, 4 mol %, 3 mol %, 2 mol %, 1.5 mol %, 1 mol %, 0.5 mol %, 0.2 mol %, 0.1 mol %, 0.05 mol %, 0.02 mol %, or 0.01 mol % O₂ in the gas phase. First, uncontrolled combustion should be avoided in the pyrolysis reactor, for safety reasons. Some amount of total carbon oxidation to CO₂ can occur, and the heat released from the exothermic oxidation can assist the endothermic pyrolysis chemistry. Large amounts of oxidation of carbon, including partial oxidation to syngas, will reduce the carbon yield to solids.

Practically speaking, it can be difficult to achieve a strictly oxygen-free environment in the reactor. This limit can be approached, and in some embodiments, the reactor is substantially free of molecular oxygen in the gas phase. To ensure that little or no oxygen is present in the pyrolysis reactor, it can be desirable to remove air from the feed material before it is introduced to the reactor. There are various ways to remove or reduce air in the feedstock.

In some embodiments, a deaeration unit is utilized in which feedstock, before or after drying, is conveyed in the presence of another gas which can remove adsorbed oxygen and penetrate the feedstock pores to remove oxygen from the pores. Essentially any gas that has lower than 21 vol % O₂ can be employed, at varying effectiveness. In some embodiments, nitrogen is employed. In some embodiments, CO or CO₂ is employed. Mixtures can be used, such as a mixture of nitrogen and a small amount of oxygen. Steam can be present in the deaeration gas, although adding significant moisture back to the feed should be avoided. The effluent from the deaeration unit can be purged (to the atmosphere or to an emissions treatment unit) or recycled.

In principle, the effluent (or a portion thereof) from the deaeration unit could be introduced into the pyrolysis reactor itself since the oxygen removed from the solids will now be highly diluted. In this embodiment, it can be advantageous to introduce the deaeration effluent gas to the last zone of the reactor, when it is operated in a countercurrent configuration.

Various types of deaeration units can be employed. If drying it to be performed, it can be preferable to dry and then deaerate since it can be inefficient to scrub soluble oxygen out of the moisture present. In certain embodiments, the drying and deaerating steps are combined into a single unit, or some amount of deaeration is achieved during drying, and so on.

The optionally dried and optionally deaerated feed material is introduced to a pyrolysis reactor or multiple reactors in series or parallel. The feed material can be introduced using any known means, including screw feeders or lock hoppers, for example. In some embodiments, a material feed system incorporates an air knife.

When a single reactor is employed, multiple zones can be present. Multiple zones, such as two, three, four, or more zones, can allow for the separate control of temperature, solids residence time, gas residence time, gas composition, flow pattern, or pressure in order to adjust the overall process performance.

References to “zones” shall be broadly construed to include regions of space within a single physical unit, physically separate units, or any combination thereof. For a continuous reactor, the demarcation of zones can relate to structure, such as the presence of flights within the reactor or distinct heating elements to provide heat to separate zones. Alternatively, or additionally, the demarcation of zones in a continuous reactor can relate to function, such as distinct temperatures, fluid flow patterns, solid flow patterns, extent of reaction, and so on. In a single batch reactor, “zones” are operating regimes in time, rather than in space. Multiple batch reactors can also be used.

It will be appreciated that there are not necessarily abrupt transitions from one zone to another zone. For example, the boundary between the preheating zone and pyrolysis zone can be somewhat arbitrary; some amount of pyrolysis can take place in a portion of the preheating zone, and some amount of “preheating” can continue to take place in the pyrolysis zone. The temperature profile in the reactor is typically continuous, including at zone boundaries within the reactor.

Some embodiments employ a first zone that is operated under conditions of preheating or mild pyrolysis. The temperature of the first zone can be selected from about 150° C. to about 500° C., such as about 300° C. to about 400° C. The temperature of the first zone is preferably not so high as to shock the biomass material which ruptures the cell walls and initiates fast decomposition of the solid phase into vapors and gases.

All references to zone temperatures in this specification should be construed in a non-limiting way to include temperatures that can apply to the bulk solids present, or the gas phase, or the reactor walls (on the process side). It will be understood that there will be a temperature gradient in each zone, both axially and radially, as well as temporally (i.e., following start-up or due to transients). Thus, references to zone temperatures can be references to average temperatures or other effective temperatures that can influence the actual kinetics. Temperatures can be directly measured by thermocouples or other temperature probes, or indirectly measured or estimated by other means.

The second zone, or in general the primary pyrolysis zone, is operated under conditions of pyrolysis or carbonization. The temperature of the second zone can be selected from about 250° C. to about 700° C., such as about, or at least about, or at most about 300° C., 350° C., 400° C., 450° C., 500° C., 550° C., 600° C., or 650° C. Within this zone, preheated biomass undergoes pyrolysis chemistry to release gases and condensable vapors, leaving a significant amount of solid material as a high-carbon reaction intermediate. Biomass components (primarily cellulose, hemicellulose, and lignin) decompose and create vapors, which escape by penetrating through pores or creating new pores. The suitable temperature will at least depend on the residence time of the second zone, as well as the nature of the feedstock and desired product properties.

The third zone, or cooling zone, is operated to cool down the high-carbon reaction intermediate to varying degrees. At a minimum, the temperature of the third zone should be a lower temperature than that of the second zone. The temperature of the third zone can be selected from about 100° C. to about 550° C., such as about 150° C. to about 350° C.

Chemical reactions can continue to occur in the cooling zone. Without being limited by any particular theory, it is believed that secondary pyrolysis reactions can be initiated in the third zone. Carbon-containing components that are in the gas phase can condense (due to the reduced temperature of the third zone). The temperature remains sufficiently high, however, to promote reactions that can form additional fixed carbon from the condensed liquids (secondary pyrolysis) or at least form bonds between adsorbed species and the fixed carbon. One exemplary reaction that can take place is the Boudouard reaction for conversion of carbon monoxide to carbon dioxide plus fixed carbon.

The residence times of the reactor zones can vary. There is an interplay of time and temperature, so that for a desired amount of pyrolysis, higher temperatures can allow for lower reaction times, and vice versa. The residence time in a continuous reactor (zone) is the volume divided by the volumetric flow rate. The residence time in a batch reactor is the batch reaction time, following heating to reaction temperature.

It should be recognized that in multiphase reactors, there are multiple residence times. In the present context, in each zone, there will be a residence time (and residence-time distribution) of both the solids phase and the vapor phase. For a given apparatus employing multiple zones, and with a given throughput, the residence times across the zones will generally be coupled on the solids side, but residence times can be uncoupled on the vapor side when multiple inlet and outlet ports are utilized in individual zones. The solids and vapor residence times are uncoupled.

The solids residence time of the preheating zone can be selected from about 5 min to about 60 min, such as about 10, 20, 30, 40, or 50 min. Depending on the temperature, sufficient time is desired to allow the biomass to reach a desired preheat temperature. The heat-transfer rate, which will depend on the particle type and size, the physical apparatus, and on the heating parameters, will dictate the minimum residence time necessary to allow the solids to reach a desired preheat temperature. In some embodiments, additional time is not desirable as it would contribute to higher capital cost, unless some amount of mild pyrolysis is intended in the preheating zone.

The solids residence time of the pyrolysis zone can be selected from about 10 min to about 120 min, such as about 20, 30, 40, 50, 60, 70, 80, 90, or 100 min. Depending on the pyrolysis temperature in this zone, there should be sufficient time to allow the carbonization chemistry to take place, following the necessary heat transfer. For times below about 10 min, in order to remove high quantities of non-carbon elements, the temperature would need to be quite high, such as above 700° C. This temperature would promote fast pyrolysis and its generation of vapors and gases derived from the carbon itself, which is to be avoided when the intended product is solid carbon.

In a static system, there would be an equilibrium conversion that could be substantially reached at a certain time. When, as in certain embodiments, vapor is continuously flowing over solids with continuous volatiles removal, the equilibrium constraint can be removed to allow for pyrolysis and devolatilization to continue until reaction rates approach zero. Longer times would not tend to substantially alter the remaining recalcitrant solids.

The solids residence time of the cooling zone can be selected from about 5 min to about 60 min, such as about 10, 20, 30, 40, or 50 min. Depending on the cooling temperature in this zone, there should be sufficient time to allow the carbon solids to cool to the desired temperature. The cooling rate and temperature will dictate the minimum residence time necessary to allow the carbon to be cooled. In some embodiments, additional time is not desirable, unless some amount of secondary pyrolysis is desired.

As discussed above, the residence time of the vapor phase can be separately selected and controlled. The vapor residence time of the preheating zone can be selected from about 0.1 min to about 15 min, such as about 0.5, 1, 2, 3, 4, 5, 6, 7, 8, 9, or 10 min. The vapor residence time of the pyrolysis zone can be selected from about 0.1 min to about 20 min, such as about 0.5, 1, 2, 3, 4, 5, 6, 7, 8, 9, 10, 11, 12, 13, 14, or 15 min. The vapor residence time of the cooling zone can be selected from about 0.1 min to about 15 min, such as about 0.5, 1, 2, 3, 4, 5, 6, 7, 8, 9, or 10 min. Short vapor residence times promote fast sweeping of volatiles out of the system, while longer vapor residence times promote reactions of components in the vapor phase with the solid phase.

The mode of operation for the reactor, and overall system, can be continuous, semi-continuous, batch, or any combination or variation of these. In some embodiments, the reactor is a continuous, countercurrent reactor in which solids and vapor flow substantially in opposite directions. The reactor can also be operated in batch but with simulated countercurrent flow of vapors, such as by periodically introducing and removing gas phases from the batch vessel.

Various flow patterns can be desired or observed. With chemical reactions and simultaneous separations involving multiple phases in multiple reactor zones, the fluid dynamics can be quite complex. Typically, the flow of solids can approach plug flow (well-mixed in the radial dimension) while the flow of vapor can approach fully mixed flow (fast transport in both radial and axial dimensions). Multiple inlet and outlet ports for vapor can contribute to overall mixing.

The pressure in each zone can be separately selected and controlled. The pressure of each zone can be independently selected from about 1 kPa to about 3000 kPa, such as about 101.3 kPa (normal atmospheric pressure). Independent zone control of pressure is possible when multiple gas inlets and outlets are used, including vacuum ports to withdraw gas when a zone pressure less than atmospheric is desired.

The process can conveniently be operated at atmospheric pressure, in some embodiments. There are many advantages associated with operation at atmospheric pressure, ranging from mechanical simplicity to enhanced safety. In certain embodiments, the pyrolysis zone is operated at a pressure of about 90 kPa, 95 kPa, 100 kPa, 101 kPa, 102 kPa, 105 kPa, or 110 kPa (absolute pressures).

Vacuum operation (e.g., 10-100 kPa) would promote fast sweeping of volatiles out of the system. Higher pressures (e.g., 100-1000 kPa) can be useful when the off-gases will be fed to a high-pressure operation. Elevated pressures can also be useful to promote heat transfer, chemistry, or separations.

The step of separating at least a portion of the condensable vapors and at least a portion of the non-condensable gases from the hot pyrolyzed solids can be accomplished in the reactor itself, or using a distinct separation unit. A substantially inert sweep gas can be introduced into one or more of the zones. Condensable vapors and non-condensable gases are then carried away from the zone(s) in the sweep gas, and out of the reactor.

The sweep gas can be N₂, Ar, CO, CO₂, H₂, H₂O, CH₄, other light hydrocarbons, or combinations thereof, for example. The sweep gas can first be preheated prior to introduction, or possibly cooled if it is obtained from a heated source.

The sweep gas more thoroughly removes volatile components, by getting them out of the system before they can condense or further react. The sweep gas allows volatiles to be removed at higher rates than would be attained merely from volatilization at a given process temperature. Or, use of the sweep gas allows milder temperatures to be used to remove a certain quantity of volatiles. The reason the sweep gas improves the volatiles removal is that the mechanism of separation is not merely relative volatility but rather liquid/vapor phase disengagement assisted by the sweep gas. The sweep gas can both reduce mass-transfer limitations of volatilization as well as reduce thermodynamic limitations by continuously depleting a given volatile species, to cause more of it to vaporize to attain thermodynamic equilibrium.

Some embodiments remove gases laden with volatile organic carbon from subsequent processing stages, in order to produce a product with high fixed carbon. Without removal, the volatile carbon can adsorb or absorb onto the pyrolyzed solids, thereby requiring additional energy (cost) to achieve a purer form of carbon which can be desired. By removing vapors quickly, it is also speculated that porosity can be enhanced in the pyrolyzing solids. Higher porosity is desirable for some products.

In certain embodiments, the sweep gas in conjunction with a relatively low process pressure, such as atmospheric pressure, provides for fast vapor removal without large amounts of inert gas necessary.

In some embodiments, the sweep gas flows countercurrent to the flow direction of feedstock. In other embodiments, the sweep gas flows cocurrent to the flow direction of feedstock. In some embodiments, the flow pattern of solids approaches plug flow while the flow pattern of the sweep gas, and gas phase generally, approaches fully mixed flow in one or more zones.

The sweep can be performed in any one or more of the reactor zones. In some embodiments, the sweep gas is introduced into the cooling zone and extracted (along with volatiles produced) from the cooling or pyrolysis zones. In some embodiments, the sweep gas is introduced into the pyrolysis zone and extracted from the pyrolysis or preheating zones. In some embodiments, the sweep gas is introduced into the preheating zone and extracted from the pyrolysis zone. In these or other embodiments, the sweep gas can be introduced into each of the preheating, pyrolysis, and cooling zones and also extracted from each of the zones.

In some embodiments, the zone or zones in which separation is carried out is a physically separate unit from the reactor. The separation unit or zone can be disposed between reactor zones, if desired. For example, there can be a separation unit placed between pyrolysis and cooling units.

The sweep gas can be introduced continuously, especially when the solids flow is continuous. When the pyrolysis reaction is operated as a batch process, the sweep gas can be introduced after a certain amount of time, or periodically, to remove volatiles. Even when the pyrolysis reaction is operated continuously, the sweep gas can be introduced semi-continuously or periodically, if desired, with suitable valves and controls.

The volatiles-containing sweep gas can exit from the one or more reactor zones, and can be combined if obtained from multiple zones. The resulting gas stream, containing various vapors, can then be fed to a thermal oxidizer for control of air emissions. Any known thermal-oxidation unit can be employed. In some embodiments, the thermal oxidizer is fed with natural gas and air, to reach sufficient temperatures for substantial destruction of volatiles contained therein.

The effluent of the thermal oxidizer will be a hot gas stream comprising water, carbon dioxide, and nitrogen. This effluent stream can be purged directly to air emissions, if desired. Preferably, the energy content of the thermal oxidizer effluent is recovered, such as in a waste-heat recovery unit. The energy content can also be recovered by heat exchange with another stream (such as the sweep gas). The energy content can be utilized by directly or indirectly heating, or assisting with heating, a unit elsewhere in the process, such as the dryer or the reactor. In some embodiments, essentially all of the thermal oxidizer effluent is employed for indirect heating (utility side) of the dryer. The thermal oxidizer can employ other fuels than natural gas.

The yield of carbonaceous material can vary, depending on the above-described factors including type of feedstock and process conditions. In some embodiments, the net yield of solids as a percentage of the starting feedstock, on a dry basis, is at least 25%, 30%, 35%, 40%, 45%, 50%, or higher. The remainder will be split between condensable vapors, such as terpenes, tars, alcohols, acids, aldehydes, or ketones; and non-condensable gases, such as carbon monoxide, hydrogen, carbon dioxide, and methane. The relative amounts of condensable vapors compared to non-condensable gases will also depend on process conditions, including the water present.

In terms of the carbon balance, in some embodiments the net yield of carbon as a percentage of starting carbon in the feedstock is at least 25%, 30%, 40%, 50%, 60%, 65%, 70%, 75%, 80%, or higher. For example, the in some embodiments the carbonaceous material contains between about 40% and about 70% of the carbon contained in the starting feedstock. The rest of the carbon results in the formation of methane, carbon monoxide, carbon dioxide, light hydrocarbons, aromatics, tars, terpenes, alcohols, acids, aldehydes, or ketones, to varying extents.

In alternative embodiments, some portion of these compounds is combined with the carbon-rich solids to enrich the carbon and energy content of the product. In these embodiments, some or all of the resulting gas stream from the reactor, containing various vapors, can be condensed, at least in part, and then passed over cooled pyrolyzed solids derived from the cooling zone or from the separate cooling unit. These embodiments are described in more detail below.

Following the reaction and cooling within the cooling zone (if present), the carbonaceous solids can be introduced into a distinct cooling unit. In some embodiments, solids are collected and simply allowed to cool at slow rates. If the carbonaceous solids are reactive or unstable in air, it can be desirable to maintain an inert atmosphere or rapidly cool the solids to, for example, a temperature less than 40° C., such as ambient temperature. In some embodiments, a water quench is employed for rapid cooling. In some embodiments, a fluidized-bed cooler is employed. A “cooling unit” should be broadly construed to also include containers, tanks, pipes, or portions thereof.

In some embodiments, the process further comprises operating the cooling unit to cool the warm pyrolyzed solids with steam, thereby generating the cool pyrolyzed solids and superheated steam; wherein the drying is carried out, at least in part, with the superheated steam derived from the cooling unit. Optionally, the cooling unit can be operated to first cool the warm pyrolyzed solids with steam to reach a first cooling-unit temperature, and then with air to reach a second cooling-unit temperature, wherein the second cooling-unit temperature is lower than the first cooling-unit temperature and is associated with a reduced combustion risk for the warm pyrolyzed solids in the presence of the air.

Following cooling to ambient conditions, the carbonaceous solids can be recovered and stored, conveyed to another site operation, transported to another site, or otherwise disposed, traded, or sold. The solids can be fed to a unit to reduce particle size. A variety of size-reduction units are known in the art, including crushers, shredders, grinders, pulverizers, jet mills, pin mills, and ball mills.

Screening or some other means for separation based on particle size can be included. The grinding can be upstream or downstream of grinding, if present. A portion of the screened material (e.g., large chunks) can be returned to the grinding unit. The small and large particles can be recovered for separate downstream uses. In some embodiments, cooled pyrolyzed solids are ground into a fine powder, such as a pulverized carbon or activated carbon product.

Various additives can be introduced throughout the process, before, during, or after any step disclosed herein. The additives can be broadly classified as process additives, selected to improve process performance such as carbon yield or pyrolysis time/temperature to achieve a desired carbon purity; and product additives, selected to improve one or more properties of the biogenic reagent, or a downstream product incorporating the reagent. Certain additives can provide enhanced process and product (biogenic reagents or products containing biogenic reagents) characteristics.

Additives can be added before, during, or after any one or more steps of the process, including into the feedstock itself at any time, before or after it is harvested. Additive treatment can be incorporated prior to, during, or after feedstock sizing, drying, or other preparation. Additives can be incorporated at or on feedstock supply facilities, transport trucks, unloading equipment, storage bins, conveyors (including open or closed conveyors), dryers, process heaters, or any other units. Additives can be added anywhere into the pyrolysis process itself, using suitable means for introducing additives. Additives can be added after carbonization, or even after pulverization, if desired.

In some embodiments, an additive is selected from a metal, a metal oxide, a metal hydroxide, or a combination thereof. For example an additive can be selected from, but is by no means limited to, magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof.

In some embodiments, an additive is selected from an acid, a base, or a salt thereof. For example an additive can be selected from, but is by no means limited to, sodium hydroxide, potassium hydroxide, magnesium oxide, hydrogen bromide, hydrogen chloride, sodium silicate, potassium permanganate, or combinations thereof.

In some embodiments, an additive is selected from a metal halide. Metal halides are compounds between metals and halogens (fluorine, chlorine, bromine, iodine, and astatine). The halogens can form many compounds with metals. Metal halides are generally obtained by direct combination, or more commonly, neutralization of basic metal salt with a hydrohalic acid. In some embodiments, an additive is selected from iron chloride (FeCl₂ or FeCl₃), iron bromide (FeBr₂ or FeBr₃), or hydrates thereof, and any combinations thereof.

Additives can result in a final product with higher energy content (energy density). An increase in energy content can result from an increase in total carbon, fixed carbon, volatile carbon, or even hydrogen. Alternatively or additionally, the increase in energy content can result from removal of non-combustible matter or of material having lower energy density than carbon. In some embodiments, additives reduce the extent of liquid formation, in favor of solid and gas formation, or in favor of solid formation.

Without being limited to any particular hypothesis, additives can chemically modify the starting biomass, or treated biomass prior to pyrolysis, to reduce rupture of cell walls for greater strength/integrity. In some embodiments, additives can increase fixed carbon content of biomass feedstock prior to pyrolysis.

Additives can result in a biogenic reagent with improved mechanical properties, such as yield strength, compressive strength, tensile strength, fatigue strength, impact strength, elastic modulus, bulk modulus, or shear modulus. Additives can improve mechanical properties by simply being present (e.g., the additive itself imparts strength to the mixture) or due to some transformation that takes place within the additive phase or within the resulting mixture. For example, reactions such as vitrification can occur within a portion of the biogenic reagent that includes the additive, thereby improving the final strength.

Chemical additives can be applied to wet or dry biomass feedstocks. The additives can be applied as a solid powder, a spray, a mist, a liquid, or a vapor. In some embodiments, additives can be introduced through spraying of a liquid solution (such as an aqueous solution or in a solvent), or by soaking in tanks, bins, bags, or other containers.

In certain embodiments, dip pretreatment is employed wherein the solid feedstock is dipped into a bath comprising the additive, either batchwise or continuously, for a time sufficient to allow penetration of the additive into the solid feed material.

In some embodiments, additives applied to the feedstock can reduce energy requirements for the pyrolysis, or increase the yield of the carbonaceous product. In these or other embodiments, additives applied to the feedstock can provide functionality that is desired for the intended use of the carbonaceous product.

The throughput, or process capacity, can vary widely from small laboratory-scale units to full operations, including any pilot, demonstration, or semi-commercial scale. In various embodiments, the process capacity (for feedstocks, products, or both) is at least about 1 kg/day, 10 kg/day, 100 kg/day, 1 ton/day (all tons are metric tons), 10 tons/day, 100 tons/day, 500 tons/day, 1000 tons/day, 2000 tons/day, or higher.

In some embodiments, a portion of solids produced can be recycled to the front end of the process, i.e., to the drying or deaeration unit or directly to the reactor. By returning to the front end and passing through the process again, treated solids can become higher in fixed carbon. Solid, liquid, and gas streams produced or existing within the process can be independently recycled, passed to subsequent steps, or removed/purged from the process at any point.

In some embodiments, pyrolyzed material is recovered and then fed to a separate unit for further pyrolysis, to create a product with higher carbon purity (e.g., conversion of low-fixed-carbon material to high-fixed-carbon material). In some embodiments, the secondary process can be conducted in a simple container, such as a steel drum, in which heated inert gas (such as heated N₂) is passed through. Other containers useful for this purpose include process tanks, barrels, bins, totes, sacks, and roll-offs. This secondary sweep gas with volatiles can be sent to the thermal oxidizer, or back to the main process reactor, for example. To cool the final product, another stream of inert gas, which is initially at ambient temperature for example, can be passed through the solids to cool the solids, and then returned to an inert gas preheat system.

Some variations of the invention utilize a biogenic reagent production system comprising:
(a) a feeder configured to introduce a carbon-containing feedstock;
(b) an optional dryer, disposed in operable communication with the feeder, configured to remove moisture contained within a carbon-containing feedstock;
(c) a multiple-zone reactor, disposed in operable communication with the dryer, wherein the multiple-zone reactor contains at least a pyrolysis zone disposed in operable communication with a spatially separated cooling zone, and wherein the multiple-zone reactor is configured with an outlet to remove condensable vapors and non-condensable gases from solids;
(d) a solids cooler, disposed in operable communication with the multiple-zone reactor; and
(e) a biogenic reagent recovery unit, disposed in operable communication with the solids cooler.

Some variations utilize a biogenic reagent production system comprising:
(a) a feeder configured to introduce a carbon-containing feedstock;
(b) an optional dryer, disposed in operable communication with the feeder, configured to remove moisture contained within a carbon-containing feedstock;
(c) an optional preheater, disposed in operable communication with the dryer, configured to heat or mildly pyrolyze the feedstock;
(d) a pyrolysis reactor, disposed in operable communication with the preheater, configured to pyrolyze the feedstock;
(e) a cooler, disposed in operable communication with the pyrolysis reactor, configured to cool pyrolyzed solids; and
(f) a biogenic reagent recovery unit, disposed in operable communication with the cooler,
wherein the system is configured with at least one gas outlet to remove condensable vapors and non-condensable gases from solids.

The feeder can be physically integrated with the multiple-zone reactor, such as through the use of a screw feeder or auger mechanism to introduce feed solids into the first reaction zone.

In some embodiments, the system further comprises a preheating zone, disposed in operable communication with the pyrolysis zone. Each of the pyrolysis zone, cooling zone, and preheating zone (it present) can be located within a single unit, or can be located in separate units.

Optionally, the dryer can be configured as a drying zone within the multiple-zone reactor. Optionally, the solids cooler can be disposed within the multiple-zone reactor (i.e., configured as an additional cooling zone or integrated with the main cooling zone).

The system can include a purging means for removing oxygen from the system. For example, the purging means can comprise one or more inlets to introduce a substantially inert gas, and one or more outlets to remove the substantially inert gas and displaced oxygen from the system. In some embodiments, the purging means is a deaerater disposed in operable communication between the dryer and the multiple-zone reactor.

The multiple-zone reactor can be configured with at least a first gas inlet and a first gas outlet. The first gas inlet and the first gas outlet can be disposed in communication with different zones, or with the same zone.

In some embodiments, the multiple-zone reactor is configured with a second gas inlet or a second gas outlet. In some embodiments, the multiple-zone reactor is configured with a third gas inlet or a third gas outlet. In some embodiments, the multiple-zone reactor is configured with a fourth gas inlet or a fourth gas outlet. In some embodiments, each zone present in the multiple-zone reactor is configured with a gas inlet and a gas outlet.

Gas inlets and outlets allow not only introduction and withdrawal of vapor, but gas outlets (probes) in particular allow precise process monitoring and control across various stages of the process, up to and potentially including all stages of the process. Precise process monitoring would be expected to result in yield and efficiency improvements, both dynamically as well as over a period of time when operational history can be utilized to adjust process conditions.

In certain embodiments, a reaction gas probe is disposed in operable communication with the pyrolysis zone. Such a reaction gas probe can be useful to extract gases and analyze them, in order to determine extent of reaction, pyrolysis selectivity, or other process monitoring. Then, based on the measurement, the process can be controlled or adjusted in any number of ways, such as by adjusting feed rate, rate of inert gas sweep, temperature (of one or more zones), pressure (of one or more zones), additives, and so on.

As intended herein, “monitor and control” via reaction gas probes should be construed to include any one or more sample extractions via reaction gas probes, and optionally making process or equipment adjustments based on the measurements, if deemed necessary or desirable, using well-known principles of process control (feedback, feedforward, proportional-integral-derivative logic, etc.).

A reaction gas probe can be configured to withdraw gas samples in a number of ways. For example, a sampling line can have a lower pressure than the pyrolysis reactor pressure, so that when the sampling line is opened an amount of gas can readily be withdrawn from pyrolysis zone. The sampling line can be under vacuum, such as when the pyrolysis zone is near atmospheric pressure. Typically, a reaction gas probe will be associated with one gas output, or a portion thereof (e.g., a line split from a gas output line).

In some embodiments, both a gas input and a gas output are utilized as a reaction gas probe by periodically introducing an inert gas into a zone, and pulling the inert gas with a process sample out of the gas output (“sample sweep”). Such an arrangement could be used in a zone that does not otherwise have a gas inlet/outlet for the substantially inert gas for processing, or, the reaction gas probe could be associated with a separate gas inlet/outlet that is in addition to process inlets and outlets. A sampling inert gas that is introduced and withdrawn periodically for sampling (in embodiments that utilize sample sweeps) could even be different than the process inert gas, if desired, either for reasons of accuracy in analysis or to introduce an analytical tracer.

For example, acetic acid concentration in the gas phase of the pyrolysis zone can be measured using a gas probe to extract a sample, which is then analyzed using a suitable technique (such as gas chromatography, GC; mass spectroscopy, MS; GC-MS, or Fourier-Transform Infrared Spectroscopy, FTIR). CO or CO₂ concentration in the gas phase could be measured and used as an indication of the pyrolysis selectivity toward gases/vapors, for example. Terpene concentration in the gas phase could be measured and used as an indication of the pyrolysis selectivity toward liquids, for example.

In some embodiments, the system further comprises at least one additional gas probe disposed in operable communication with the cooling zone, or with the drying zone (if present) or the preheating zone (if present).

A gas probe for the cooling zone could be useful to determine the extent of any additional chemistry taking place in the cooling zone, for example. A gas probe in the cooling zone could also be useful as an independent measurement of temperature (in addition, for example, to a thermocouple disposed in the cooling zone). This independent measurement can be a correlation of cooling temperature with a measured amount of a certain species. The correlation could be separately developed, or could be established after some period of process operation.

A gas probe for the drying zone could be useful to determine the extent of drying, by measuring water content, for example. A gas probe in the preheating zone could be useful to determine the extent of any mild pyrolysis taking place, for example.

In certain embodiments, the cooling zone is configured with a gas inlet, and the pyrolysis zone is configured with a gas outlet, to generate substantially countercurrent flow of the gas phase relative to the solid phase. Alternatively, or additionally, the preheating zone (when it is present) can be configured with a gas outlet, to generate substantially countercurrent flow of the gas phase relative to the solid phase. Alternatively, or additionally, the drying zone can be configured with a gas outlet, to generate substantially countercurrent flow.

The pyrolysis reactor or reactors can be selected from any suitable reactor configuration that is capable of carrying out the pyrolysis process. Exemplary reactor configurations include, but are not limited to, fixed-bed reactors, fluidized-bed reactors, entrained-flow reactors, augers, ablative reactors, rotating cones, rotary drum kilns, calciners, roasters, moving-bed reactors, transport-bed reactors, ablative reactors, rotating cones, or microwave-assisted pyrolysis reactors.

In some embodiments in which an auger is used, sand or another heat carrier can optionally be employed. For example, the feedstock and sand can be fed at one end of a screw. The screw mixes the sand and feedstock and conveys them through the reactor. The screw can provide good control of the feedstock residence time and does not dilute the pyrolyzed products with a carrier or fluidizing gas. The sand can be reheated in a separate vessel.

In some embodiments in which an ablative process is used, the feedstock is moved at a high speed against a hot metal surface. Ablation of any char forming at surfaces can maintain a high rate of heat transfer. Such apparatus can prevent dilution of products. As an alternative, the feedstock particles can be suspended in a carrier gas and introduced at a high speed through a cyclone whose wall is heated.

In some embodiments in which a fluidized-bed reactor is used, the feedstock can be introduced into a bed of hot sand fluidized by a gas, which is typically a recirculated product gas. Reference herein to “sand” shall also include similar, substantially inert materials, such as glass particles, recovered ash particles, and the like. High heat-transfer rates from fluidized sand can result in rapid heating of the feedstock. There can be some ablation by attrition with the sand particles. Heat is usually provided by heat-exchanger tubes through which hot combustion gas flows.

Circulating fluidized-bed reactors can be employed, wherein gas, sand, and feedstock move together. Exemplary transport gases include recirculated product gases and combustion gases. High heat-transfer rates from the sand ensure rapid heating of the feedstock, and ablation is expected to be stronger than with regular fluidized beds. A separator can be employed to separate the product gases from the sand and char particles. The sand particles can be reheated in a fluidized burner vessel and recycled to the reactor.

In some embodiments, a multiple-zone reactor is a continuous reactor comprising a feedstock inlet, a plurality of spatially separated reaction zones configured for separately controlling the temperature and mixing within each of the reaction zones, and a carbonaceous-solids outlet, wherein one of the reaction zones is configured with a first gas inlet for introducing a substantially inert gas into the reactor, and wherein one of the reaction zones is configured with a first gas outlet.

In various embodiments the reactor includes at least two, three, four, or more reaction zones. Each of the reaction zones is disposed in communication with separately adjustable heating means independently selected from electrical heat transfer, steam heat transfer, hot-oil heat transfer, phase-change heat transfer, waste heat transfer, or a combination thereof. In some embodiments, at least one reactor zone is heated with an effluent stream from the thermal oxidizer, if present.

The reactor can be configured for separately adjusting gas-phase composition and gas-phase residence time of at least two reaction zones, up to and including all reaction zones present in the reactor.

The reactor can be equipped with a second gas inlet or a second gas outlet. In some embodiments, the reactor is configured with a gas inlet in each reaction zone. In these or other embodiments, the reactor is configured with a gas outlet in each reaction zone. The reactor can be a cocurrent or countercurrent reactor.

In some embodiments, the feedstock inlet comprises a screw or auger feed mechanism. In some embodiments, the carbonaceous-solids outlet comprises a screw or auger output mechanism.

Certain embodiments utilize a rotating calciner with a screw feeder. In these embodiments, the reactor is axially rotatable, i.e., it spins about its centerline axis. The speed of rotation will impact the solid flow pattern, and heat and mass transport. Each of the reaction zones can be configured with flights disposed on internal walls, to provide agitation of solids. The flights can be separately adjustable in each of the reaction zones.

Other means of agitating solids can be employed, such as augers, screws, or paddle conveyors. In some embodiments, the reactor includes a single, continuous auger disposed throughout each of the reaction zones. In other embodiments, the reactor includes twin screws disposed throughout each of the reaction zones.

Some systems are designed specifically with the capability to maintain the approximate size of feed material throughout the process—that is, to process the biomass feedstock without destroying or significantly damaging its structure. In some embodiments, the pyrolysis zone does not contain augers, screws, or rakes that would tend to greatly reduce the size of feed material being pyrolyzed.

In some embodiments of the invention, the system further includes a thermal oxidizer disposed in operable communication with the outlet at which condensable vapors and non-condensable gases are removed. The thermal oxidizer is preferably configured to receive a separate fuel (such as natural gas) and an oxidant (such as air) into a combustion chamber, adapted for combustion of the fuel and at least a portion of the condensable vapors. Certain non-condensable gases can also be oxidized, such as CO or CH₄, to CO₂.

When a thermal oxidizer is employed, the system can include a heat exchanger disposed between the thermal oxidizer and the dryer, configured to utilize at least some of the heat of the combustion for the dryer. This embodiment can contribute significantly to the overall energy efficiency of the process.

In some embodiments, the system further comprises a carbon-enhancement unit, disposed in operable communication with the solids cooler, configured for combining condensable vapors, in at least partially condensed form, with the solids. The carbon-enhancement unit can increase the carbon content of the biogenic reagent obtained from the recovery unit.

The system can further include a separate pyrolysis unit adapted to further pyrolyze the biogenic reagent to further increase its carbon content. The separate pyrolysis unit can be a relatively simply container, unit, or device, such as a tank, barrel, bin, drum, tote, sack, or roll-off.

The overall system can be at a fixed location, or it can be distributed at several locations. The system can be constructed using modules which can be simply duplicated for practical scale-up. The system can also be constructed using economy-of-scale principles, as is well-known in the process industries.

Some variations relating to carbon enhancement of solids will now be further described. In some embodiments, a process for producing a biogenic reagent comprises:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) in a pyrolysis zone, pyrolyzing the feedstock in the presence of a substantially inert gas for at least 10 minutes and with a pyrolysis temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) in a cooling zone, cooling the hot pyrolyzed solids, in the presence of the substantially inert gas for at least 5 minutes and with a cooling temperature less than the pyrolysis temperature, to generate warm pyrolyzed solids;
(g) optionally cooling the warm pyrolyzed solids to generate cool pyrolyzed solids;
(h) subsequently passing at least a portion of the condensable vapors or at least a portion of the non-condensable gases from step (e) across the warm pyrolyzed solids or the cool pyrolyzed solids, to form enhanced pyrolyzed solids with increased carbon content; and
(i) recovering a biogenic reagent comprising at least a portion of the enhanced pyrolyzed solids.

In some embodiments, step (h) includes passing at least a portion of the condensable vapors from step (e), in vapor or condensed form, across the warm pyrolyzed solids, to produce enhanced pyrolyzed solids with increased carbon content. In some embodiments, step (h) includes passing at least a portion of the non-condensable gases from step (e) across the warm pyrolyzed solids, to produce enhanced pyrolyzed solids with increased carbon content.

Alternatively, or additionally, vapors or gases can be contacted with the cool pyrolyzed solids. In some embodiments, step (h) includes passing at least a portion of the condensable vapors from step (e), in vapor or condensed form, across the cool pyrolyzed solids, to produce enhanced pyrolyzed solids with increased carbon content. In some embodiments, step (h) includes passing at least a portion of the non-condensable gases from step (e) across the cool pyrolyzed solids, to produce enhanced pyrolyzed solids with increased carbon content.

In certain embodiments, step (h) includes passing substantially all of the condensable vapors from step (e), in vapor or condensed form, across the cool pyrolyzed solids, to produce enhanced pyrolyzed solids with increased carbon content. In certain embodiments, step (h) includes passing substantially all of the non-condensable gases from step (e) across the cool pyrolyzed solids, to produce enhanced pyrolyzed solids with increased carbon content.

The process can include various methods of treating or separating the vapors or gases prior to using them for carbon enhancement. For example, an intermediate feed stream comprising or consisting essentially of at least a portion of the condensable vapors and at least a portion of the non-condensable gases, obtained from step (e), can be fed to a separation unit configured to generate at least first and second output streams. In certain embodiments, the intermediate feed stream comprises all of the condensable vapors, all of the non-condensable gases, or both. Separation techniques can include or use distillation columns, flash vessels, centrifuges, cyclones, membranes, filters, packed beds, capillary columns, and so on. Separation can be principally based, for example, on distillation, absorption, adsorption, or diffusion, and can utilize differences in vapor pressure, activity, molecular weight, density, viscosity, polarity, chemical functionality, affinity to a stationary phase, and any combinations thereof.

In some embodiments, the first and second output streams are separated from the intermediate feed stream based on relative volatility. For example, the separation unit can be a distillation column, a flash tank, or a condenser.

Thus in some embodiments, the first output stream comprises the condensable vapors, and the second output stream comprises the non-condensable gases. The condensable vapors can include at least one carbon-containing compound selected from terpenes, alcohols, acids, aldehydes, or ketones. The vapors from pyrolysis can include aromatic compounds such as benzene, toluene, ethylbenzene, and xylenes. Heavier aromatic compounds, such as refractory tars, can be present in the vapor. The non-condensable gases can include at least one carbon-containing molecule selected from carbon monoxide, carbon dioxide, or methane.

In some embodiments, the first and second output streams are separated intermediate feed stream based on relative polarity. For example, the separation unit can be a stripping column, a packed bed, a chromatography column, or membranes.

Thus in some embodiments, the first output stream comprises polar compounds, and the second output stream comprises non-polar compounds. The polar compounds can include at least one carbon-containing molecule selected from methanol, furfural, or acetic acid. The non-polar compounds can include at least one carbon-containing molecule selected from carbon monoxide, carbon dioxide, methane, a terpene, or a terpene derivative.

Step (h) can increase the total carbon content of the biogenic reagent, relative to an otherwise-identical process without step (h). The extent of increase in carbon content can be, for example, about 1%, 2%, 5%, 10%, 15%, 25%, or even higher, in various embodiments.

In some embodiments, step (h) increases the fixed carbon content of the biogenic reagent. In these or other embodiments, step (h) increases the volatile carbon content of the biogenic reagent. Volatile carbon content is the carbon attributed to volatile matter in the reagent. The volatile matter can be, but is not limited to, hydrocarbons including aliphatic or aromatic compounds (e.g., terpenes); oxygenates including alcohols, aldehydes, or ketones; and various tars. Volatile carbon will typically remain bound or adsorbed to the solids at ambient conditions but upon heating, will be released before the fixed carbon would be oxidized, gasified, or otherwise released as a vapor.

Depending on conditions associated with step (h), it is possible for some amount of volatile carbon to become fixed carbon (e.g., via Boudouard carbon formation from CO). Typically, the volatile matter will enter the micropores of the fixed carbon and will be present as condensed/adsorbed species, but remain relatively volatile. This residual volatility can be more advantageous for fuel applications, compared to product applications requiring high surface area and porosity.

Step (h) can increase the energy content (i.e., energy density) of the biogenic reagent. The increase in energy content can result from an increase in total carbon, fixed carbon, volatile carbon, or even hydrogen. The extent of increase in energy content can be, for example, about 1%, 2%, 5%, 10%, 15%, 25%, or even higher, in various embodiments.

Further separations can be employed to recover one or more non-condensable gases or condensable vapors, for use within the process or further processing. For example, further processing can be included to produce refined carbon monoxide or hydrogen.

As another example, separation of acetic acid can be conducted, followed by reduction of the acetic acid into ethanol. The reduction of the acetic acid can be accomplished, at least in part, using hydrogen derived from the non-condensable gases produced.

Condensable vapors can be used for either energy in the process (such as by thermal oxidation) or in carbon enrichment, to increase the carbon content of the biogenic reagent. Certain non-condensable gases, such as CO or CH₄, can be utilized either for energy in the process, or as part of the substantially inert gas for the pyrolysis step. Combinations of any of the foregoing are also possible.

A potential benefit of including step (h) is that the gas stream is scrubbed, with the resulting gas stream being enriched in CO and CO₂. The resulting gas stream can be utilized for energy recovery, recycled for carbon enrichment of solids, or used as an inert gas in the reactor. Similarly, by separating non-condensable gases from condensable vapors, the CO/CO₂ stream is prepared for use as the inert gas in the reactor system or in the cooling system, for example.

Other variations are premised on the realization that the principles of the carbon-enhancement step can be applied to any feedstock in which it is desired to add carbon.

In some embodiments, a batch or continuous process for producing a biogenic reagent comprises:
(a) providing a solid stream comprising a carbon-containing material;
(b) providing a gas stream comprising condensable carbon-containing vapors, non-condensable carbon-containing gases, or a mixture of condensable carbon-containing vapors and non-condensable carbon-containing gases; and
(c) passing the gas stream across the solid stream under suitable conditions to form a carbon-containing product with increased carbon content relative to the carbon-containing material.

In some embodiments, the starting carbon-containing material is pyrolyzed biomass or torrefied biomass. The gas stream can be obtained during an integrated process that provides the carbon-containing material. Or, the gas stream can be obtained from separate processing of the carbon-containing material. The gas stream, or a portion thereof, can be obtained from an external source (e.g., an oven at a lumber mill). Mixtures of gas streams, as well as mixtures of carbon-containing materials, from a variety of sources, are possible.

In some embodiments, the process further comprises recycling or reusing the gas stream for repeating the process to further increase carbon or energy content of the carbon-containing product. In some embodiments, the process further comprises recycling or reusing the gas stream for carrying out the process to increase carbon or energy content of another feedstock different from the carbon-containing material.

In some embodiments, the process further includes introducing the gas stream to a separation unit configured to generate at least first and second output streams, wherein the gas stream comprises a mixture of condensable carbon-containing vapors and non-condensable carbon-containing gases. The first and second output streams can be separated based on relative volatility, relative polarity, or any other property. The gas stream can be obtained from separate processing of the carbon-containing material.

In some embodiments, the process further comprises recycling or reusing the gas stream for repeating the process to further increase carbon content of the carbon-containing product. In some embodiments, the process further comprises recycling or reusing the gas stream for carrying out the process to increase carbon content of another feedstock.

The carbon-containing product can have an increased total carbon content, a higher fixed carbon content, a higher volatile carbon content, a higher energy content, or any combination thereof, relative to the starting carbon-containing material.

In related variations, a biogenic reagent production system comprises:
(a) a feeder configured to introduce a carbon-containing feedstock;
(b) an optional dryer, disposed in operable communication with the feeder, configured to remove moisture contained within a carbon-containing feedstock;
(c) a multiple-zone reactor, disposed in operable communication with the dryer, wherein the multiple-zone reactor contains at least a pyrolysis zone disposed in operable communication with a spatially separated cooling zone, and wherein the multiple-zone reactor is configured with an outlet to remove condensable vapors and non-condensable gases from solids;
(d) a solids cooler, disposed in operable communication with the multiple-zone reactor;
(e) a material-enrichment unit, disposed in operable communication with the solids cooler, configured to pass the condensable vapors or the non-condensable gases across the solids, to form enhanced solids with increased carbon content; and
(f) a biogenic reagent recovery unit, disposed in operable communication with the material-enrichment unit.

The system can further comprise a preheating zone, disposed in operable communication with the pyrolysis zone. In some embodiments, the dryer is configured as a drying zone within the multiple-zone reactor. Each of the zones can be located within a single unit or in separate units. Also, the solids cooler can be disposed within the multiple-zone reactor.

In some embodiments, the cooling zone is configured with a gas inlet, and the pyrolysis zone is configured with a gas outlet, to generate substantially countercurrent flow of the gas phase relative to the solid phase. In these or other embodiments, the preheating zone or the drying zone (or dryer) is configured with a gas outlet, to generate substantially countercurrent flow of the gas phase relative to the solid phase.

In particular embodiments, the system incorporates a material-enrichment unit that comprises:
(i) a housing with an upper portion and a lower portion;
(ii) an inlet at a bottom of the lower portion of the housing configured to carry the condensable vapors and non-condensable gases;
(iii) an outlet at a top of the upper portion of the housing configured to carry a concentrated gas stream derived from the condensable vapors and non-condensable gases;
(iv) a path defined between the upper portion and the lower portion of the housing; and
(v) a transport system following the path, the transport system configured to transport the solids, wherein the housing is shaped such that the solids adsorb at least some of the condensable vapors or at least some of the non-condensable gases.

The present invention is capable of producing a variety of compositions useful as biogenic reagents, and products incorporating such reagents. In some variations, a biogenic reagent is produced by any process disclosed herein, such as a process comprising the steps of:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) in a pyrolysis zone, pyrolyzing the feedstock in the presence of a substantially inert gas for at least 10 minutes and with a pyrolysis temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) in a cooling zone, cooling the hot pyrolyzed solids, in the presence of the substantially inert gas for at least 5 minutes and with a cooling temperature less than the pyrolysis temperature, to generate warm pyrolyzed solids;
(g) cooling the warm pyrolyzed solids to generate cool pyrolyzed solids; and
(h) recovering a biogenic reagent comprising at least a portion of the cool pyrolyzed solids.

In some embodiments, the reagent comprises about at least 70 wt %, at least 80 wt %, at least 90 wt %, or at least 95 wt % total carbon on a dry basis. The total carbon includes at least fixed carbon, and can further include carbon from volatile matter. In some embodiments, carbon from volatile matter is about at least 5%, at least 10%, at least 25%, or at least 50% of the total carbon present in the biogenic reagent. Fixed carbon can be measured using ASTM D3172, while volatile carbon can be measured using ASTM D3175, for example.

The biogenic reagent can comprise about 10 wt % or less, such as about 5 wt % or less, hydrogen on a dry basis. The biogenic reagent can comprise about 1 wt % or less, such as about 0.5 wt % or less, nitrogen on a dry basis. The biogenic reagent can comprise about 0.5 wt % or less, such as about 0.2 wt % or less, phosphorus on a dry basis. The biogenic reagent can comprise about 0.2 wt % or less, such as about 0.1 wt % or less, sulfur on a dry basis.

Carbon, hydrogen, and nitrogen can be measured using ASTM D5373 for ultimate analysis, for example. Oxygen can be measured using ASTM D3176, for example. Sulfur can be measured using ASTM D3177, for example.

Certain embodiments provide reagents with little or essentially no hydrogen (except from any moisture that can be present), nitrogen, phosphorus, or sulfur, and are substantially carbon plus any ash and moisture present. Therefore, some embodiments provide a biogenic reagent with up to and including 100% carbon, on a dry/ash-free (DAF) basis.

Generally speaking, feedstocks such as biomass contain non-volatile species, including silica and various metals, which are not readily released during pyrolysis. It is of course possible to utilize ash-free feedstocks, in which case there should not be substantial quantities of ash in the pyrolyzed solids. Ash can be measured using ASTM D3174, for example.

Various amounts of non-combustible matter, such as ash, can be present. The biogenic reagent can comprise about 10 wt % or less, such as about 5 wt %, about 2 wt %, about 1 wt % or less non-combustible matter on a dry basis. In certain embodiments, the reagent contains little ash, or even essentially no ash or other non-combustible matter. Therefore, some embodiments provide essentially pure carbon, including 100% carbon, on a dry basis.

Various amounts of moisture can be present. On a total mass basis, the biogenic reagent can comprise at least 1 wt %, 2 wt %, 5 wt %, 10 wt %, 15 wt %, 25 wt %, 35 wt %, 50 wt %, or more moisture. As intended herein, “moisture” is to be construed as including any form of water present in the biogenic reagent, including absorbed moisture, adsorbed water molecules, chemical hydrates, and physical hydrates. The equilibrium moisture content can vary at least with the local environment, such as the relative humidity. Also, moisture can vary during transportation, preparation for use, and other logistics. Moisture can be measured using ASTM D3173, for example.

The biogenic reagent can have various energy contents which for present purposes means the energy density based on the higher heating value associated with total combustion of the bone-dry reagent. For example, the biogenic reagent can possess an energy content of about at least 11,000 Btu/lb, at least 12,000 Btu/lb, at least 13,000 Btu/lb, at least 14,000 Btu/lb, or at least 15,000 Btu/lb. In certain embodiments, the energy content is between about 14,000-15,000 Btu/lb. The energy content can be measured using ASTM D5865, for example.

The biogenic reagent can be formed into a powder, such as a coarse powder or a fine powder. For example, the reagent can be formed into a powder with an average mesh size of about 200 mesh, about 100 mesh, about 50 mesh, about 10 mesh, about 6 mesh, about 4 mesh, or about 2 mesh, in embodiments.

In some embodiments, the biogenic reagent is formed into structural objects comprising pressed, binded, or agglomerated particles. The starting material to form these objects can be a powder form of the reagent, such as an intermediate obtained by particle-size reduction. The objects can be formed by mechanical pressing or other forces, optionally with a binder or other means of agglomerating particles together.

In some embodiments, the biogenic reagent is produced in the form of structural objects whose structure substantially derives from the feedstock. For example, feedstock chips can produce product chips of biogenic reagent. Or, feedstock cylinders can produce biogenic reagent cylinders, which can be somewhat smaller but otherwise maintain the basic structure and geometry of the starting material.

A biogenic reagent according to the present invention can be produced as, or formed into, an object that has a minimum dimension of at least about 1 cm, 2 cm, 3 cm, 4 cm, 5 cm, 6 cm, 7 cm, 8 cm, 9 cm, 10 cm, or higher. In various embodiments, the minimum dimension or maximum dimension can be a length, width, or diameter.

Other variations of the invention relate to the incorporation of additives into the process, into the product, or both. In some embodiments, the biogenic reagent includes at least one process additive incorporated during the process. In these or other embodiments, the reagent includes at least one product additive introduced to the reagent following the process.

In some embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur; and
an additive selected from a metal, a metal oxide, a metal hydroxide, a metal halide, or a combination thereof.

The additive can be selected from, but is by no means limited to, magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof.

In some embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur; and
an additive selected from an acid, a base, or a salt thereof.

The additive can be selected from, but is by no means limited to, sodium hydroxide, potassium hydroxide, magnesium oxide, hydrogen bromide, hydrogen chloride, sodium silicate, potassium permanganate, or combinations thereof.

In certain embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur;
a first additive selected from a metal, metal oxide, metal hydroxide, a metal halide, or a combination thereof; and
a second additive selected from an acid, a base, or a salt thereof,
wherein the first additive is different from the second additive.

The first additive can be selected from magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof, while the second additive can be independently selected from sodium hydroxide, potassium hydroxide, magnesium oxide, hydrogen bromide, hydrogen chloride, sodium silicate, potassium permanganate, or combinations thereof.

A certain biogenic reagent consists essentially of, on a dry basis, carbon, hydrogen, nitrogen, phosphorus, sulfur, non-combustible matter, and an additive selected from magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, or combinations thereof.

A certain biogenic reagent consists essentially of, on a dry basis, carbon, hydrogen, nitrogen, phosphorus, sulfur, non-combustible matter, and an additive selected from sodium hydroxide, potassium hydroxide, magnesium oxide, hydrogen bromide, hydrogen chloride, sodium silicate, or combinations thereof.

The amount of additive (or total additives) can vary widely, such as from about 0.01 wt % to about 25 wt %, including about 0.1 wt %, about 1 wt %, about 5 wt %, about 10 wt %, or about 20 wt %. It will be appreciated then when relatively large amounts of additives are incorporated, such as higher than about 1 wt %, there will be a reduction in energy content calculated on the basis of the total reagent weight (inclusive of additives). Still, in various embodiments, the biogenic reagent with additive(s) can possess an energy content of about at least 11,000 Btu/lb, at least 12,000 Btu/lb, at least 13,000 Btu/lb, at least 14,000 Btu/lb, or at least 15,000 Btu/lb.

The above discussion regarding product form applies also to embodiments that incorporate additives. In fact, certain embodiments incorporate additives as binding agents, fluxing agents, or other modifiers to enhance final properties for a particular application.

In certain embodiments, the majority of carbon contained in the biogenic reagent is classified as renewable carbon. In some embodiments, substantially all of the carbon is classified as renewable carbon. There can be certain market mechanisms (e.g., Renewable Identification Numbers, tax credits, etc.) wherein value is attributed to the renewable carbon content within the biogenic reagent.

In certain embodiments, the fixed carbon can be classified as non-renewable carbon (e.g., from coal) while the volatile carbon, which can be added separately, can be renewable carbon to increase not only energy content but also renewable carbon value.

The biogenic reagents produced as described herein is useful for a wide variety of carbonaceous products. The biogenic reagent can be a desirable market product itself. Biogenic reagents as provided herein are associated with lower levels of impurities, reduced process emissions, and improved sustainability (including higher renewable carbon content) compared to the state of the art.

In variations, a product includes any of the biogenic reagents that can be obtained by the disclosed processes, or that are described in the compositions set forth herein, or any portions, combinations, or derivatives thereof.

Generally speaking, the biogenic reagents can be combusted to produce energy (including electricity and heat); partially oxidized, gasified, or steam-reformed to produce syngas; utilized for their adsorptive or absorptive properties; utilized for their reactive properties during metal refining (such as reduction of metal oxides) or other industrial processing; or utilized for their material properties in carbon steel and various other metal alloys. Essentially, the biogenic reagents can be utilized for any market application of carbon-based commodities or advanced materials, including specialty uses to be developed.

Prior to suitability or actual use in any product applications, the disclosed biogenic reagents can be analyzed, measured, and optionally modified (such as through additives) in various ways. Some properties of potential interest, other than chemical composition and energy content, include density, particle size, surface area, microporosity, absorptivity, adsorptivity, binding capacity, reactivity, desulfurization activity, and basicity, to name a few properties.

Products or materials that can incorporate these biogenic reagents include, but are by no means limited to, carbon-based blast furnace addition products, carbon-based taconite pellet addition products, ladle addition carbon-based products, met coke carbon-based products, coal replacement products, carbon-based coking products, carbon breeze products, fluidized-bed carbon-based feedstocks, carbon-based furnace addition products, injectable carbon-based products, pulverized carbon-based products, stoker carbon-based products, carbon electrodes, or activated carbon products.

Use of the disclosed biogenic reagents in metals production can reduce slag, increase overall efficiency, and reduce lifecycle environmental impacts. Therefore, embodiments of this invention are particularly well-suited for metal processing and manufacturing.

Some variations of the invention utilize the biogenic reagents as carbon-based blast furnace addition products. A blast furnace is a type of metallurgical furnace used for smelting to produce industrial metals, such as (but not limited to) iron. Smelting is a form of extractive metallurgy; its main use is to produce a metal from its ore. Smelting uses heat and a chemical reducing agent to decompose the ore. The carbon or the carbon monoxide derived from the carbon removes oxygen from the ore, leaving behind elemental metal.

The reducing agent can comprise or consist essentially of a biogenic reagent. In a blast furnace, biogenic reagent, ore, and typically limestone can be continuously supplied through the top of the furnace, while air (optionally with oxygen enrichment) is blown into the bottom of the chamber, so that the chemical reactions take place throughout the furnace as the material moves downward. The end products are usually molten metal and slag phases tapped from the bottom, and flue gases exiting from the top of the furnace. The downward flow of the ore in contact with an upflow of hot, carbon monoxide-rich gases is a countercurrent process.

Carbon quality in the blast furnace is measured by its resistance to degradation. The role of the carbon as a permeable medium is crucial in economic blast furnace operation. The degradation of the carbon varies with the position in the blast furnace and involves the combination of reaction with CO₂, H₂O, or O₂ and the abrasion of carbon particles against each other and other components of the burden. Degraded carbon particles can cause plugging and poor performance.

The Coke Reactivity test is a highly regarded measure of the performance of carbon in a blast furnace. This test has two components: the Coke Reactivity Index (CRI) and the Coke Strength after Reaction (CSR). A carbon-based material with a low CRI value (high reactivity) and a high CSR value is preferable for better blast furnace performance. CRI can be determined according to any suitable method known in the art, for example by ASTM Method DS341 on an as-received basis.

In some embodiments, the biogenic reagent provides a carbon product having suitable properties for introduction directly into a blast furnace.

The strength of the biogenic reagent can be determined by any suitable method known in the art, for example by a drop-shatter test, or a CSR test. In some embodiments, the biogenic reagent, optionally when blended with another source of carbon, provides a final carbon product having CSR of at least about 50%, 60%, or 70%. A combination product can also provide a final coke product having a suitable reactivity for combustion in a blast furnace. In some embodiments, the product has a CRI such that the biogenic reagent is suitable for use as an additive or replacement for met coal, met coke, coke breeze, foundry coke, or injectable coal.

Some embodiments employ one or more additives in an amount sufficient to provide a biogenic reagent that, when added to another carbon source (e.g., coke) having a CRI or CSR insufficient for use as a blast furnace product, provides a composite product with a CRI or CSR sufficient for use in a blast furnace. In some embodiments, one or more additives are present in an amount sufficient to provide a biogenic reagent having a CRI of not more than about 40%, 30%, or 20%.

In some embodiments, one or more additives selected from the alkaline earth metals, or oxides or carbonates thereof, are introduced during or after the process of producing a biogenic reagent. For example, calcium, calcium oxide, calcium carbonate, magnesium oxide, or magnesium carbonate can be introduced as additives. The addition of these compounds before, during, or after pyrolysis can increase the reactivity of the biogenic reagent in a blast furnace. These compounds can lead to stronger materials, i.e., higher CSR, thereby improving blast-furnace efficiency. In addition, additives such as those selected from the alkaline earth metals, or oxides or carbonates thereof, can lead to lower emissions (e.g., SO₂).

In some embodiments, a blast furnace replacement product is a biogenic reagent according to the present invention comprising at least about 55 wt % carbon, not more than about 0.5 wt % sulfur, not more than about 8 wt % non-combustible material, and a heat value of at least about 11,000 Btu per pound. In some embodiments, the blast furnace replacement product further comprises not more than about 0.035 wt % phosphorous, about 0.5 wt % to about 50 wt % volatile matter, and optionally one or more additives. In some embodiments, the blast furnace replacement product comprises about 2 wt % to about 15 wt % dolomite, about 2 wt % to about 15 wt % dolomitic lime, about 2 wt % to about 15 wt % bentonite, or about 2 wt % to about 15 wt % calcium oxide. In some embodiments, the blast furnace replacement product has dimensions substantially in the range of about 1 cm to about 10 cm.

In some embodiments, a biogenic reagent according to the present invention is useful as a foundry coke replacement product. Foundry coke is generally characterized as having a carbon content of at least about 85 wt %, a sulfur content of about 0.6 wt %, not more than about 1.5 wt % volatile matter, not more than about 13 wt % ash, not more than about 8 wt % moisture, about 0.035 wt % phosphorus, a CRI value of about 30, and dimensions ranging from about 5 cm to about 25 cm.

Some variations of the invention utilize the biogenic reagents as carbon-based taconite pellet addition products. The ores used in making iron and steel are iron oxides. Major iron oxide ores include hematite, limonite (also called brown ore), taconite, and magnetite, a black ore. Taconite is a low-grade but important ore, which contains both magnetite and hematite. The iron content of taconite is generally 25 wt % to 30 wt %. Blast furnaces typically require at least a 50 wt % iron content ore for efficient operation. Iron ores can undergo beneficiation including crushing, screening, tumbling, flotation, and magnetic separation. The refined ore is enriched to over 60% iron and is often formed into pellets before shipping.

For example, taconite can be ground into a fine powder and combined with a binder such as bentonite clay and limestone. Pellets about one centimeter in diameter can be formed, containing approximately 65 wt % iron, for example. The pellets are fired, oxidizing magnetite to hematite. The pellets are durable which ensures that the blast furnace charge remains porous enough to allow heated gas to pass through and react with the pelletized ore.

The taconite pellets can be fed to a blast furnace to produce iron, as described above with reference to blast furnace addition products. In some embodiments, a biogenic reagent is introduced to the blast furnace. In these or other embodiments, a biogenic reagent is incorporated into the taconite pellet itself. For example, taconite ore powder, after beneficiation, can be mixed with a biogenic reagent and a binder and rolled into small objects, then baked to hardness. In such embodiments, taconite-carbon pellets with the appropriate composition can conveniently be introduced into a blast furnace without the need for a separate source of carbon.

Some variations of the invention utilize the biogenic reagents as ladle addition carbon-based products. A ladle is a vessel used to transport and pour out molten metals. Casting ladles are used to pour molten metal into molds to produce the casting. Transfers ladle are used to transfer a large amount of molten metal from one process to another. Treatment ladles are used for a process to take place within the ladle to change some aspect of the molten metal, such as the conversion of cast iron to ductile iron by the addition of various elements into the ladle.

Biogenic reagents can be introduced to any type of ladle, but typically carbon will be added to treatment ladles in suitable amounts based on the target carbon content. Carbon injected into ladles can be in the form of fine powder, for good mass transport of the carbon into the final composition. In some embodiments, a biogenic reagent according to the present invention, when used as a ladle addition product, has a minimum dimension of about 0.5 cm, such as about 0.75 cm, about 1 cm, about 1.5 cm, or higher.

In some embodiments, a high carbon biogenic reagent according to the present invention is useful as a ladle addition carbon additive at, for example, basic oxygen furnace or electric arc furnace facilities wherever ladle addition of carbon would be used (e.g., added to ladle carbon during steel manufacturing).

In some embodiments, the ladle addition carbon additive additionally comprises up to about 5 wt % manganese, up to about 5 wt % calcium oxide, or up to about 5 wt % dolomitic lime.

Direct-reduced iron (DRI), also called sponge iron, is produced from direct reduction of iron ore (in the form of lumps, pellets, or fines) by a reducing gas conventionally produced from natural gas or coal. The reducing gas is typically syngas, a mixture of hydrogen and carbon monoxide which acts as reducing agent. The biogenic reagent as provided herein can be converted into a gas stream comprising CO, to act as a reducing agent to produce direct-reduced iron.

Iron nuggets are a high-quality steelmaking and iron-casting feed material. Iron nuggets are essentially all iron and carbon, with almost no gangue (slag) and low levels of metal residuals. They are a premium grade pig iron product with superior shipping and handling characteristics. The carbon contained in iron nuggets, or any portion thereof, can be the biogenic reagent provided herein. Iron nuggets can be produced through the reduction of iron ore in a rotary hearth furnace, using a biogenic reagent as the reductant and energy source.

Some variations of the invention utilize the biogenic reagents as metallurgical coke carbon-based products. Metallurgical coke, also known as “met” coke, is a carbon material normally manufactured by the destructive distillation of various blends of bituminous coal. The final solid is a non-melting carbon called metallurgical coke. As a result of the loss of volatile gases and of partial melting, met coke has an open, porous morphology. Met coke has a very low volatile content. However, the ash constituents, that were part of the original bituminous coal feedstock, remain encapsulated in the resultant coke. Met coke feedstocks are available in a wide range of sizes from fine powder to basketball-sized lumps. Typical purities range from 86-92 wt % fixed carbon.

Metallurgical coke is used where a high-quality, tough, resilient, wearing carbon is required. Applications include, but are not limited to, conductive flooring, friction materials (e.g., carbon linings), foundry coatings, foundry carbon raiser, corrosion materials, drilling applications, reducing agents, heat-treatment agents, ceramic packing media, electrolytic processes, and oxygen exclusion.

Met coke can be characterized as having a heat value of about 10,000 to 14,000 Btu per pound and an ash content of about 10 wt % or greater. Thus, in some embodiments, a met coke replacement product comprises a biogenic reagent according to the present invention comprising at least about 80 wt %, 85 wt %, or 90 wt % carbon, not more than about 0.8 wt % sulfur, not more than about 3 wt % volatile matter, not more than about 15 wt % ash, not more than about 13 wt % moisture, and not more than about 0.035 wt % phosphorus. A biogenic reagent according to the present invention, when used as a met coke replacement product, can have a size range from about 2 cm to about 15 cm, for example.

In some embodiments, the met coke replacement product further comprises an additive such as chromium, nickel, manganese, magnesium oxide, silicon, aluminum, dolomite, fluorospar, calcium oxide, lime, dolomitic lime, bentonite and combinations thereof.

Some variations of the invention utilize the biogenic reagents as coal replacement products. Any process or system using coal can in principle be adapted to use a biogenic reagent.

In some embodiments, a biogenic reagent is combined with one or more coal-based products to form a composite product having a higher rank than the coal-based product(s) or having fewer emissions, when burned, than the pure coal-based product.

For example, a low-rank coal such as sub-bituminous coal can be used in applications normally calling for a higher-rank coal product, such as bituminous coal, by combining a selected amount of a biogenic reagent according to the present invention with the low-rank coal product. In other embodiments, the rank of a mixed coal product (e.g., a combination of a plurality of coals of different rank) can be improved by combining the mixed coal with some amount of biogenic reagent. The amount of a biogenic reagent to be mixed with the coal product(s) can vary depending on the rank of the coal product(s), the characteristics of the biogenic reagent (e.g., carbon content, heat value, etc.) and the desired rank of the final combined product.

For example, anthracite coal is generally characterized as having at least about 80 wt % carbon, about 0.6 wt % sulfur, about 5 wt % volatile matter, up to about 15 wt % ash, up to about 10 wt % moisture, and a heat value of about 12,494 Btu/lb. In some embodiments, an anthracite coal replacement product is a biogenic reagent comprising at least about 80 wt % carbon, not more than about 0.6 wt % sulfur, not more than about 15 wt % ash, and a heat value of at least about 12,000 Btu/lb.

In some embodiments, a biogenic reagent is useful as a thermal coal replacement product. Thermal coal products are generally characterized as having high sulfur levels, high phosphorus levels, high ash content, and heat values of up to about 15,000 Btu/lb. In some embodiments, a thermal coal replacement product is a biogenic reagent comprising not more than about 0.5 wt % sulfur, not more than about 4 wt % ash, and a heat value of at least about 12,000 Btu/lb.

Some variations of the invention utilize the biogenic reagents as carbon-based coking products. Any coking process or system can be adapted to use biogenic reagents to produce coke, or use it as a coke feedstock.

In some embodiments, a biogenic reagent is useful as a thermal coal or coke replacement product. For example, a thermal coal or coke replacement product can consist essentially of a biogenic reagent comprising at least about 50 wt % carbon, not more than about 8 wt % ash, not more than about 0.5 wt % sulfur, and a heat value of at least about 11,000 Btu/lb. In other embodiments, the thermal coke replacement product further comprises about 0.5 wt % to about 50 wt % volatile matter. The thermal coal or coke replacement product can include about 0.4 wt % to about 15 wt % moisture.

In some embodiments, a biogenic reagent is useful as a petroleum (pet) coke or calcine pet coke replacement product. Calcine pet coke is generally characterized as having at least about 66 wt % carbon, up to 4.6 wt % sulfur, up to about 5.5 wt % volatile matter, up to about 19.5 wt % ash, and up to about 2 wt % moisture, and is typically sized at about 3 mesh or less. In some embodiments, the calcine pet coke replacement product is a biogenic reagent comprising at least about 66 wt % carbon, not more than about 4.6 wt % sulfur, not more than about 19.5 wt % ash, not more than about 2 wt % moisture, and is sized at about 3 mesh or less.

In some embodiments, a biogenic reagent is useful as a coking carbon replacement carbon (e.g., co-fired with metallurgical coal in a coking furnace). In one embodiment, a coking carbon replacement product is a biogenic reagent comprising at least about 55 wt % carbon, not more than about 0.5 wt % sulfur, not more than about 8 wt % non-combustible material, and a heat value of at least about 11,000 Btu per pound. In some embodiments, the coking carbon replacement product comprises about 0.5 wt % to about 50 wt % volatile matter, or one or more additives.

Some variations of the invention utilize the biogenic reagents as carbon breeze products, which typically have very fine particle sizes such as 6 mm, 3 mm, 2 mm, 1 mm, or smaller. In some embodiments, a biogenic reagent according to the present invention is useful as a coke breeze replacement product. Coke breeze is generally characterized as having a maximum dimension of not more than about 6 mm, a carbon content of at least about 80 wt %, 0.6 to 0.8 wt % sulfur, 1% to 20 wt % volatile matter, up to about 13 wt % ash, and up to about 13 wt % moisture. In some embodiments, a coke breeze replacement product is a biogenic reagent according to the present invention comprising at least about 80 wt % carbon, not more than about 0.8 wt % sulfur, not more than about 20 wt % volatile matter, not more than about 13 wt % ash, not more than about 13 wt % moisture, and a maximum dimension of about 6 mm.

In some embodiments, a biogenic reagent is useful as a carbon breeze replacement product during, for example, taconite pellet production or in an iron-making process.

Some variations utilize the biogenic reagents as feedstocks for various fluidized beds, or as fluidized-bed carbon-based feedstock replacement products. The carbon can be employed in fluidized beds for total combustion, partial oxidation, gasification, steam reforming, or the like. The carbon can be primarily converted into syngas for various downstream uses, including production of energy (e.g., combined heat and power), or liquid fuels (e.g., methanol or Fischer-Tropsch diesel fuels).

In some embodiments, a biogenic reagent according to the present invention is useful as a fluidized-bed coal replacement product in, for example, fluidized bed furnaces wherever coal would be used (e.g., for process heat or energy production).

Some variations utilize the biogenic reagents as carbon-based furnace addition products. Coal-based carbon furnace addition products are generally characterized as having high sulfur levels, high phosphorus levels, and high ash content, which contribute to degradation of the metal product and create air pollution. In some embodiments, a carbon furnace addition replacement product comprising a biogenic reagent comprises not more than about 0.5 wt % sulfur, not more than about 4 wt % ash, not more than about 0.03 wt % phosphorous, and a maximum dimension of about 7.5 cm. In some embodiments, the carbon furnace addition replacement product replacement product comprises about 0.5 wt % to about 50 wt % volatile matter and about 0.4 wt % to about 15 wt % moisture.

In some embodiments, a biogenic reagent is useful as a furnace addition carbon additive at, for example, basic oxygen furnace or electric arc furnace facilities wherever furnace addition carbon would be used. For example, furnace addition carbon can be added to scrap steel during steel manufacturing at electric-arc furnace facilities. For electric-arc furnace applications, high-purity carbon is desired so that impurities are not introduced back into the process following earlier removal of impurities.

In some embodiments, a furnace addition carbon additive is a biogenic reagent comprising at least about 80 wt % carbon, not more than about 0.5 wt % sulfur, not more than about 8 wt % non-combustible material, and a heat value of at least about 11,000 Btu per pound. In some embodiments, the furnace addition carbon additive further comprises up to about 5 wt % manganese, up to about 5 wt % fluorospar, about 5 wt % to about 10 wt % dolomite, about 5 wt % to about 10 wt % dolomitic lime, or about 5 wt % to about 10 wt % calcium oxide.

Some variations utilize the biogenic reagents as stoker furnace carbon-based products. In some embodiments, a biogenic reagent according to the present invention is useful as a stoker coal replacement product at, for example, stoker furnace facilities wherever coal would be used (e.g., for process heat or energy production).

Some variations utilize the biogenic reagents as injectable (e.g., pulverized) carbon-based materials. In some embodiments, a biogenic reagent is useful as an injection-grade calcine pet coke replacement product. Injection-grade calcine pet coke is generally characterized as having at least about 66 wt % carbon, about 0.55 to about 3 wt % sulfur, up to about 5.5 wt % volatile matter, up to about 10 wt % ash, up to about 2 wt % moisture, and is sized at about 6 mesh or less. In some embodiments, a calcine pet coke replacement product is a biogenic reagent comprising at least about 66 wt % carbon, not more than about 3 wt % sulfur, not more than about 10 wt % ash, not more than about 2 wt % moisture, and is sized at about 6 mesh or less.

In some embodiments, a biogenic reagent is useful as an injectable carbon replacement product at, for example, basic oxygen furnace or electric arc furnace facilities in any application where injectable carbon would be used (e.g., injected into slag or ladle during steel manufacturing).

In some embodiments, a biogenic reagent is useful as a pulverized carbon replacement product, for example, wherever pulverized coal would be used (e.g., for process heat or energy production). In some embodiments, the pulverized coal replacement product comprises up to about 10 percent calcium oxide.

Some variations utilize the biogenic reagents as carbon addition product for metals production. In some embodiments, a biogenic reagent according to the present invention is useful as a carbon addition product for production of carbon steel or another metal alloy comprising carbon. Coal-based late-stage carbon addition products are generally characterized as having high sulfur levels, high phosphorous levels, and high ash content, and high mercury levels which degrade metal quality and contribute to air pollution. In some embodiments of this invention, the carbon addition product comprises not more than about 0.5 wt % sulfur, not more than about 4 wt % ash, not more than about 0.03 wt % phosphorus, a minimum dimension of about 1 to 5 mm, and a maximum dimension of about 8 to 12 mm.

Some variations utilize the biogenic reagents within carbon electrodes. In some embodiments, a biogenic reagent is useful as an electrode (e.g., anode) material suitable for use, for example, in aluminum production.

Other uses of the biogenic reagent in carbon electrodes include applications in batteries, fuel cells, capacitors, and other energy-storage or energy-delivery devices. For example, in a lithium-ion battery, the biogenic reagent can be used on the anode side to intercalate lithium. In these applications, carbon purity and low ash can be very important.

Some variations of the invention utilize the biogenic reagents as catalyst supports. Carbon is a known catalyst support in a wide range of catalyzed chemical reactions, such as mixed-alcohol synthesis from syngas using sulfided cobalt-molybdenum metal catalysts supported on a carbon phase, or iron-based catalysts supported on carbon for Fischer-Tropsch synthesis of higher hydrocarbons from syngas.

Some variations utilize the biogenic reagents as activated carbon products. Activated carbon is used in a wide variety of liquid and gas-phase applications, including water treatment, air purification, solvent vapor recovery, food and beverage processing, and pharmaceuticals. For activated carbon, the porosity and surface area of the material are generally important. The biogenic reagent provided herein can provide a superior activated carbon product, in various embodiments, due to (i) greater surface area than fossil-fuel based activated carbon; (ii) carbon renewability; (iii) vascular nature of biomass feedstock in conjunction with additives better allows penetration/distribution of additives that enhance pollutant control; and (iv) less inert material (ash) leads to greater reactivity.

It should be recognized that in the above description of market applications of biogenic reagents, the described applications are not exclusive, nor are they exhaustive. Thus a biogenic reagent that is described as being suitable for one type of carbon product can be suitable for any other application described, in various embodiments. These applications are exemplary only, and there are other applications of biogenic reagents.

In addition, in some embodiments, the same physical material can be used in multiple market processes, either in an integrated way or in sequence. Thus, for example, a biogenic reagent that is used as a carbon electrode or an activated carbon can, at the end of its useful life as a performance material, then be introduced to a combustion process for energy value or to a metal-making (e.g., metal ore reduction) process, etc.

Some embodiments can employ a biogenic reagent both for its reactive/adsorptive properties and also as a fuel. For example, a biogenic reagent injected into an emissions stream can be suitable to remove contaminants, followed by combustion of the biogenic reagent particles and possibly the contaminants, to produce energy and thermally destroy or chemically oxidize the contaminants.

Significant environmental and product use advantages can be associated with biogenic reagents, compared to conventional fossil-fuel-based products. The biogenic reagents can be not only environmentally superior, but also functionally superior from a processing standpoint because of greater purity, for example.

With regard to some embodiments of metals production, production of biogenic reagents with disclosed processes can result in significantly lower emissions of CO, CO₂, NOR, SO₂, and hazardous air pollutants compared to the coking of coal-based products necessary to prepare them for use in metals production.

Use of biogenic reagents in place of coal or coke also significantly reduces environmental emissions of SO₂, hazardous air pollutants, and mercury.

Also, because of the purity of these biogenic reagents (including low ash content), the disclosed biogenic reagents have the potential to reduce slag and increase production capacity in batch metal-making processes.

In some embodiments, a biogenic reagent functions as an activated carbon. For example, the low-fixed-carbon material can be activated, the high-fixed-carbon material can be activated, or both materials can be activated such that the biocarbon composition (blend) functions as an activated carbon.

In certain embodiments, a portion of the biogenic reagent is recovered as an activated carbon product, while another portion (e.g., the remainder) of the biogenic reagent is pelletized with a binder to produce biocarbon pellets. In other embodiments, the biogenic reagent is pelletized with a binder to produce biocarbon pellets that are shipped for later conversion to an activated carbon product. The later conversion can include pulverizing back to a powder, and can also include chemical treatment with, e.g., steam, acids, or bases. In these embodiments, the biocarbon pellets can be regarded as activated-carbon precursor pellets.

In certain embodiments, the fixed carbon within the biogenic reagent can be primarily used to make activated carbon while the volatile carbon within the biogenic reagent can be primarily used to make reducing gas. For example, at least 50 wt %, at least 90 wt %, or essentially all of the fixed carbon within the biogenic reagent generated in step (b) can be recovered as activated carbon in step (f), while, for example, at least 50 wt %, at least 90 wt %, or essentially all of the volatile carbon within the biogenic reagent generated in step (b) can be directed to the reducing gas (e.g., via steam-reforming reactions of volatile carbon to CO).

The activated carbon, when produced, can be characterized by an Iodine Number of at least about 500, 750, 800, 1000, 1500, or 2000, for example. The activated carbon is preferably characterized by a renewable carbon content of at least 50%, 60%, 70%, 80%, 90%, or 95% as determined from a measurement of the ¹⁴C/¹²C isotopic ratio of the activated carbon. In some embodiments, the activated carbon is characterized as (fully) renewable activated carbon as determined from a measurement of the ¹⁴C/¹²C isotopic ratio of the activated carbon.

In some embodiments, the pyrolysis reactor is configured for optimizing the production of different types of activated carbon. For example, reaction conditions (e.g., time, temperature, and steam concentration) can be selected for an activated carbon product with certain attributes such as Iodine Number. Different reaction conditions can be selected for a different activated carbon product, such as one with a higher Iodine Number. The pyrolysis reactor can be operated in a campaign mode to produce one product and then switched to another mode for another product. The first product can have been continuously or periodically removed during the first campaign, or can be removed prior to switching the reaction conditions of the pyrolysis reactor.

The activated carbon can be characterized by an Iodine Number of at least about 500, 750, 1000, 1500, or 2000, for example. The activated carbon can be characterized by a renewable carbon content of at least 90% as determined from a measurement of the ¹⁴C/¹²C isotopic ratio of the activated carbon. In some embodiments, the activated carbon is characterized as (fully) renewable activated carbon as determined from a measurement of the ¹⁴C/¹²C isotopic ratio of the activated carbon.

Activated carbon produced by the processes disclosed herein can be used in a number of ways.

In some embodiments, the activated carbon is utilized internally at the process site to purify the one or more primary products. In some embodiments, the activated carbon is utilized at the site to purify water. In these or other embodiments, the activated carbon is utilized at the site to treat a liquid waste stream to reduce liquid-phase emissions or to treat a vapor waste stream to reduce air emissions. In some embodiments, the activated carbon is utilized as a soil amendment to assist generation of new biomass, which can be the same type of biomass utilized as local feedstock at the site.

Activated carbon prepared according to the processes disclosed herein can have the same or better characteristics as traditional fossil fuel-based activated carbon. In some embodiments, the activated carbon has a surface area that is comparable to, equal to, or greater than surface area associated with fossil fuel-based activated carbon. In some embodiments, the activated carbon can control pollutants as well as or better than traditional activated carbon products. In some embodiments, the activated carbon has an inert material (e.g., ash) level that is comparable to, equal to, or less than an inert material (e.g., ash) level associated with a traditional activated carbon product. In some embodiments, the activated carbon has a particle size or a particle size distribution that is comparable to, equal to, greater than, or less than a particle size or a particle size distribution associated with a traditional activated carbon product. In some embodiments, the activated carbon has a particle shape that is comparable to, substantially similar to, or the same as a particle shape associated with a traditional activated carbon product. In some embodiments, the activated carbon has a particle shape that is substantially different than a particle shape associated with a traditional activated carbon product. In some embodiments, the activated carbon has a pore volume that is comparable to, equal to, or greater than a pore volume associated with a traditional activated carbon product. In some embodiments, the activated carbon has pore dimensions that are comparable to, substantially similar to, or the same as pore dimensions associated with a traditional activated carbon product. In some embodiments, the activated carbon has an attrition resistance of particles value that is comparable to, substantially similar to, or the same as an attrition resistance of particles value associated with a traditional activated carbon product. In some embodiments, the activated carbon has a hardness value that is comparable to, substantially similar to, or the same as a hardness value associated with a traditional activated carbon product. In some embodiments, the activated carbon has a bulk density value that is comparable to, substantially similar to, or the same as a bulk density value associated with a traditional activated carbon product. In some embodiments, the activated carbon product has an adsorptive capacity that is comparable to, substantially similar to, or the same as an adsorptive capacity associated with a traditional activated carbon product.

Prior to suitability or actual use in any product applications, the disclosed activated carbons can be analyzed, measured, and optionally modified (such as through additives) in various ways. Some properties of potential interest include density, particle size, surface area, microporosity, absorptivity, adsorptivity, binding capacity, reactivity, desulfurization activity, basicity, hardness, and Iodine Number.

Activated carbon is used commercially in a wide variety of liquid and gas-phase applications, including water treatment, air purification, solvent vapor recovery, food and beverage processing, sugar and sweetener refining, automotive uses, and pharmaceuticals. For activated carbon, key product attributes can include particle size, shape, composition, surface area, pore volume, pore dimensions, particle-size distribution, the chemical nature of the carbon surface and interior, attrition resistance of particles, hardness, bulk density, and adsorptive capacity.

The bulk density for the biogenic activated carbon, or for the biocoke, can be from about 50 g/liter to about 650 g/liter, for example.

The surface area of the biogenic activated carbon or the biocoke can vary widely. Exemplary surface areas (e.g., BET surface areas) range from about 400 m²/g to about 2000 m²/g or higher, such as about 500 m²/g, 600 m²/g, 800 m²/g, 1000 m²/g, 1200 m²/g, 1400 m²/g, 1600 m²/g, or 1800 m²/g. Surface area generally correlates to adsorption capacity.

The pore-size distribution can be important to determine ultimate performance of the activated carbon or the biocoke. Pore-size measurements can include micropore content, mesopore content, and macropore content.

The Iodine Number is a parameter used to characterize activated carbon performance. The Iodine Number measures the degree of activation of the carbon, and is a measure of micropore (e.g., 0-20 Å) content. It is an important measurement for liquid-phase applications. Exemplary Iodine Numbers for activated carbon products produced by embodiments of the disclosure include about 500, 600, 750, 900, 1000, 1100, 1200, 1300, 1500, 1600, 1750, 1900, 2000, 2100, and 2200, including all intervening ranges. The units of Iodine Number are milligram iodine per gram carbon.

Another pore-related measurement is Methylene Blue Number, which measures mesopore content (e.g., 20-500 Å). Exemplary Methylene Blue Numbers for activated carbon products or biocoke produced by embodiments of the disclosure include about 100, 150, 200, 250, 300, 350, 400, 450, and 500, including all intervening ranges. The units of Methylene Blue Number are milligram methylene blue (methylthioninium chloride) per gram carbon.

Another pore-related measurement is Molasses Number, which measures macropore content (e.g., >500 Å). Exemplary Molasses Numbers for activated carbon products or biocoke produced by embodiments of the disclosure include about 100, 150, 200, 250, 300, 350, and 400, including all intervening ranges. The units of Molasses Number are milligram molasses per gram carbon.

In some embodiments, the activated carbon or the biocoke is characterized by a mesopore volume of at least about 0.5 cm³/g, such as at least about 1 cm³/g, for example.

The activated carbon or the biocoke can be characterized by its water-holding capacity. In various embodiments, activated carbon products produced by embodiments of the disclosure have a water-holding capacity at 25° C. of about 10% to about 300% (water weight divided by weight of dry activated carbon), such as from about 50% to about 100%, e.g., about 60-80%.

Hardness or Abrasion Number is measure of activated carbon's resistance to attrition. It is an indicator of activated carbon's or biocoke's physical integrity to withstand frictional forces and mechanical stresses during handling or use. Some amount of hardness is desirable, but if the hardness is too high, excessive equipment wear can result. Exemplary Abrasion Numbers, measured according to ASTM D3802, range from about 1% to great than about 99%, such as about 1%, about 5%, about 10%, about 15%, about 20%, about 25%, about 30%, about 35%, about 40%, about 45%, about 50%, about 55%, 60%, about 65%, about 70%, about 75%, about 80%, about 85%, about 90%, about 95%, about 96%, about 97%, about 98%, about 99%, or greater than about 99%.

In some embodiments, an optimal range of hardness can be achieved in which the activated carbon or the biocoke is reasonably resistant to attrition but does not cause abrasion and wear in capital facilities that process the activated carbon. This optimum is made possible in some embodiments of this disclosure due to the selection of feedstock as well as processing conditions. In some embodiments in which the downstream use can handle high hardness, a process of this disclosure can be operated to increase or maximize hardness to produce biogenic activated carbon or biocoke products having an Abrasion Number of about 75%, about 80%, about 85%, about 90%, about 95%, about 96%, about 97%, about 98%, about 99%, or greater than about 99%.

The biogenic activated carbon provided by the present disclosure has a wide range of commercial uses. For example, without limitation, the biogenic activated carbon can be utilized in emissions control, water purification, groundwater treatment, wastewater treatment, air stripper applications, PCB removal applications, odor removal applications, soil vapor extractions, manufactured gas plants, industrial water filtration, industrial fumigation, tank and process vents, pumps, blowers, filters, pre-filters, mist filters, ductwork, piping modules, adsorbers, absorbers, and columns.

In one embodiment, a method of using activated carbon to reduce emissions comprises:
(a) providing activated carbon particles comprising a biogenic activated carbon composition recovered from the second reactor disclosed herein;
(b) providing a gas-phase emissions stream comprising at least one selected contaminant;
(c) providing an additive selected to assist in removal of the selected contaminant from the gas-phase emissions stream;
(d) introducing the activated carbon particles and the additive into the gas-phase emissions stream, to adsorb at least a portion of the selected contaminant onto the activated carbon particles, thereby generating contaminant-adsorbed carbon particles within the gas-phase emissions stream; and
(e) separating at least a portion of the contaminant-adsorbed carbon particles from the gas-phase emissions stream, to produce a contaminant-reduced gas-phase emissions stream.

An additive for the biogenic activated carbon composition can be provided as part of the activated carbon particles. Alternatively, or additionally, an additive can be introduced directly into the gas-phase emissions stream, into a fuel bed, or into a combustion zone. Other ways of directly or indirectly introducing the additive into the gas-phase emissions stream for removal of the selected contaminant are possible, as will be appreciated by one of skill in the art.

A selected contaminant (in the gas-phase emissions stream) can be a metal, such as a metal selected from mercury, boron, selenium, arsenic, or any compound, salt, or mixture thereof. A selected contaminant can be a hazardous air pollutant, an organic compound (such as a VOC), or a non-condensable gas, for example. In some embodiments, a biogenic activated carbon product adsorbs, absorbs or chemisorbs a selected contaminant in greater amounts than a comparable amount of a non-biogenic activated carbon product. In some such embodiments, the selected contaminant is a metal, a hazardous air pollutant, an organic compound (such as a VOC), a non-condensable gas, or any combination thereof. In some embodiments, the selected contaminant comprises mercury. In some embodiments, the selected contaminant comprises one or more VOCs. In some embodiments, the biogenic activated carbon comprises at least about 1 wt % hydrogen or at least about 10 wt % oxygen.

Hazardous air pollutants are those pollutants that cause or can cause cancer or other serious health effects, such as reproductive effects or birth defects, or adverse environmental and ecological effects. Section 112 of the Clean Air Act, as amended, is incorporated by reference herein in its entirety. Pursuant to the Section 112 of the Clean Air Act, the United States Environmental Protection Agency (EPA) is mandated to control 189 hazardous air pollutants. Any current or future compounds classified as hazardous air pollutants by the EPA are included in possible selected contaminants in the present context.

Volatile organic compounds, some of which are also hazardous air pollutants, are organic chemicals that have a high vapor pressure at ordinary, room-temperature conditions. Examples include short-chain alkanes, olefins, alcohols, ketones, and aldehydes. Many volatile organic compounds are dangerous to human health or cause harm to the environment. EPA regulates volatile organic compounds in air, water, and land. EPA's definition of volatile organic compounds is described in 40 CFR Section 51.100, which is incorporated by reference herein in its entirety.

Non-condensable gases are gases that do not condense under ordinary, room-temperature conditions. Non-condensable gas can include, but are not limited to, nitrogen oxides, carbon monoxide, carbon dioxide, hydrogen sulfide, sulfur dioxide, sulfur trioxide, methane, ethane, ethylene, ozone, ammonia, or combinations thereof.

Multiple contaminants can be removed by the disclosed activated carbon particles. In some embodiments, the contaminant-adsorbed carbon particles include at least two contaminants, at least three contaminants, or more. The activated carbon as disclosed herein can allow multi-pollutant control as well as control of certain targeted pollutants (e.g., selenium).

In some embodiments, contaminant-adsorbed carbon particles are treated to regenerate activated carbon particles. In some embodiments, the method includes thermally oxidizing the contaminant-adsorbed carbon particles. The contaminant-adsorbed carbon particles, or a regenerated form thereof, can be combusted to provide energy.

In some embodiments, an additive for activated carbon is selected from an acid, a base, a salt, a metal, a metal oxide, a metal hydroxide, a metal halide, or a combination thereof. In certain embodiments, the additive is selected from magnesium, manganese, aluminum, nickel, iron, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, sodium hydroxide, potassium hydroxide, hydrogen bromide, hydrogen chloride, sodium silicate, potassium permanganate, organic acids (e.g., citric acid), or a combination thereof.

In some embodiments, the gas-phase emissions stream is derived from metals processing, such as the processing of high-sulfur-content metal ores.

As an exemplary embodiment relating to mercury control, activated carbon can be injected (such as into the ductwork) upstream of a particulate matter control device, such as an electrostatic precipitator or fabric filter. In some cases, a flue gas desulfurization (dry or wet) system can be downstream of the activated carbon injection point. The activated carbon can be pneumatically injected as a powder. The injection location will typically be determined by the existing plant configuration (unless it is a new site) and whether additional downstream particulate matter control equipment is modified.

For boilers currently equipped with particulate matter control devices, implementing biogenic activated carbon injection for mercury control could entail: (i) injection of powdered activated carbon upstream of the existing particulate matter control device (electrostatic precipitator or fabric filter); (ii) injection of powdered activated carbon downstream of an existing electrostatic precipitator and upstream of a retrofit fabric filter; or (iii) injection of powdered activated carbon between electrostatic precipitator electric fields. Inclusion of iron or iron-containing compounds can drastically improve the performance of electrostatic precipitators for mercury control. Furthermore, inclusion of iron or iron-containing compounds can drastically change end-of-life options, since the spent activated carbon solids can be separated from other ash.

In some embodiments, powdered activated carbon injection approaches can be employed in combination with existing SO₂ control devices. Activated carbon could be injected prior to the SO₂ control device or after the SO₂ control device, subject to the availability of a means to collect the activated carbon sorbent downstream of the injection point.

In some embodiments, the same physical material can be used in multiple processes, either in an integrated way or in sequence. Thus, for example, activated carbon can, at the end of its useful life as a performance material, then be introduced to a combustion process for energy value or to a metal-making process that requires carbon but does not require the properties of activated carbon, etc.

The biogenic activated carbon and the principles of the disclosure can be applied to liquid-phase applications, including processing of water, aqueous streams of varying purities, solvents, liquid fuels, polymers, molten salts, and molten metals, for example. As intended herein, “liquid phase” includes slurries, suspensions, emulsions, multiphase systems, or any other material that has (or can be adjusted to have) at least some amount of a liquid state present.

In one embodiment, the present disclosure provides a method of using activated carbon to purify a liquid, in some variations, includes the following steps:
(a) providing activated carbon particles recovered from the second reactor;
(b) providing a liquid comprising at least one selected contaminant;
(c) providing an additive selected to assist in removal of the selected contaminant from the liquid; and
(d) contacting the liquid with the activated carbon particles and the additive, to adsorb at least a portion of the at least one selected contaminant onto the activated carbon particles, thereby generating contaminant-adsorbed carbon particles and a contaminant-reduced liquid.

The additive can be provided as part of the activated carbon particles. Or, the additive can be introduced directly into the liquid. In some embodiments, additives—which can be the same, or different—are introduced both as part of the activated carbon particles as well as directly into the liquid.

In some embodiments relating to liquid-phase applications, an additive is selected from an acid, a base, a salt, a metal, a metal oxide, a metal hydroxide, a metal halide, or a combination thereof. For example, an additive can be selected from magnesium, manganese, aluminum, nickel, iron, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, sodium hydroxide, potassium hydroxide, hydrogen bromide, hydrogen chloride, sodium silicate, potassium permanganate, organic acids (e.g., citric acid), or a combination thereof.

In some embodiments, the selected contaminant (in the liquid to be treated) is a metal, such as a metal selected from arsenic, boron, selenium, mercury, or any compound, salt, or mixture thereof. In some embodiments, the selected contaminant is an organic compound (such as a VOC), a halogen, a biological compound, a pesticide, or a herbicide. The contaminant-adsorbed carbon particles can include two, three, or more contaminants. In some embodiments, an activated carbon product adsorbs, absorbs or chemisorbs a selected contaminant in greater amounts than a comparable amount of a non-biogenic activated carbon product. In some such embodiments, the selected contaminant is a metal, a hazardous air pollutant, an organic compound (such as a VOC), a non-condensable gas, or any combination thereof. In some embodiments, the selected contaminant comprises mercury. In some embodiments, the selected contaminant comprises one or more VOCs. In some embodiments, the biogenic activated carbon comprises at least about 1 wt % hydrogen or at least about 10 wt % oxygen.

The liquid to be treated will typically be aqueous, although that is not necessary for the principles of this disclosure. In some embodiments, a liquid is treated with activated carbon particles in a fixed bed. In other embodiments, a liquid is treated with activated carbon particles in solution or in a moving bed.

In one embodiment, the present disclosure provides a method of using a biogenic activated carbon composition to remove at least a portion of a sulfur-containing contaminant from a liquid, the method comprising:
(a) providing activated-carbon particles recovered from the second reactor disclosed herein;
(b) providing a liquid containing a sulfur-containing contaminant;
(c) providing an additive selected to assist in removal of the sulfur-containing contaminant from the liquid; and
(d) contacting the liquid with the activated-carbon particles and the additive, to adsorb or absorb at least a portion of the sulfur-containing contaminant onto or into the activated-carbon particles.

In some embodiments, the sulfur-containing contaminant is selected from elemental sulfur, sulfuric acid, sulfurous acid, sulfur dioxide, sulfur trioxide, sulfate anions, bisulfate anions, sulfite anions, bisulfite anions, thiols, sulfides, disulfides, polysulfides, thioethers, thioesters, thioacetals, sulfoxides, sulfones, thiosulfinates, sulfimides, sulfoximides, sulfonediimines, sulfur halides, thioketones, thioaldehydes, sulfur oxides, thiocarboxylic acids, thioamides, sulfonic acids, sulfinic acids, sulfenic acids, sulfonium, oxosulfonium, sulfuranes, persulfuranes, or a combination, salt, or derivative thereof. For example, the sulfur-containing contaminant can be a sulfate, in anionic or salt form.

The liquid can be an aqueous liquid, such as water. In some embodiments, the water is wastewater associated with a process selected from metal mining, acid mine drainage, mineral processing, municipal sewer treatment, pulp and paper, ethanol, or any other industrial process that is capable of discharging sulfur-containing contaminants in wastewater. The water can also be (or be part of) a natural body of water, such as a lake, river, or stream.

In one embodiment, the present disclosure provides a process to reduce the concentration of sulfates in water, the process comprising:
(a) providing activated-carbon particles recovered from the second reactor disclosed herein;
(b) providing a volume or stream of water containing sulfates;
(c) providing an additive selected to assist in removal of the sulfates from the water; and
(d) contacting the water with the activated-carbon particles and the additive, to adsorb or absorb at least a portion of the sulfates onto or into the activated-carbon particles.

In some embodiments, the sulfates are reduced to a concentration of about 50 mg/L or less in the water, such as a concentration of about 10 mg/L or less in the water. In some embodiments, the sulfate is present primarily in the form of sulfate anions or bisulfate anions. Depending on pH, the sulfate can also be present in the form of sulfate salts.

The water can be derived from, part of, or the entirety of a wastewater stream. Exemplary wastewater streams are those that can be associated with a metal mining, acid mine drainage, mineral processing, municipal sewer treatment, pulp and paper, ethanol, or any other industrial process that could discharge sulfur-containing contaminants to wastewater. The water can be a natural body of water, such as a lake, river, or stream. In some embodiments, the process is conducted continuously. In other embodiments, the process is conducted in batch.

When water is treated with activated carbon, there can be filtration of the water, osmosis of the water, or direct addition (with sedimentation, clarification, etc.) of the activated-carbon particles to the water. When osmosis is employed, the activated carbon can be used in several ways within, or to assist, an osmosis device. In some embodiments, the activated-carbon particles and the additive are directly introduced to the water prior to osmosis. The activated-carbon particles and the additive are optionally employed in pre-filtration prior to the osmosis. In certain embodiments, the activated-carbon particles and the additive are incorporated into a membrane for osmosis.

In some embodiments, an activated carbon is effective for removing a sulfur-containing contaminant selected from elemental sulfur, sulfuric acid, sulfurous acid, sulfur dioxide, sulfur trioxide, sulfate anions, bisulfate anions, sulfite anions, bisulfite anions, thiols, sulfides, disulfides, polysulfides, thioethers, thioesters, thioacetals, sulfoxides, sulfones, thiosulfinates, sulfimides, sulfoximides, sulfonediimines, sulfur halides, thioketones, thioaldehydes, sulfur oxides, thiocarboxylic acids, thioamides, sulfonic acids, sulfinic acids, sulfenic acids, sulfonium, oxosulfonium, sulfuranes, persulfuranes, or a combination, salt, or derivative thereof.

Generally speaking, the disclosed activated carbon can be used in any application in which traditional activated carbon might be used. In some embodiments, the activated carbon is used as a total (i.e., 100%) replacement for traditional activated carbon. In some embodiments, the activated carbon comprises essentially all or substantially all of the activated carbon used for a particular application. In some embodiments, the activated carbon comprises about 1% to about 100% of biogenic activated carbon.

For example and without limitation, the activated carbon can be used—alone or in combination with a traditional activated carbon product—in filters. In some embodiments, a packed bed or packed column comprises the disclosed activated carbon. In such embodiments, the biogenic activated carbon has a size characteristic suitable for the particular packed bed or packed column. Injection of biogenic activated carbon into gas streams can be useful for control of contaminant emissions in gas streams or liquid streams derived from coal-fired power plants, biomass-fired power plants, metal processing plants, crude-oil refineries, chemical plants, polymer plants, pulp and paper plants, cement plants, waste incinerators, food processing plants, gasification plants, and syngas plants.

### Use of Biocoke in Metal Oxide Reduction

There are various embodiments in which biocoke-containing pellets, or a pulverized form thereof, or other biocoke compositions disclosed herein, are fed to a metal ore furnace or a chemical-reduction furnace.

A metal ore furnace or a chemical-reduction furnace can be a blast furnace, a top-gas recycling blast furnace, a shaft furnace, a reverberatory furnace (also known as an air furnace), a crucible furnace, a muffling furnace, a retort furnace, a flash furnace, a Tecnored furnace, an Ausmelt furnace, an ISASMELT furnace, a puddling furnace, a Bogie hearth furnace, a continuous chain furnace, a pusher furnace, a rotary hearth furnace, a walking beam furnace, an electric arc furnace, an induction furnace, a basic oxygen furnace, a puddling furnace, a Bessemer furnace, a direct-reduced-metal furnace, or a combination or derivative thereof.

A metal ore furnace or a chemical-reduction furnace can be arranged horizontally, vertically, or inclined. The flow of solids and fluids (liquids or gases) can be cocurrent or countercurrent. The solids within a furnace can be in a fixed bed or a fluidized bed. A metal ore furnace or a chemical-reduction furnace can be operated at a variety of process conditions of temperature, pressure, and residence time.

Some variations of the invention relate specifically to a blast furnace. A blast furnace is a type of metallurgical furnace used for smelting to produce industrial metals, such as iron or copper. Blast furnaces are utilized in smelting iron ore to produce pig iron, an intermediate material used in the production of commercial iron and steel. Blast furnaces are also used in combination with sinter plants in base metals smelting, for example.

As used herein, “blast” refers to the combustion air being forced or supplied above atmospheric pressure. In a blast furnace, metal ores, carbon (in the present disclosure, biogenic reagent or a derivative thereof), and usually flux (e.g., limestone) are continuously supplied through the top of the furnace, while a hot blast of air (optionally with oxygen enrichment) is blown into the lower section of the furnace through a series of pipes called tuyeres. The chemical reduction reactions take place throughout the furnace as the material falls downward. The end products are usually molten metal and slag phases tapped from the bottom, and waste gases (reduction off-gas) exiting from the top of the furnace. The downward flow of the metal ore along with the flux in countercurrent contact with an upflow of hot, CO-rich gases allows for an efficient chemical reaction to reduce the metal ore to metal.

Air furnaces (such as reverberatory furnaces) are naturally aspirated, usually by the convection of hot gases in a chimney flue. According to this broad definition, bloomeries for iron, blowing houses for tin, and smelt mills for lead would be classified as blast furnaces.

The blast furnace remains an important part of modern iron production. Modern furnaces are highly efficient, including Cowper stoves which preheat incoming blast air with waste heat from flue gas, and recovery systems to extract the heat from the hot gases exiting the furnace. A blast furnace is typically built in the form of a tall structure, lined with refractory brick, and profiled to allow for expansion of the feed materials as they heat during their descent, and subsequent reduction in size as melting starts to occur.

In some embodiments pertaining to iron production, biocarbon pellets, iron ore (iron oxide), and limestone flux are charged into the top of the blast furnace. The iron ore or limestone flux can be integrated within the biocarbon pellets. Optionally, the biocarbon pellets are size-reduced before feeding to the blast furnace. For example, the biocarbon pellets can be pulverized to a powder which is fed to the blast furnace.

The blast furnace can be configured to allow the hot, dirty gas high in carbon monoxide content to exit the furnace throat, while bleeder valves can protect the top of the furnace from sudden gas pressure surges. The coarse particles in the exhaust gas settle and can be disposed, while the gas can flow through a venturi scrubber or electrostatic precipitator or a gas cooler to reduce the temperature of the cleaned gas. A casthouse at the bottom of the furnace contains equipment for casting the liquid iron and slag. A taphole can be drilled through a refractory plug, so that liquid iron and slag flow down a trough through an opening, separating the iron and slag. Once the pig iron and slag has been tapped, the taphole can be plugged with refractory clay. Nozzles, called tuyeres, are used to implement a hot blast to increase the efficiency of the blast furnace. The hot blast is directed into the furnace through cooled tuyeres near the base.

The hot blast temperature can be from 900° C. to 1300° C. (air temperature), for example. The temperature within the blast furnace can be 2000° C. or higher. Other carbonaceous materials or oxygen can also be injected into the furnace at the tuyere level to combine with the carbon (from biocarbon pellets) to release additional energy and increase the percentage of reducing gases present which increases productivity.

Blast furnaces operate on the principle of chemical reduction whereby carbon monoxide, having a stronger affinity for the oxygen in metal ore (e.g., iron ore) than the corresponding metal does, reduces the metal to its elemental form. Blast furnaces differ from bloomeries and reverberatory furnaces in that in a blast furnace, flue gas is in direct contact with the ore and metal, allowing carbon monoxide to diffuse into the ore and reduce the metal oxide to elemental metal mixed with carbon. The blast furnace usually operates as a continuous, countercurrent exchange process.

Silica usually is removed from the pig iron. Silica reacts with calcium oxide and forms a silicate which floats to the surface of the molten pig iron as slag. The downward-moving column of metal ore, flux, carbon, and reaction products must be porous enough for the flue gas to pass through. This requires the biogenic-reagent carbon to be in large enough particles (e.g., biocarbon pellets or smaller objects derived from the pellets) to be permeable. Therefore, pellets, or crushed pellets, must be strong enough so it will not be crushed by the weight of the material above it. Besides physical strength of the carbon, it can also be low in sulfur, phosphorus, and ash.

Many chemical reactions take place in a blast furnace. The chemistry can be understood with reference to hematite (Fe₂O₃) as the starting metal oxide. This form of iron oxide is common in iron ore processing, either in the initial feedstock or as produced within the blast furnace. Other forms of iron ore (e.g., taconite) will have various concentrations of different iron oxides (Fe₃O₄, Fe₂O₃, FeO, etc.).

The main overall chemical reaction producing molten iron in a blast furnace is:

Fe₂O₃+3CO→2Fe+3CO₂

which is an endothermic reaction. This overall reaction occurs over many steps, with the first being that preheated blast air blown into the furnace reacts with carbon (e.g., from the biocarbon pellets) to produce carbon monoxide and heat:

2C+O₂→2CO

The hot carbon monoxide is the reducing agent for the iron ore and reacts with the iron oxide to produce molten iron and carbon dioxide. Depending on the temperature in the different parts of the furnace (typically highest at the bottom), the iron is reduced in several steps. At the top, where the temperature usually is in the range of 200-700° C., the iron oxide is partially reduced to iron(II,III) oxide, Fe₃O₄:

3Fe₂O₃+CO→2Fe₃O₄+CO₂

At temperatures around 850° C., further down in the furnace, the iron(II,III) is reduced further to iron(II) oxide, FeO:

Fe₃O₄+CO→3FeO+CO₂

Hot carbon dioxide, unreacted carbon monoxide, and nitrogen from the air pass up through the furnace as fresh feed material travels down into the reaction zone. As the material travels downward, countercurrent gases both preheat the feed charge and decompose the limestone (when employed) to calcium oxide and carbon dioxide:

CaCO₃→CaO+CO₂

The calcium oxide formed by decomposition reacts with various acidic impurities in the iron (notably silica) to form a slag which is primarily calcium silicate, CaSiO₃:

SiO₂+CaO→CaSiO₃

As the FeO moves down to the region with higher temperatures, ranging up to 1200° C., FeO is reduced further to iron metal, again with carbon monoxide as reactant:

FeO+CO→Fe+CO₂

The carbon dioxide formed in this process can be converted back to carbon monoxide by reacting with carbon via the reverse Boudouard reaction:

C+CO₂→2CO

In the chemical reactions shown above, it is important to note that a reducing gas can alternatively or additionally be directly introduced into the blast furnace, rather than being an in-situ product within the furnace. Typically, in these embodiments, the reducing gas includes both hydrogen and carbon monoxide, which both function to chemically reduce metal oxide. Optionally, the reducing gas can be separately produced from biocarbon pellets by reforming, gasification, or partial oxidation.

In conventional blast furnaces, there is no hydrogen available for causing metal oxide reduction. Hydrogen can be injected directly into the blast furnace. Alternatively, or additionally, hydrogen can be available within the biocarbon pellets that are fed to the blast furnace, when the biocarbon pellets contain volatile carbon that is associated with hydrogen (e.g., heavy tar components). Regardless of the source, hydrogen can cause additional reduction reactions that are similar to those above, but replacing CO with H₂:

3Fe₂O₃+H₂→2Fe₃O₄+H₂O

Fe₃O₄+4H₂→3Fe+4H₂O

which occur in parallel to the reduction reactions with CO. The hydrogen can also react with carbon dioxide to generate more CO, in the reverse water-gas shift reaction. In certain embodiments, a reducing gas consisting essentially of hydrogen is fed to a blast furnace.

The “pig iron” produced by the blast furnace typically has a relatively high carbon content of around 3-6 wt %. Pig iron can be used to make cast iron. Pig iron produced by blast furnaces normally undergoes further processing to reduce the carbon and sulfur content and produce various grades of steel used commercially. In a further process step referred to as basic oxygen steelmaking, the carbon is oxidized by blowing oxygen onto the liquid pig iron to form crude steel.

Desulfurization conventionally is performed during the transport of the liquid iron to the steelworks, by adding calcium oxide, which reacts with iron sulfide contained in the pig iron to form calcium sulfide. In some embodiments, desulfurization can also take place within a furnace or downstream of a furnace, by reacting a metal sulfide with CO (in the reducing gas) to form a metal and carbonyl sulfide, CSO. In these or other embodiments, desulfurization can also take place within a furnace or downstream of a furnace, by reacting a metal sulfide with H₂ (in the reducing gas) to form a metal and hydrogen sulfide, H₂S.

Other types of furnaces can employ other chemical reactions. It will be understood that in the chemical conversion of a metal oxide into a metal, which employs carbon or a reducing gas in the conversion, that carbon is preferably renewable carbon. This disclosure provides renewable carbon in biogenic reagents produced via pyrolysis of biomass. In certain embodiments, some carbon utilized in the furnace is not renewable carbon. In various embodiments, of the total carbon that is consumed in the metal ore furnace, that percentage of that carbon that is renewable can be at least about 20%, 30%, 40%, 50%, 60%, 70%, 80%, 90%, 95%, 99%, or 100%.

In some variations, a Tecnored furnace, or modification thereof, is utilized. The Tecnored process was originally developed by Tecnored Desenvolvimento Tecnológico S.A. of Brazil and is based on a low-pressure moving-bed reduction furnace which reduces cold-bonded, carbon-bearing, self-fluxing, and self-reducing pellets. Reduction is carried out in a short-height shaft furnace at typical reduction temperatures. The process produces hot metal (typically liquid iron) at high efficiency.

Tecnored technology was developed to be a coke-less ironmaking process, thus avoiding the investment and operation of environmentally harmful coke ovens besides significantly reducing greenhouse gas emissions in the production of hot metal. The Tecnored process uses a combination of hot and cold blasts and requires no additional oxygen. It eliminates the need for coke plants, sinter plants, and tonnage oxygen plants. Hence, the process has much lower operating and investment costs than those of traditional ironmaking routes.

In the present disclosure, the Tecnored process can be adapted for use in various ways. Some embodiments provide self-reducing agglomerates (such as biocarbon pellets), produced from iron ore fines or iron-bearing residues, plus a biogenic reagent disclosed herein. These materials, mixed with fluxing and binding agents, are agglomerated and thermally cured, producing biocarbon pellets which have sufficient strength for the physical and metallurgical demands of the Tecnored process. The agglomerates produced are then smelted in a Tecnored furnace. The fuel for the Tecnored furnace can itself be biocarbon pellets, or a non-pellet biocarbon composition (e.g., a powder).

By combining fine particles of iron oxide and the reductant within the briquette, both the surface area of the oxide in contact with reductant and, consequently, the reaction kinetics are increased dramatically. The self-reducing briquettes can be designed to contain sufficient reductant to allow full reduction of the iron-bearing feed contained, optionally with fluxes to provide the desired slag chemistry. The self-reducing briquettes are cured at low temperatures prior to feeding to the furnace. The heat required to drive the reaction within the self-reducing briquettes is provided by a bed of solid fuel, which can also be in the form of briquettes, onto which the self-reducing briquettes are fed within the furnace.

A Tecnored furnace has three zones: (i) upper shaft zone; (ii) melting zone; and (iii) lower shaft zone. In the upper shaft zone, solid fuel (preferably biogenic reagent) is charged. In this zone, the Boudouard reaction (C+CO₂→2CO) is prevented which saves energy. Post-combustion in this zone of the furnace burns CO which provides energy for preheating and reduction of the charge. Inside the pellets, the following reactions take place at a very fast rate:

FeₓO_{y}+yCO→xFe+yCO₂

yCO₂+yC=2yCO

where x is from 1 to typically 5 and y is from 1 to typically 7.

In the melting zone, reoxidation is prevented because of the reducing atmosphere in the charge. The melting of the charge takes place under reducing atmosphere. In the lower shaft zone, solid fuel is charged. In some instances, the solid fuel comprises, or consists essentially of, biocarbon pellets. In this zone, further reduction of residual iron oxides and slagging reactions of gangue materials and fuel ash takes place in the liquid state. Also, superheating of metal and slag droplets take place. These superheated metal and slag droplets sink due to gravity to the furnace hearth and accumulate there.

This modified Tecnored process employs two different inputs of carbon units—namely the reductant and the solid fuel. The reducing agent is conventionally coal fines, but in this disclosure, the reducing agent can include pulverized biocarbon pellets. The self-reducing agglomerates can be the biocarbon pellets disclosed herein. The quantity of carbon fines required is established by a ratio of carbon to ore fines, which is preferably selected to achieve full reduction of the metal oxides.

The solid fuel need not be in the form of biocoke fines. For example, the solid fuel can be in the form of lumps, such as about 40-80 mm in size to handle the physical and thermal needs required from the solid fuels in the Tecnored process. These lumps can be made by breaking apart (e.g., crushing) biocarbon pellets, but not all the way down to powder. The solid fuel is charged through side feeders (to avoid the endothermic Boudouard reaction in the upper shaft) and provides most of the energy demanded by the process. This energy is usually formed by the primary blast (C+O₂→CO₂) and by the secondary blast, where the upstream CO, generated by the gasification of the solid fuel at the hearth, is burned (2CO+O₂→2 CO₂).

In certain exemplary embodiments, a modified-Tecnored process comprises pelletizing iron ore fines with a size less than 140 mesh, biogenic-reagent fines with a size less than 200 mesh, and a flux such as hydrated lime of size less than 140 mesh using cement as the binder. The pellets are cured and dried at 200° C. before they are fed to the top of the Tecnored furnace. The total residence time of the charge in the furnace is around 30-40 minutes. Biogenic reagent in the form of solid fuel of size ranging from 40 mm to 80 mm is fed in the furnace below the hot pellet area using side feeders. Hot blast air at around 1150° C. is blown in through tuyeres located in the side of the furnace to provide combustion air for the biogenic carbon. A small amount of furnace gas is allowed to flow through the side feeders to use for the solid fuel drying and preheating. Cold blast air is blown in at a higher point to promote post-combustion of CO in the upper shaft. The hot metal produced is tapped into a ladle on a ladle car, which can tilt the ladle for de-slagging. The liquid iron is optionally desulfurized in the ladle, and the slag is raked into a slag pot. The hot metal typically contains about 3-5 wt % carbon.

Conventionally, external CO or H₂ does not play a significant role in the self-reduction process using a Tecnored furnace. However, external H₂ or CO (from reducing gas) can assist the overall chemistry by increasing the rate or conversion of iron oxides in the above reaction (FeₓO_{y}+y CO→x Fe+y CO₂) or in a reaction with hydrogen as reactant (FeₓO_{y}+y H₂→x Fe+y H₂O). The reduction chemistry can be assisted at least at the surface of the pellets or briquettes, and possibly within the bulk phase of the pellets or briquettes since mass transfer of hot reducing gas is fast. Some embodiments of this disclosure combine aspects of a blast furnace with aspects of a Tecnored furnace, so that a self-reducing pellet or briquette is utilized, in addition to the use of reducing gas within the furnace.

As stated previously, there are a large number of possible furnace configurations for metal ore processing. This specification will not describe in details the various conditions and chemistry that can take place in all possible furnaces, but it will be understood by one skilled in the art that the principles of this invention can be applied to essentially any furnace or process that uses carbon somewhere in the process of making a metal from a metal ore.

It will also be observed that some processes utilize biocoke-containing pellets, some processes utilize reducing gas, and some processes utilize both biocoke-containing pellets and reducing gas. The processes provided herein can produce both solid biocoke-containing pellets as well as a reducing gas. In some embodiments, only the solid biocoke-containing pellets are employed in a metal ore conversion process. In other embodiments, only the reducing gas is employed in a metal ore conversion process. In still other embodiments, both the biocoke-containing pellets and the reducing gas are employed in a metal ore conversion process. In these embodiments employing both sources of renewable carbon, the percentage of overall carbon usage in the metal ore conversion from the reducing gas can be about, at least about, or at most about 5%, 10%, 20%, 30%, 40%, 50%, 60%, 70%, 80%, 90%, 95%, or 100%. The other carbon usage can be from the biocoke-containing pellets. Alternatively, some or all of the other carbon usage can be from conventional carbon inputs, such as coal fines or conventional coke fines.

### Conversion of Biocarbon Compositions to Reducing Gas

Some variations employ a biocoke composition (as pellets, powder, or another form) to generate reducing gas, wherein the reducing gas can be utilized in situ in a process or can be recovered and sold.

The optional production of reducing gas (also referred to herein as “bio-reductant gas”) will now be further described. The conversion of a biocoke composition to reducing gas takes place in a reactor, which can be referred to as a bio-reductant formation unit.

A reactant can be employed to react with the biocoke composition and produce a reducing gas. The reactant can be selected from oxygen, steam, or a combination thereof. In some embodiments, oxygen is mixed with steam, and the resulting mixture is added to the second reactor. Oxygen or oxygen-enriched air can be added to cause an exothermic reaction such as the partial or total oxidation of carbon with oxygen; to achieve a more favorable H₂/CO ratio in the reducing gas; (iii) to increase the yield of reducing gas; or (iv) to increase the purity of reducing gas, e.g., by reducing the amount of CO₂, pyrolysis products, tar, aromatic compounds, or other undesirable products.

Steam is a desired reactant, in some embodiments. Steam (i.e., H₂O in a vapor phase) can be introduced into the reactor in one or more input streams. Steam can include steam generated by moisture contained in the biocarbon pellets, as well as steam generated by any chemical reactions that produce water.

All references herein to a “ratio” of chemical species are references to molar ratios unless otherwise indicated. For example, a H₂/CO ratio of 1 means one mole of hydrogen per mole of carbon dioxide.

Steam reforming, partial oxidation, water-gas shift (WGS), or combustion reactions can occur when oxygen or steam are added. Exemplary reactions are shown below with respect to a cellulose repeat unit (C₆H₁₀O₅) found, for example, in cellulosic feedstocks. Similar reactions can occur with any carbon-containing feedstock, including biocoke-containing pellets.
Steam Reforming C₆H₁₀O₅+H₂O→6 CO+6H₂
Partial Oxidation C₆H₁₀O₅+½O₂→6 CO+5H₂
Water-Gas Shift CO+H₂O H H₂+CO₂
Complete Combustion C₆H₁₀O₅+6O₂→6 CO₂+5 H₂O

The bio-reductant formation unit is any reactor capable of causing at least one chemical reaction that produces reducing gas. Conventional steam reformers, well-known in the art, can be used either with or without a catalyst. Other possibilities include autothermal reformers, partial-oxidation reactors, and multistaged reactors that combine several reaction mechanisms (e.g., partial oxidation followed by water-gas shift). The reactor configuration can be a fixed bed, a fluidized bed, a plurality of microchannels, or some other configuration.

In some embodiments, the total amount of steam as reactant is at least about 0.1 mole of steam per mole of carbon in the feed material. In various embodiments, at least about any of 0.5, 1.0, 1.5, 2.0, 3.0, 4.0, 5.0, or more moles of steam are added or are present per mole of carbon. In some embodiments, between about 1.5-3.0 moles of steam are added or are present per mole carbon.

The amount to steam that is added to the second reactor can vary depending on factors such as the conditions of the pyrolysis reactor. When pyrolysis produces a carbon-rich solid material, generally more steam (or more oxygen) is used to add the necessary H and O atoms to the C available to generate CO and H₂. From the perspective of the overall system, the moisture contained in the biocoke-containing pellets can be accounted for in determining how much additional water (steam) to add in the process.

Exemplary ratios of oxygen to steam (O₂/H₂O) are equal to or less than about any of 2, 1.5, 1, 0.5, 0.2, 0.1, 0.05, 0.02, 0.01, or less, in the second reactor. When the ratio of O₂/H₂O is greater than 1, the combustion reaction starts to dominate over partial oxidation, which can produce undesirably low CO/CO₂ ratios.

In some embodiments, oxygen without steam is used as the reactant. Oxygen can be added in substantially pure form, or it can be fed to the process via the addition of air, optionally enriched with oxygen. In some embodiments, air that is not enriched with oxygen is added. In other embodiments, enriched air from an off-spec or recycle stream, which can be a stream from a nearby air-separation plant, for example, can be used. In some embodiments, the use of enriched air with a reduced amount of N₂ (i.e., less than 79 vol %) results in less N₂ in the resulting reducing gas. Because removal of N₂ can be expensive, methods of producing reducing gas with less or no N₂ are typically desirable.

In some embodiments, the presence of oxygen alters the ratio of H₂/CO in the reducing gas, compared to the ratio produced by the same method in the absence of oxygen. The H₂/CO ratio of the reducing gas can be between about 0.5 to about 2.0, such as between about 0.75-1.25, about 1-1.5, or about 1.5-2.0. As will be recognized, increased water-gas shift (by higher rates of steam addition) will tend to produce higher H₂/CO ratios, such as at least 2.0, 3.0, 4.0, 5.0, or even higher, which can be desired for certain applications, including hydrogen production.

Catalysts can optionally be utilized in the reactor for generating the reducing gas. Catalysts can include, but are not limited to, alkali metal salts, alkaline earth metal oxides and salts, mineral substances or ash in coal, transition metals and their oxides and salts, and eutectic salt mixtures. Specific examples of catalysts include, but are not limited to, potassium hydroxide, potassium carbonate, lithium hydroxide, lithium carbonate, cesium hydroxide, nickel oxide, nickel-substituted synthetic mica montmorillonite (NiSMM), NiSMM-supported molybdenum, iron hydroxyoxide, iron nitrate, iron-calcium-impregnated salts, nickel uranyl oxide, sodium fluoride, and cryolite.

Other exemplary catalysts include, but are not limited to, nickel, nickel oxide, rhodium, ruthenium, iridium, palladium, and platinum. Such catalysts can be coated or deposited onto one or more support materials, such as, for example, gamma-alumina (optionally doped with a stabilizing element such as magnesium, lanthanum, or barium).

Before being added to the system, any catalyst can be pretreated or activated using known techniques that impact total surface area, active surface area, site density, catalyst stability, catalyst lifetime, catalyst composition, surface roughness, surface dispersion, porosity, density, or thermal diffusivity. Pretreatments of catalysts include, but are not limited to, calcining, washcoat addition, particle-size reduction, and surface activation by thermal or chemical means.

Catalyst addition can be performed by first dissolving or slurrying the catalyst(s) into a solvent such as water or any hydrocarbon that can be gasified or reformed. In some embodiments, the catalyst is added by direct injection of such a slurry into a vessel. In some embodiments, the catalyst is added to steam and the steam/catalyst mixture is added to the system. In these embodiments, the added catalyst can be at or near its equilibrium solubility in the steam or can be introduced as particles entrained in the steam and thereby introduced into the system.

Material can generally be conveyed into and out of the reactor by single screws, twin screws, rams, and the like. Material can be conveyed mechanically by physical force (metal contact), pressure-driven flow, pneumatically driven flow, centrifugal flow, gravitational flow, fluidized flow, or some other known means of moving solid and gas phases. It can be desirable to utilize a fixed bed of biocarbon pellets in the reactor, especially in embodiments that employ a bed of metal oxide disposed above the biocarbon pellet bed which need to be mechanically robust.

In some embodiments, the reactor employs gasification of a biocoke-containing composition to generate a reducing gas. Gasification is carried out at elevated temperatures, typically about 600° C. to about 1100° C. Less-reactive biogenic reagents require higher operating temperatures. The amount of reactant introduced (e.g., air, oxygen, enriched air, or oxygen-steam mixtures) will typically be the primary factor controlling the gasification temperature. Operating pressures from atmospheric to about 50 bar have been employed in biomass gasification. Gasification also requires a reactant, commonly air, high-purity oxygen, steam, or some mixture of these gases.

Gasifiers can be differentiated based on the means of supporting solids within the vessel, the directions of flow of both solids and gas, and the method of supplying heat to the reactor. Whether the gasifier is operated at near atmospheric or at elevated pressures, and the gasifier is air-blown or oxygen-blown, are also distinguishing characteristics. Common classifications are fixed-bed updraft, fixed-bed downdraft, bubbling fluidized bed, and circulating fluidized bed.

Fixed-bed gasifiers, in general, cannot handle fibrous herbaceous feedstocks, such as wheat straw, corn stover, or yard wastes. However, in the disclosed processes, biomass is first pyrolyzed to a biogenic reagent, which is pelletized, and the biocarbon pellets can be gasified. The biocarbon pellets can be directly gasified using a fixed-bed gasifier, without necessarily reducing the size of the pellets.

Circulating fluidized-bed gasification technology is available from Lurgi and Foster Wheeler, and represents the majority of existing gasification technology utilized for biomass and other wastes. Bubbling fluidized-bed gasification (e.g., U-GAS® technology) has been commercially used.

Directly heated gasifiers conduct endothermic and exothermic gasification reactions in a single reaction vessel; no additional heating is needed. In contrast, indirectly heated gasifiers require an external source of heat. Indirectly heated gasifiers commonly employ two vessels. The first vessel gasifies the feed with steam (an endothermic process). Heat is supplied by circulating a heat-transfer medium, commonly sand. Reducing gas and solid char produced in the first vessel, along with the sand, are separated. The mixed char and sand are fed to the second vessel, where the char is combusted with air, heating the sand. The hot sand is circulated back to the first vessel.

The biocoke composition can be introduced to a gasifier as a “dry feed” (optionally with moisture, but no free liquid phase), or as a slurry or suspension in water. Dry-feed gasifiers typically allow for high per-pass carbon conversion to reducing gas and good energy efficiency. In a dry-feed gasifier, the energy released by the gasification reactions can cause the gasifier to reach extremely high temperatures. This problem can be resolved by using a wet-wall design.

In some embodiments, the feed to the gasifier is biocarbon pellets with high hydrogen content. The resulting reducing gas is relatively rich in hydrogen, with high H₂/CO ratios, such as H₂/CO>1.5 or more.

In some embodiments, the feed to the gasifier includes biocoke-containing pellets with low hydrogen content. The resulting reducing gas is expected to have relatively low H₂/CO ratios. For downstream processes that require H₂/CO>1, it can be desirable to inject water or steam into the gasifier to both moderate the gasifier temperature (via sensible-heat effects or endothermic chemistry), and to shift the H₂/CO ratio to a higher, more-desirable ratio. Water addition can also contribute to temperature moderation by endothermic consumption, via steam-reforming chemistry. In steam reforming, H₂O reacts with carbon or with a hydrocarbon, such as tar or benzene/toluene/xylenes, to produce reducing gas and lower the adiabatic gasification temperature.

In certain variations, the gasifier is a fluidized-bed gasifier, such as a bubbling fluidized gasification reactor. Fluidization results in a substantially uniform temperature within the gasifier bed. A fluidizing bed material, such as alumina sand or silica sand, can reduce potential attrition issues. The gasifier temperature is preferably moderated to a sufficiently low temperature so that ash particles do not begin to transform from solid to molten form, which can cause agglomeration and loss of fluidization within the gasifier.

When a fluidized-bed gasifier is used, the total flow rate of all components should ensure that the gasifier bed is fluidized. The total gas flow rate and bed diameter establish the gas velocity through the gasifier. The correct velocity must be maintained to ensure proper fluidization.

In variations, the gasifier type can be entrained-flow slagging, entrained flow non-slagging, transport, bubbling fluidized bed, circulating fluidized bed, or fixed bed. Some embodiments employ gasification catalysts.

Circulating fluidized-bed gasifiers can be employed, wherein gas, sand, and feedstock (e.g., crushed or pulverized biocarbon pellets) move together. Exemplary transport gases include recirculated product gas, combustion gas, or recycle gas. High heat-transfer rates from the sand ensure rapid heating of the feedstock, and ablation is expected to be stronger than with regular fluidized beds. A separator can be employed to separate the reducing gas from the sand and char particles. The sand particles can be reheated in a fluidized burner vessel and recycled to the reactor.

In some embodiments in which a countercurrent fixed-bed gasifier is used, the reactor comprises or consists essentially of a fixed bed of a feedstock through which a gasification agent (such as steam, oxygen, or recycle gas) flows in countercurrent configuration. The ash is either removed dry or as a slag.

In some embodiments in which a cocurrent fixed-bed gasifier is used, the reactor is similar to the countercurrent type, but the gasification agent gas flows in cocurrent configuration with the feedstock. Heat is added to the upper part of the bed, either by combusting small amounts of the feedstock or from external heat sources. The produced gas leaves the reactor at a high temperature, and much of this heat is transferred to the gasification agent added in the top of the bed, resulting in good energy efficiency.

In some embodiments in which a fluidized-bed reactor is used, the feedstock is fluidized in recycle gas, oxygen, air, or steam. The ash can be removed dry or as heavy agglomerates that defluidize. Recycle or subsequent combustion of solids can be used to increase conversion. Fluidized-bed reactors are useful for feedstocks that form highly corrosive ash that would damage the walls of slagging reactors.

In some embodiments in which an entrained-flow gasifier is used, biocarbon pellets are pulverized and gasified with oxygen, air, or recycle gas in concurrent flow. The gasification reactions take place in a dense cloud of very fine particles. High temperatures can be employed, thereby providing for low quantities of tar and methane in the reducing gas.

Entrained-flow reactors remove the major part of the ash as a slag, as the operating temperature is typically well above the ash fusion temperature. A smaller fraction of the ash is produced either as a very fine dry fly ash or as a fly-ash slurry. Certain entrained-bed reactors have an inner water- or steam-cooled wall covered with partially solidified slag.

The gasifier chamber can be designed, by proper configuration of the freeboard or use of internal cyclones, to keep the carryover of solids downstream operations at a level suitable for recovery of heat. Unreacted carbon can be drawn from the bottom of the gasifier chamber, cooled, and recovered.

A gasifier can include one or more catalysts, such as catalysts effective for partial oxidation, reverse water-gas shift, or dry (CO₂) reforming of carbon-containing species.

In some embodiments, a bubbling fluid-bed devolatilization reactor is utilized. The reactor is heated, at least in part, by the hot recycle gas stream to approximately 600° C.—below the expected slagging temperature. Steam, oxygen, or air can also be introduced to the second reactor. The second can be designed, by proper configuration of a freeboard or use of internal cyclones, to keep the carryover of solids at a level suitable for recovery of heat downstream. Unreacted char can be drawn from the bottom of the devolatilization chamber, cooled, and then fed to a utility boiler to recover the remaining heating value of this stream.

When a fluidized-bed gasifier is employed, the feedstock can be introduced into a bed of hot sand fluidized by a gas, such as recycle gas. Reference herein to “sand” shall also include similar, substantially inert materials, such as glass particles, recovered ash particles, and the like. High heat-transfer rates from fluidized sand can result in rapid heating of the feedstock. There can be some ablation by attrition with the sand particles. Heat can be provided by heat-exchanger tubes through which hot combustion gas flows.

Circulating fluidized-bed reactors can be employed, wherein gas, sand, and feedstock move together. Exemplary transport gases include recirculated product gas, combustion gas, or recycle gas. High heat-transfer rates from the sand ensure rapid heating of the feedstock, and ablation is expected to be stronger than with regular fluidized beds. A separator can be employed to separate the reducing gas from the sand and char particles. The sand particles can be reheated in a fluidized burner vessel and recycled to the reactor.

In some embodiments in which a countercurrent fixed-bed reactor is used, the reactor comprises or consists essentially of a fixed bed of a feedstock through which a gasification agent (such as steam, oxygen, or recycle gas) flows in countercurrent configuration. The ash is either removed dry or as a slag.

In some embodiments in which a cocurrent fixed-bed reactor is used, the reactor is similar to the countercurrent type, but the gasification agent gas flows in cocurrent configuration with the feedstock. Heat is added to the upper part of the bed, either by combusting small amounts of the feedstock or from external heat sources. The reducing gas leaves the reactor at a high temperature, and much of this heat is transferred to the reactants added in the top of the bed, resulting in good energy efficiency. Since tars pass through a hot bed of carbon in this configuration, tar levels are expected to be lower than when using the countercurrent type.

In some embodiments in which a fluidized-bed reactor is used, the feedstock is fluidized in recycle gas, oxygen, air, or steam. The ash is removed dry or as heavy agglomerates that defluidize. Recycle or subsequent combustion of solids can be used to increase conversion.

To enhance heat and mass transfer, water can be introduced into the reactor using a nozzle, which is generally a mechanical device designed to control the direction or characteristics of a fluid flow as it enters an enclosed chamber or pipe via an orifice. Nozzles are capable of reducing the water droplet size to generate a fine spray of water. Nozzles can be selected from atomizer nozzles (similar to fuel injectors), swirl nozzles which inject the liquid tangentially, and so on.

Water sources can include direct piping from process condensate, other recycle water, wastewater, make-up water, boiler feed water, city water, and so on. Water can optionally first be cleaned, purified, treated, ionized, distilled, and the like.

When several water sources are used, various volume ratios of water sources are possible. In some embodiments, a portion or all of the water for the second reactor is wastewater.

In some variations, the reducing gas is filtered, purified, or otherwise conditioned prior to being converted to another product. For example, cooled reducing gas can be introduced to a conditioning unit, where benzene, toluene, ethyl benzene, xylene, sulfur compounds, nitrogen, metals, or other impurities are optionally removed from the reducing gas.

Some embodiments include a reducing-gas cleanup unit. The reducing-gas cleanup unit is not particularly limited in its design. Exemplary reducing-gas cleanup units include cyclones, centrifuges, filters, membranes, solvent-based systems, and other means of removing particulates or other specific contaminants. In some embodiments, an acid-gas removal unit is included and can be any means known in the art for removing H₂S, CO₂, or other acid gases from the reducing gas.

Examples of acid-gas removal steps include removal of CO₂ with one or more solvents for CO₂, or removal of CO₂ by a pressure-swing adsorption unit. Suitable solvents for reactive solvent-based acid gas removal include monoethanolamine, diethanolamine, methyldiethanolamine, diisopropylamine, and aminoethoxyethanol. Suitable solvents for physical solvent-based acid gas removal include dimethyl ethers of polyethylene glycol (such as in the Selexol® process) and refrigerated methanol (such as in the Rectisol® process).

The reducing gas produced as described according to the present invention can be utilized in a number of ways. Reducing gas can generally be chemically converted or purified into hydrogen, carbon monoxide, methane, olefins (such as ethylene), oxygenates (such as dimethyl ether), alcohols (such as methanol and ethanol), paraffins, and other hydrocarbons. Reducing gas can be converted into linear or branched C₅-C₁₅ hydrocarbons, diesel fuel, gasoline, waxes, or olefins by Fischer-Tropsch chemistry; mixed alcohols by a variety of catalysts; isobutane by isosynthesis; ammonia by hydrogen production followed by the Haber process; aldehydes and alcohols by oxosynthesis; and many derivatives of methanol including dimethyl ether, acetic acid, ethylene, propylene, and formaldehyde by various processes. The reducing gas can also be converted to energy using energy-conversion devices such as solid-oxide fuel cells, Stirling engines, micro-turbines, internal combustion engines, thermo-electric generators, scroll expanders, gas burners, or thermo-photovoltaic devices.

In this detailed description, reference has been made to multiple embodiments of the invention and non-limiting examples relating to how the invention can be understood and practiced. Other embodiments that do not provide all of the features and advantages set forth herein can be utilized, without departing from the spirit and scope of the present invention. This invention incorporates routine experimentation and optimization of the methods and systems described herein. Such modifications and variations are considered to be within the scope of the invention defined by the claims.

All publications, patents, and patent applications cited in this specification are herein incorporated by reference in their entirety as if each publication, patent, or patent application were specifically and individually put forth herein. To the extent any materials incorporated herein by reference conflict with the present disclosure, the present disclosure controls.

Where methods and steps described above indicate certain events occurring in certain order, those of ordinary skill in the art will recognize that the ordering of certain steps can be modified and that such modifications are in accordance with the variations of the invention. Additionally, certain of the steps can be performed concurrently in a parallel process when possible, as well as performed sequentially.

Therefore, to the extent there are variations of the invention, which are within the spirit of the disclosure or equivalent to the inventions found in the appended claims, it is the intent that this patent will cover those variations as well. The present invention shall only be limited by what is claimed.

### EXAMPLES

### Example 1: Production of Biocoke from Biogas Obtained by Pyrolyzing Mixed Hardwood/Softwood

Wood chips containing a mix of hardwood and softwood are provided as a biomass feedstock. The average size of the wood chips is about 25 millimeters long, about 25 millimeters wide, and about 5 millimeters thick.

The biomass feedstock is pyrolyzed in a continuous pyrolysis reactor at a pyrolysis temperature of about 600° C. using a pyrolysis solid-phase residence time of about 30 minutes. The pyrolysis pressure is about 1 bar (atmospheric pressure) under an inert gas consisting essentially of N₂. There is a solid output (pyrolysis solids) and a vapor output (pyrolysis vapor) from the pyrolysis reactor. The pyrolysis solids containing carbon are collected in a hopper and are in the form of granules with an average particle size of about 500 microns. The pyrolysis vapor contains CO, CO₂, H₂O, and various alkanes, olefins, aromatics, aldehydes, ketones, acids, and alcohols.

The pyrolysis vapor is converted to biocoke in a kinetic interface reactor. The kinetic interface reactor is a countercurrent rotary kiln in which the pyrolysis solids as kinetic interface media flow in substantially one direction. The pyrolysis vapor is fed into the rotary kiln and flows substantially in the opposite direction as the flow direction of the pyrolysis solids. The kinetic interface reactor is operated at a temperature of about 900° C., a pressure of about 1 bar, a solid-phase residence time of about 120 minutes, and a vapor-phase residence time of about 30 minutes. No additional coking catalyst is added to the kinetic interface reactor. The pyrolysis vapor reacts to form biocoke (solid product) and an off-gas (vapor product) that contains, for example, water formed from oxygen and hydrogen content of the pyrolysis vapor. The carbon conversion of pyrolysis vapor to solids is about 80%, the carbon conversion of pyrolysis vapor to CO and CO₂ is about 10%, and about 10% of the pyrolysis vapor is unconverted and is part of the reactor off-gas stream (along with CO, CO₂, H₂O, etc.). The “carbon conversion of the carbon-containing vapor” is therefore about 80%.

A biocoke-containing kinetic interface media is collected as the solid output of the rotary kiln. Each particle of biocoke-containing kinetic interface media is a core that contains the initial granule of pyrolysis solids, and a shell that contains the solid reaction product of the pyrolysis vapor converted to biocoke. There is a discontinuous interface between the pyrolysis-solids core and the biocoke shell, as can be observed by scanning electron microscopy.

The biocoke-containing kinetic interface media is determined to contain about 80 wt % fixed carbon according to ASTM D3172. The biocoke-containing kinetic interface media is determined to contain 100% renewable carbon from a ¹⁴C/¹²C isotope measurement according to ASTM D6866. The biocoke portion of the biocoke-containing kinetic interface media is estimated to contain about 85 wt % fixed carbon according to ASTM D3172. The biocoke itself must contain 100% renewable carbon because the ¹⁴C/¹²C isotope measurement showed that the entire biocoke-containing kinetic interface media has 100% renewable carbon, and the biocoke is a portion (outer region) of the biocoke-containing kinetic interface media.

The entire biocoke-containing kinetic interface media can be utilized in a biocoke application, if desired, such as for foundry biocoke as a supporting matrix, a reducing agent, and/or an energy carrier. Optionally, the biocoke formed from the pyrolysis vapor can be recovered from the biocoke-containing kinetic interface media via separation and recovery.

### Example 2: Production of Biocoke from Biogas

Wood chips containing a mix of hardwood and softwood are provided as a biomass feedstock. The average size of the wood chips is about 25 millimeters long, about 25 millimeters wide, and about 5 millimeters thick.

The biomass feedstock is pyrolyzed in a continuous pyrolysis reactor at a pyrolysis temperature of about 650° C. using a pyrolysis solid-phase residence time of about 20 minutes. The pyrolysis pressure is about 1 bar (atmospheric pressure) under an inert gas consisting essentially of N₂. There is a solid output (pyrolysis solids) and a vapor output (pyrolysis vapor) from the pyrolysis reactor. The pyrolysis solids containing carbon are collected in a hopper and are in the form of granules with an average particle size of about 500 microns.

Biogas is obtained from an anaerobic digestor that ferments food waste into methane and small amounts of other gases. The biogas contains fully renewable carbon. This biogas is the carbon-containing vapor to be converted to biocoke.

The biogas is converted to biocoke in a kinetic interface reactor. The kinetic interface reactor is a countercurrent rotary kiln in which the pyrolysis solids as kinetic interface media flow in substantially one direction. The biogas is fed into the rotary kiln and flows substantially in the opposite direction as the flow direction of the pyrolysis solids. The kinetic interface reactor is operated at a temperature of about 1000° C., a pressure of about 2 bar, a solid-phase residence time of about 120 minutes, and a vapor-phase residence time of about 30 minutes. No additional coking catalyst is added to the kinetic interface reactor. The biogas reacts to form biocoke (solid product) and an off-gas (vapor product) that for example contains CO and CO₂. The carbon conversion of biogas to solids is about 75%, the carbon conversion of biogas to CO and CO₂ is about 20%, and about 5% of the biogas is unconverted and is part of the reactor off-gas stream (which contains unreacted CH₄, CO, CO₂, H₂O, etc.). The “carbon conversion of the carbon-containing vapor” is therefore about 75%.

A biocoke-containing kinetic interface media is collected as the solid output of the rotary kiln. Each particle of biocoke-containing kinetic interface media is a core that contains the initial granule of pyrolysis solids, and a shell that contains the solid reaction product of the biogas converted to biocoke. There is a discontinuous interface between the pyrolysis-solids core and the biocoke shell, as can be observed by scanning electron microscopy.

The biocoke-containing kinetic interface media is determined to contain about 75 wt % fixed carbon according to ASTM D3172. The biocoke-containing kinetic interface media is determined to contain 100% renewable carbon from a ¹⁴C/¹²C isotope measurement according to ASTM D6866. The biocoke portion of the biocoke-containing kinetic interface media is estimated to contain about 80 wt % fixed carbon according to ASTM D3172. The biocoke contains 100% renewable carbon according to the ¹⁴C/¹²C isotope measurement.

The entire biocoke-containing kinetic interface media can be utilized in a biocoke application, if desired, such as for foundry biocoke as a supporting matrix, a reducing agent, and/or an energy carrier. Optionally, the biocoke formed from the biogas can be recovered from the biocoke-containing kinetic interface media via separation and recovery.

### Example 3: Production of Biocoke from Bioliquid Obtained by Pyrolyzing Mixed Hardwood/Softwood

Wood chips containing a mix of hardwood and softwood are provided as a biomass feedstock. The average size of the wood chips is about 25 millimeters long, about 25 millimeters wide, and about 5 millimeters thick.

The biomass feedstock is pyrolyzed in a continuous pyrolysis reactor at a pyrolysis temperature of about 600° C. using a pyrolysis solid-phase residence time of about 30 minutes. The pyrolysis pressure is about 1 bar (atmospheric pressure) under an inert gas consisting essentially of N₂. There is a solid output (pyrolysis solids) and a vapor output (pyrolysis vapor) from the pyrolysis reactor. The pyrolysis solids containing carbon are collected in a hopper and are in the form of granules with an average particle size of about 500 microns. The pyrolysis vapor contains CO, CO₂, H₂O, and various alkanes, olefins, aromatics, aldehydes, ketones, acids, and alcohols.

The pyrolysis vapor is sent to a two-stage condenser in order to condense out much of the water in a first condenser stage, and then to condense out a bioliquid in a second condenser stage. The vapor output of the first condenser stage, containing pyrolysis carbon-containing vapors including CO and CO₂, enters the second condenser stage. The vapor output of the second condenser stage contains a majority of the CO and CO₂, and potentially light hydrocarbons, such as methane, methanol, and acetic acid. The liquid output of the second condenser stage is the bioliquid to be converted to biocoke.

The bioliquid is converted to biocoke in a kinetic interface reactor. The kinetic interface reactor is a vertical vessel in which the pyrolysis solids as kinetic interface media flow substantially downward with gravity. The bioliquid is pumped into the vertical vessel and flows substantially upward, in the opposite direction as the flow direction of the pyrolysis solids. The kinetic interface reactor is operated at a temperature of about 950° C., a pressure of about 3 bar, a solid-phase residence time of about 90 minutes, and a liquid-phase residence time of about 40 minutes. No additional coking catalyst is added to the kinetic interface reactor. The bioliquid reacts to form biocoke (solid product) and an off-gas (vapor product) that for example contains water formed from oxygen and hydrogen content of the bioliquid (e.g., O and H atoms in acetic acid). The carbon conversion of bioliquid to solids is about 90%, the carbon conversion of bioliquid to CO and CO₂ is about 10%, and there is substantially no unconverted bioliquid. The “carbon conversion of the carbon-containing liquid” is therefore about 90%.

A biocoke-containing kinetic interface media is collected as the solid output of the vertical vessel. Each particle of biocoke-containing kinetic interface media is a core that contains the initial granule of pyrolysis solids, and a shell that contains the solid reaction product of the bioliquid converted to biocoke. There is a discontinuous interface between the pyrolysis-solids core and the biocoke shell, as can be observed by scanning electron microscopy.

The biocoke-containing kinetic interface media is determined to contain about 85 wt % fixed carbon according to ASTM D3172. The biocoke-containing kinetic interface media is determined to contain 100% renewable carbon from a ¹⁴C/¹²C isotope measurement according to ASTM D6866. The biocoke portion of the biocoke-containing kinetic interface media is estimated to contain about 90 wt % fixed carbon according to ASTM D3172. The biocoke itself must contain 100% renewable carbon because the ¹⁴C/¹²C isotope measurement showed that the entire biocoke-containing kinetic interface media has 100% renewable carbon, and the biocoke is a portion (outer region) of the biocoke-containing kinetic interface media.

The entire biocoke-containing kinetic interface media can be utilized in a biocoke application, if desired, such as for foundry biocoke as a supporting matrix, a reducing agent, and/or an energy carrier. Optionally, the biocoke formed from the bioliquid can be recovered from the biocoke-containing kinetic interface media via separation and recovery.

### Example 4: Production of Biocoke from Bioliquid

Wood chips containing a mix of hardwood and softwood are provided as a biomass feedstock. The average size of the wood chips is about 25 millimeters long, about 25 millimeters wide, and about 5 millimeters thick.

The biomass feedstock is pyrolyzed in a continuous pyrolysis reactor at a pyrolysis temperature of about 700° C. using a pyrolysis solid-phase residence time of about 15 minutes. The pyrolysis pressure is about 1 bar (atmospheric pressure) under a substantially inert gas consisting essentially of N₂ and about 0.1 vol % O₂. There is a solid output (pyrolysis solids) and a vapor output (pyrolysis vapor) from the pyrolysis reactor. The pyrolysis solids containing carbon are collected in a hopper, and are in the form of granules with an average particle size of about 200 microns. The pyrolysis vapor contains CO, CO₂, H₂O, and various alkanes, olefins, aromatics, aldehydes, ketones, acids, and alcohols.

The granules of pyrolysis solids are formed into biopellets using a starch binder. The biopellets are approximately spherical with a diameter of about 10 millimeters. Since starch is 100% renewable, the pellet binder contains 100% renewable carbon, and therefore the biopellets contain 100% renewable carbon.

Bioliquid is obtained from a fermentation process that produces cellulosic ethanol from corn stover. The bioliquid is dehydrated but unpurified ethanol from a cellulosic-ethanol plant. Therefore, various impurities are present.

The bioliquid is converted to biocoke in a kinetic interface reactor. The kinetic interface reactor is a vertical vessel in which the biopellets as kinetic interface media flow substantially downward with gravity. The bioliquid is pumped into the vertical vessel and also flows substantially downward, co-current with the biopellets. The kinetic interface reactor is operated at a temperature of about 1000° C., a pressure of about 2 bar, a solid-phase residence time of about 100 minutes, and a liquid-phase residence time of about 30 minutes. No additional coking catalyst is added to the kinetic interface reactor. The bioliquid reacts to form biocoke (solid product) and an off-gas (vapor product) that for example contains water formed from oxygen and hydrogen content of the bioliquid (e.g., O and H atoms in the ethanol). The carbon conversion of bioliquid to solids is about 80%, the carbon conversion of bioliquid to CO and CO₂ is about 15%, and about 5% of the bioliquid is unconverted and is part of the reactor off-gas stream. The “carbon conversion of the carbon-containing liquid” is therefore about 80%.

A biocoke-containing kinetic interface media is collected as the solid output of the vertical vessel. Each particle of biocoke-containing kinetic interface media is a core that contains the initial pellet, and a shell that contains the solid reaction product of the bioliquid converted to biocoke. There is a discontinuous interface between the biopellet core and the biocoke shell, as can be observed by scanning electron microscopy.

The biocoke-containing kinetic interface media is determined to contain about 85 wt % fixed carbon according to ASTM D3172. The biocoke-containing kinetic interface media is determined to contain 100% renewable carbon from a ¹⁴C/¹²C isotope measurement according to ASTM D6866. The biocoke portion of the biocoke-containing kinetic interface media is estimated to contain about 90 wt % fixed carbon according to ASTM D3172. The biocoke itself contains 100% renewable carbon from the ¹⁴C/¹²C isotope measurement.

The entire biocoke-containing kinetic interface media can be utilized in a biocoke application, if desired, such as for foundry biocoke as a supporting matrix, a reducing agent, and/or an energy carrier. Optionally, the biocoke formed from the bioliquid can be recovered from the biocoke-containing kinetic interface media via separation and recovery.

### Example 5: Production of Biocoke from Biogas Obtained by Pyrolyzing Mixed Hardwood/Softwood

Wood chips containing a mix of hardwood and softwood are provided as a biomass feedstock. The average size of the wood chips is about 25 millimeters long, about 25 millimeters wide, and about 5 millimeters thick.

The biomass feedstock is pyrolyzed in a continuous pyrolysis reactor at a pyrolysis temperature of about 600° C. using a pyrolysis solid-phase residence time of about 30 minutes. The pyrolysis pressure is about 1 bar (atmospheric pressure) under an inert gas consisting essentially of N₂. There is a solid output (pyrolysis solids) and a vapor output (pyrolysis vapor) from the pyrolysis reactor. The pyrolysis solids containing carbon are collected in a hopper, and are in the form of granules with an average particle size of about 500 microns. The pyrolysis vapor contains CO, CO₂, H₂O, and various alkanes, olefins, aromatics, aldehydes, ketones, acids, and alcohols.

A mixture of silica and alumina is obtained, for purposes of functioning as a kinetic interface media. The kinetic interface media initially contains very little, if any, carbon (carbon would not be in the form of biocoke or biocarbon, but rather as soil impurities or other components, such as SiC). The silica/alumina mixture is a powder with average particle size of about 100 microns.

The pyrolysis vapor is converted to biocoke in a kinetic interface reactor. The kinetic interface reactor is a countercurrent rotary kiln in which the silica/alumina mixture as kinetic interface media flows in substantially one direction. The pyrolysis vapor is fed into the rotary kiln and flows substantially in the opposite direction as the flow direction of the pyrolysis solids. The kinetic interface reactor is operated at a temperature of about 900° C., a pressure of about 1 bar, a solid-phase residence time of about 120 minutes, and a vapor-phase residence time of about 30 minutes. No additional coking catalyst is added to the kinetic interface reactor. The pyrolysis vapor reacts to form biocoke (solid product) and an off-gas (vapor product) that for example contains water formed from oxygen and hydrogen content of the pyrolysis vapor. The carbon conversion of pyrolysis vapor to solids is about 80%, the carbon conversion of pyrolysis vapor to CO and CO₂ is about 10%, and about 10% of the pyrolysis vapor is unconverted and is part of the reactor off-gas stream (along with CO, CO₂, H₂O, etc.). The “carbon conversion of the carbon-containing vapor” is therefore about 80%.

A biocoke-containing kinetic interface media is collected as the solid output of the rotary kiln. Each particle of biocoke-containing kinetic interface media is a core that contains the initial mixture of silica and alumina (which themselves undergo no chemical conversion), and a shell that contains the solid reaction product of the pyrolysis vapor converted to biocoke. There is a discontinuous interface between the silica/alumina core and the biocoke shell, as can be observed by scanning electron microscopy, energy dispersive spectroscopy, or X-ray photoelectron spectroscopy.

The biocoke-containing kinetic interface media is determined to contain about 50 wt % fixed carbon according to ASTM D3172. The biocoke-containing kinetic interface media is determined to over 99% renewable carbon from a ¹⁴C/¹²C isotope measurement according to ASTM D6866. The biocoke portion of the biocoke-containing kinetic interface media is estimated to contain about 85 wt % fixed carbon according to ASTM D3172. The biocoke itself contains 100% renewable carbon from a ¹⁴C/¹²C isotope measurement of the biocoke phase.

The entire biocoke-containing kinetic interface media can be utilized in a biocoke application, if desired, although the high content of silica and alumina can preclude certain uses. Optionally, the biocoke formed from the pyrolysis vapor can be recovered from the biocoke-containing kinetic interface media via separation and recovery. Such separation can utilize the difference in density between carbon, silica, and alumina, since C has a lower density than SiO₂ or Al₂O₃. Chemical separation can be utilized, such as treatment with a reactant that preferentially removes silica and alumina from the biocoke-containing kinetic interface media, leaving substantially biocoke behind.

### Example 6: Production of Biocoke from Biogas Obtained by Pyrolyzing Mixed Hardwood/Softwood

Wood chips containing a mix of hardwood and softwood are provided as a biomass feedstock. The average size of the wood chips is about 25 millimeters long, about 25 millimeters wide, and about 5 millimeters thick.

The biomass feedstock is pyrolyzed in a continuous pyrolysis reactor at a pyrolysis temperature of about 600° C. using a pyrolysis solid-phase residence time of about 30 minutes. The pyrolysis pressure is about 1 bar (atmospheric pressure) under an inert gas consisting essentially of N₂. There is a solid output (pyrolysis solids) and a vapor output (pyrolysis vapor) from the pyrolysis reactor. The pyrolysis vapor contains CO, CO₂, H₂O, and various alkanes, olefins, aromatics, aldehydes, ketones, acids, and alcohols. The pyrolysis solids containing carbon are collected in a hopper, and are in the form of granules with an average particle size of about 500 microns. In this example, the pyrolysis solids are not further used.

The pyrolysis vapor is continuously converted to biocoke in a kinetic interface reactor. The kinetic interface reactor is a continuous horizontal plug-flow reactor. The pyrolysis vapor is fed into the plug-flow reactor. The kinetic interface reactor is operated at a temperature of about 900° C., a pressure of about 2 bar, a vapor-phase residence time of about 15 minutes, and a solid-phase residence time of about 60 minutes. No additional coking catalyst is added to the kinetic interface reactor. The pyrolysis vapor reacts to form solid biocoke and an off-gas that for example contains water formed from oxygen and hydrogen content of the pyrolysis vapor. The carbon conversion of pyrolysis vapor to solids is about 80%, the carbon conversion of pyrolysis vapor to CO and CO₂ is about 10%, and about 10% of the pyrolysis vapor is unconverted and is part of the reactor off-gas stream (along with CO, CO₂, H₂O, etc.). The “carbon conversion of the carbon-containing vapor” is therefore about 80%.

The outlet of the plug-flow reactor enters a separation unit which continuously splits the output into an off-gas stream and a solid stream. The solid stream is biocoke. About 80% of the solid stream is continuously recovered as a biocoke product. The remaining 20% of the solid stream is continuously recycled to the kinetic interface reactor, entering on the same side as the feed for the pyrolysis vapor, but through a separate inlet port. The recycled biocoke functions as a kinetic interface media within the plug-flow reactor, to catalyze or seed the formation of biocoke from the pyrolysis vapor.

The plug-flow reactor is operated continuously for 500 hours, and there is never a spatially continuous solid mass filled within the reactor, that would require shutting down the reactor and physically removing the solid mass of biocoke.

The biocoke product is determined to contain about 90 wt % fixed carbon according to ASTM D3172. The biocoke product is determined to contain 100% renewable carbon from a ¹⁴C/¹²C isotope measurement according to ASTM D6866.

The biocoke product can be utilized in a biocoke application, if desired, such as for foundry biocoke as a supporting matrix, a reducing agent, and/or an energy carrier.

### Example 7: Production of Biocoke from Bioliquid Obtained by Pyrolyzing Mixed Hardwood/Softwood

Wood chips containing a mix of hardwood and softwood are provided as a biomass feedstock. The average size of the wood chips is about 25 millimeters long, about 25 millimeters wide, and about 5 millimeters thick.

The biomass feedstock is pyrolyzed in a continuous pyrolysis reactor at a pyrolysis temperature of about 600° C. using a pyrolysis solid-phase residence time of about 30 minutes. The pyrolysis pressure is about 1 bar (atmospheric pressure) under an inert gas consisting essentially of N₂. There is a solid output (pyrolysis solids) and a vapor output (pyrolysis vapor) from the pyrolysis reactor. The pyrolysis vapor contains CO, CO₂, H₂O, and various alkanes, olefins, aromatics, aldehydes, ketones, acids, and alcohols. The pyrolysis solids containing carbon are collected in a hopper, and are in the form of granules with an average particle size of about 500 microns. In this example, the pyrolysis solids are not further used.

The pyrolysis vapor is sent to a two-stage condenser in order to condense out much of the water in a first condenser stage, and then to condense out a bioliquid in a second condenser stage. The vapor output of the first condenser stage, containing pyrolysis carbon-containing vapors including CO and CO₂, enters the second condenser stage. The vapor output of the second condenser stage contains a majority of the CO and CO₂, and potentially light hydrocarbons, such as methane, methanol, and acetic acid. The liquid output of the second condenser stage is the bioliquid to be converted to biocoke.

The bioliquid is continuously converted to biocoke in a kinetic interface reactor. The kinetic interface reactor is a continuous vertical fluidized-bed reactor. The bioliquid is fed into the fluidized-bed reactor. The kinetic interface reactor is operated at a temperature of about 1100° C., a pressure of about 4 bar, a liquid-phase residence time of about 45 minutes, and a solid-phase residence time of about 180 minutes. No additional coking catalyst is added to the kinetic interface reactor. The bioliquid reacts to form solid biocoke and an off-gas that for example contains water formed from oxygen and hydrogen content of the bioliquid. The carbon conversion of bioliquid to solids is about 80%, the carbon conversion of bioliquid to CO and CO₂ is about 10%, and about 10% of the bioliquid is unconverted and is part of a reactor off-gas stream (along with CO, CO₂, H₂O, etc.). The “carbon conversion of the carbon-containing liquid” is therefore about 80%.

The fluidized-bed reactor has an outlet for off-gas at the top of the reactor. The fluidized-bed reactor has an outlet for solid biocoke at the bottom of the reactor. The off-gas and solid biocoke continuously exit the fluidized-bed reactor. About 75% of the solid stream is continuously recovered as a biocoke product. The remaining 25% of the solid stream is continuously recycled to the kinetic interface reactor, entering into a side port on the fluidized-bed reactor. The recycled biocoke functions as a kinetic interface media within the fluidized-bed reactor, to catalyze or seed the formation of biocoke from the pyrolysis vapor.

The fluidized-bed reactor is operated continuously for 500 hours, and there is never a spatially continuous solid mass filled within the reactor, that would require shutting down the reactor and physically removing the solid mass of biocoke from the reactor bed.

The biocoke product is determined to contain about 95 wt % fixed carbon according to ASTM D3172. The biocoke product is determined to contain 100% renewable carbon from a ¹⁴C/¹²C isotope measurement according to ASTM D6866.

The biocoke product can be utilized in a biocoke application, if desired, such as for foundry biocoke as a supporting matrix, a reducing agent, and/or an energy carrier.

### Example 8: Production of Biocoke from Biogas Obtained by Pyrolyzing Mixed Hardwood/Softwood

Wood chips containing a mix of hardwood and softwood are provided as a biomass feedstock. The average size of the wood chips is about 25 millimeters long, about 25 millimeters wide, and about 5 millimeters thick.

The biomass feedstock is pyrolyzed in a continuous pyrolysis reactor at a pyrolysis temperature of about 600° C. using a pyrolysis solid-phase residence time of about 30 minutes. The pyrolysis pressure is about 1 bar (atmospheric pressure) under an inert gas consisting essentially of N₂. There is a solid output (pyrolysis solids) and a vapor output (pyrolysis vapor) from the pyrolysis reactor. The pyrolysis vapor contains CO, CO₂, H₂O, and various alkanes, olefins, aromatics, aldehydes, ketones, acids, and alcohols. The pyrolysis solids containing carbon are collected in a hopper, and are in the form of granules with an average particle size of about 500 microns. In this example, the pyrolysis solids are not further used.

The pyrolysis vapor is continuously converted to biocoke in a kinetic interface reactor. The kinetic interface reactor is a continuous fluidized-bed reactor. The pyrolysis vapor is fed into the fluidized-bed reactor at a bottom inlet port. The kinetic interface reactor is operated at a temperature of about 800° C., a pressure of about 2 bar, a vapor-phase residence time of about 10 minutes, and a solid-phase residence time of about 30 minutes. An additional coking catalyst is added to the kinetic interface reactor through a side port. The additional coking catalyst is a nickel-containing aluminosilicate catalyst. The additional coking catalyst enables a lower temperature and shorter residence time in the fluidized-bed reactor. Periodically, the additional coking catalyst can be regenerated by withdrawing it near the bottom of the fluidized-bed reactor, since the aluminosilicate catalyst has a higher density than the biocoke and will tend to fall toward the bottom.

The pyrolysis vapor reacts to form solid biocoke and an off-gas that for example contains water formed from oxygen and hydrogen content of the pyrolysis vapor. The carbon conversion of pyrolysis vapor to solids is about 90%, the carbon conversion of pyrolysis vapor to CO and CO₂ is about 8%, and about 2% of the pyrolysis vapor is unconverted and is part of the reactor off-gas stream (along with CO, CO₂, H₂O, etc.). The “carbon conversion of the carbon-containing vapor” is therefore about 90%.

The fluidized-bed reactor has an outlet for off-gas at the top of the reactor. The fluidized-bed reactor has an outlet for solid biocoke at the bottom of the reactor. The off-gas and solid biocoke continuously exit the fluidized-bed reactor. About 90% of the solid stream is continuously recovered as a biocoke product. The remaining 10% of the solid stream is continuously recycled to the kinetic interface reactor, entering into a side port on the fluidized-bed reactor, which is different than the coking-catalyst side port. The recycled biocoke functions as a kinetic interface media within the fluidized-bed reactor, to catalyze or seed the formation of biocoke from the pyrolysis vapor.

The fluidized-bed reactor is operated continuously for 500 hours, and there is never a spatially continuous solid mass filled within the reactor, that would require shutting down the reactor and physically removing the solid mass of biocoke from the reactor bed.

The biocoke product is determined to contain about 98 wt % fixed carbon according to ASTM D3172. The biocoke product is determined to contain 100% renewable carbon from a ¹⁴C/¹²C isotope measurement according to ASTM D6866.

The high-quality biocoke product can be utilized in a biocoke application, if desired, such as for foundry biocoke as a supporting matrix, a reducing agent, and/or an energy carrier.

I/We claim:

1. A continuous process for producing biocoke, the continuous process comprising:
providing a heated biogas stream, wherein the heated biogas stream comprises carbon-containing vapor;
introducing the heated biogas stream to a kinetic interface reactor;
converting, using the kinetic interface reactor, the carbon-containing vapor to solid biocoke;
continuously withdrawing the solid biocoke;
continuously returning a recycled portion of the solid biocoke to the kinetic interface reactor, wherein the recycled portion of the solid biocoke is a kinetic interface media comprised within the kinetic interface reactor; and
recovering the solid biocoke as a biocoke product, wherein the biocoke product comprises at least 75 wt % fixed carbon, and wherein total carbon within the biocoke product is at least 50% renewable as determined from a measurement of the ¹⁴C/¹²C isotopic ratio of the total carbon,
wherein the process does not result in a spatially continuous solid mass filled within the kinetic interface reactor.

2. The process of claim 1, further comprising generating the heated biogas stream by pyrolyzing a biomass feedstock, wherein the carbon-containing vapor is a pyrolysis vapor.

3. The process of claim 2, wherein the biomass feedstock comprises softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

4. The process of claim 1, wherein the carbon-containing vapor is selected from CO, CO₂, an alkane, an olefin, an aromatic, an aldehyde, a ketone, an acid, an alcohol, or a combination thereof.

5. The process of claim 1, wherein the kinetic interface media is in the form of pellets.

6. The process of claim 5, wherein the pellets are characterized by an average pellet effective diameter of at least about 1 millimeter to at most about 10 centimeters.

7. The process of claim 1, wherein the kinetic interface media is in the form of a powder.

8. The process of claim 7, wherein the powder is characterized by an average particle size of at least about 1 micron to at most about 500 microns.

9. The process of claim 1, wherein the kinetic interface media is in the form of granules.

10. The process of claim 9, wherein the granules are characterized by an average granule effective diameter of at least about 100 microns to at most about 10 millimeters.

11. The process of claim 1, wherein, during the converting, the solid biocoke forms on the surface of the kinetic interface media.

12. The process of claim 1, wherein, during the converting, the solid biocoke forms in an internal phase of the kinetic interface media.

13. The process of claim 1, wherein, during the converting, effective reaction conditions comprise a coking temperature of at least about 400° C. to at most about 1200° C.

14. The process of claim 1, wherein, during the converting, effective reaction conditions comprise a coking pressure of at least about 1 bar to at most about 40 bar.

15. The process of claim 1, wherein, during the converting, effective reaction conditions comprise a coking vapor-phase residence time of at least about 1 second to at most about 1 hour.

16. The process of claim 1, wherein, during the converting, effective reaction conditions comprise a coking solid-phase residence time of at least about 1 minute to at most about 24 hours.

17. The process of claim 1, wherein, during the converting, effective reaction conditions comprise a kinetic interface media residence time of at least about 1 minute to at most about 24 hours.

18. The process of claim 1, wherein, during the converting, effective reaction conditions comprise coking reactions that are seeded by the kinetic interface media as a reaction matrix.

19. The process of claim 1, wherein, during the converting, effective reaction conditions comprise coking reactions that are catalyzed by the kinetic interface media.

20. The process of claim 1, wherein, during the converting, effective reaction conditions comprise coking reactions that are catalyzed by a separate coking catalyst, other than the kinetic interface media, introduced to the kinetic interface reactor.

21. The process of claim 20, wherein the separate coking catalyst is continuously or periodically regenerated for reuse in the kinetic interface reactor.

22. The process of claim 1, wherein, during the converting, effective reaction conditions comprise uncatalyzed coking reactions that generate free biocoke particles from the carbon-containing vapor.

23. The process of claim 22, wherein the free biocoke particles do not become chemically or physically combined with the kinetic interface media.

24. The process of claim 22, wherein the free biocoke particles, after being formed, become chemically or physically combined with the kinetic interface media.

25. The process of claim 1, wherein, during the converting, carbon conversion of the carbon-containing vapor is at least 25%.

26. The process of claim 25, wherein, during the converting, the carbon conversion of the carbon-containing vapor is at least 50%.

27. The process of claim 25, wherein, during the converting, the carbon conversion of the carbon-containing vapor is at least 75%.

28. The process of claim 25, wherein, during the converting, the carbon conversion of the carbon-containing vapor is at least 90%.

29. The process of claim 1, further comprising recovering a kinetic interface reactor off-gas stream comprising unconverted carbon-containing vapor.

30. The process of claim 29, further comprising combusting the kinetic interface reactor off-gas stream, thereby generating energy.

31. The process of claim 30, further comprising utilizing the energy to heat a pyrolysis reactor, wherein the pyrolysis reactor is configured to provide the kinetic interface media, and wherein the kinetic interface media comprises a pyrolyzed form of a first biomass feedstock.

32. The process of claim 29, further comprising partially oxidizing the kinetic interface reactor off-gas stream, thereby generating a reducing gas.

33. The process of claim 1, wherein the kinetic interface reactor is a fluidized-bed reactor.

34. The process of claim 1, wherein the kinetic interface reactor is a falling-bed reactor.

35. The process of claim 1, wherein the kinetic interface reactor is a gravity-driven vessel.

36. The process of claim 1, wherein the kinetic interface reactor is a vertical vessel or a slanted vessel.

37. The process of claim 1, wherein the kinetic interface reactor is a horizontal vessel.

38. The process of claim 1, wherein the kinetic interface reactor is a rotary kiln, and optionally wherein the rotary kiln is configured such that the kinetic interface media tumbles radially and the heated biogas stream flows axially.

39. The process of claim 1, wherein the kinetic interface reactor is configured with a mechanical conveyor.

40. The process of claim 39, wherein the mechanical conveyor is selected from a screw conveyor, a belt conveyor, a chain conveyor, a continuous-flow conveyor, or a recirculating conveyor.

41. The process of claim 1, wherein the biocoke product comprises at least about 80 wt % fixed carbon.

42. The process of claim 1, wherein the biocoke product comprises at least about 90 wt % fixed carbon.

43. The process of claim 1, wherein the biocoke product comprises at least about 95 wt % fixed carbon.

44. The process of claim 1, wherein the biocoke product comprises at least about 99 wt % fixed carbon.

45. The process of claim 1, wherein total carbon within the biocoke product is at least about 75% renewable as determined from a measurement of the ¹⁴C/¹²C isotopic ratio of the total carbon.

46. The process of claim 1, wherein total carbon within the biocoke product is at least about 90% renewable as determined from a measurement of the ¹⁴C/¹²C isotopic ratio of the total carbon.

47. The process of claim 1, wherein total carbon within the biocoke product is fully renewable as determined from a measurement of the ¹⁴C/¹²C isotopic ratio of the total carbon.

48. The process of claim 1, wherein the biocoke product comprises essentially no ash.

49. The process of claim 1, wherein in the recovering, the solid biocoke and the kinetic interface media are separated from each other.

50. The process of claim 1, further comprising adding a carbonization agent, wherein the carbonization agent comprises a metal, metal alloy, metal oxide, metal hydroxide, metal hydride, metal sulfide, metal nitride, metal halide, metal salt, mineral, natural polymer, synthetic polymer, acid, base, metal salt, non-metal salt, organic halide, inorganic halide, or a derivative or a combination thereof.

51. A continuous process for producing biocoke, the continuous process comprising:
providing a bioliquid stream, wherein the bioliquid stream comprises carbon-containing liquid;
introducing the bioliquid stream to a kinetic interface reactor;
converting, using the kinetic interface reactor, the carbon-containing liquid to solid biocoke;
continuously withdrawing the solid biocoke;
continuously returning a recycled portion of the solid biocoke to the kinetic interface reactor, wherein the recycled portion of the solid biocoke is a kinetic interface media comprised within the kinetic interface reactor; and
recovering the solid biocoke as a biocoke product, wherein the biocoke product contains at least 75 wt % fixed carbon, and wherein total carbon within the biocoke product is at least 50% renewable as determined from a measurement of the ¹⁴C/¹²C isotopic ratio of the total carbon,
wherein the process does not result in a spatially continuous solid mass filled within the kinetic interface reactor.

52. The process of claim 51, further comprising generating the bioliquid stream by pyrolyzing a biomass feedstock, wherein the carbon-containing liquid is a condensed pyrolysis vapor.

53. The process of claim 52, wherein the biomass feedstock comprises softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, walnut shells, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

54. The process of claim 51, wherein the bioliquid stream comprises one or more alkanes, olefins, aromatics, aldehydes, ketones, acids, alcohols, or a combination thereof.

55. The process of claim 51, wherein the kinetic interface media is in the form of pellets.

56. The process of claim 55, wherein the pellets are characterized by an average pellet effective diameter of at least about 1 millimeter to at most about 10 centimeters.

57. The process of claim 51, wherein the kinetic interface media is in the form of a powder.

58. The process of claim 57, wherein the powder is characterized by an average particle size of at least about 1 micron to at most about 500 microns.

59. The process of claim 51, wherein the kinetic interface media is in the form of granules.

60. The process of claim 59, wherein the granules are characterized by an average granule effective diameter of at least about 100 microns to at most about 10 millimeters.

61. The process of claim 51, wherein, during the converting, the solid biocoke forms on the surface of the kinetic interface media.

62. The process of claim 51, wherein, during the converting, the solid biocoke forms in an internal phase of the kinetic interface media.

63. The process of claim 51, wherein, during the converting, effective reaction conditions comprise a coking temperature of at least about 400° C. to at most about 1200° C.

64. The process of claim 51, wherein, during the converting, effective reaction conditions comprise a coking pressure of at least about 1 bar to at most about 40 bar.

65. The process of claim 51, wherein, during the converting, effective reaction conditions comprise a coking liquid-phase residence time of at least about 1 minute to at most about 1 hour.

66. The process of claim 51, wherein, during the converting, effective reaction conditions comprise a coking solid-phase residence time of at least about 1 minute to at most about 24 hours.

67. The process of claim 51, wherein, during the converting, effective reaction conditions comprise a kinetic interface media residence time of at least about 1 minute to at most about 24 hours.

68. The process of claim 51, wherein, during the converting, effective reaction conditions comprise coking reactions that are seeded by the kinetic interface media as a reaction matrix.

69. The process of claim 51, wherein, during the converting, effective reaction conditions comprise coking reactions that are catalyzed by the kinetic interface media.

70. The process of claim 51, wherein, during the converting, effective reaction conditions comprise coking reactions that are catalyzed by a separate coking catalyst, other than the kinetic interface media, introduced to the kinetic interface reactor.

71. The process of claim 70, wherein the separate coking catalyst is continuously or periodically regenerated for reuse in the kinetic interface reactor.

72. The process of claim 51, wherein, during the converting, effective reaction conditions comprise uncatalyzed coking reactions that generate free biocoke particles from the carbon-containing liquid.

73. The process of claim 72, wherein the free biocoke particles do not become chemically or physically combined with the kinetic interface media.

74. The process of claim 72, wherein the free biocoke particles, after being formed, become chemically or physically combined with the kinetic interface media.

75. The process of claim 51, wherein, during the converting, carbon conversion of the carbon-containing liquid is at least 25%.

76. The process of claim 51, wherein, during the converting, the carbon conversion of the carbon-containing liquid is at least 50%.

77. The process of claim 51, wherein, during the converting, the carbon conversion of the carbon-containing liquid is at least 75%.

78. The process of claim 51, wherein, during the converting, the carbon conversion of the carbon-containing liquid is at least 90%.

79. The process of claim 51, further comprising recovering unconverted carbon-containing liquid.

80. The process of claim 79, further comprising combusting the unconverted carbon-containing liquid, thereby generating energy.

81. The process of claim 80, further comprising utilizing the energy to heat a pyrolysis reactor, wherein the pyrolysis reactor is configured to provide the kinetic interface media.

82. The process of claim 79, further comprising partially oxidizing the unconverted carbon-containing liquid, thereby generating a reducing gas.

83. The process of claim 51, wherein the kinetic interface reactor is a fluidized-bed reactor.

84. The process of claim 51, wherein the kinetic interface reactor is a falling-bed reactor.

85. The process of claim 51, wherein the kinetic interface reactor is a gravity-driven vessel.

86. The process of claim 51, wherein the kinetic interface reactor is a vertical vessel or a slanted vessel.

87. The process of claim 51, wherein the kinetic interface reactor is a horizontal vessel.

88. The process of claim 51, wherein the kinetic interface reactor is a rotary kiln, and optionally wherein the rotary kiln is configured such that the kinetic interface media tumbles radially and the heated biogas stream flows axially.

89. The process of claim 51, wherein the kinetic interface reactor is configured with a mechanical conveyor.

90. The process of claim 89, wherein the mechanical conveyor is selected from a screw conveyor, a belt conveyor, a chain conveyor, a continuous-flow conveyor, or a recirculating conveyor.

91. The process of claim 51, wherein the biocoke product comprises at least about 80 wt % fixed carbon.

92. The process of claim 51, wherein the biocoke product comprises at least about 90 wt % fixed carbon.

93. The process of claim 51, wherein the biocoke product comprises at least about 95 wt % fixed carbon.

94. The process of claim 51, wherein the biocoke product comprises at least about 99 wt % fixed carbon.

95. The process of claim 51, wherein total carbon within the biocoke product is at least about 75% renewable as determined from a measurement of the ¹⁴C/¹²C isotopic ratio of the total carbon.

96. The process of claim 51, wherein total carbon within the biocoke product is at least about 90% renewable as determined from a measurement of the ¹⁴C/¹²C isotopic ratio of the total carbon.

97. The process of claim 51, wherein total carbon within the biocoke product is fully renewable as determined from a measurement of the ¹⁴C/¹²C isotopic ratio of the total carbon.

98. The process of claim 51, wherein the biocoke product comprises essentially no ash.

99. The process of claim 51, wherein in the recovering, the solid biocoke and the kinetic interface media are separated from each other.

100. The process of claim 51, further comprising adding a carbonization agent, wherein the carbonization agent comprises a metal, metal alloy, metal oxide, metal hydroxide, metal hydride, metal sulfide, metal nitride, metal halide, metal salt, mineral, natural polymer, synthetic polymer, acid, base, metal salt, non-metal salt, organic halide, inorganic halide, or a derivative or a combination thereof.

101. A biocoke product produced by a continuous process comprising:
providing a heated biogas stream, wherein the heated biogas stream comprises carbon-containing vapor;
introducing the heated biogas stream to a kinetic interface reactor;
converting, using the kinetic interface reactor, the carbon-containing vapor to solid biocoke;
continuously withdrawing the solid biocoke;
continuously returning a recycled portion of the solid biocoke to the kinetic interface reactor, wherein the recycled portion of the solid biocoke is a kinetic interface media contained within the kinetic interface reactor; and
recovering the solid biocoke as a biocoke product, wherein the biocoke product comprises at least 75 wt % fixed carbon, and wherein total carbon within the biocoke product is at least 50% renewable as determined from a measurement of the ¹⁴C/¹²C isotopic ratio of the total carbon,
wherein the process does not result in a spatially continuous solid mass filled within the kinetic interface reactor.

102. A biocoke product produced by a continuous process comprising:
providing a bioliquid stream, wherein the bioliquid stream comprises carbon-containing liquid;
introducing the bioliquid stream to a kinetic interface reactor;
converting, using the kinetic interface reactor, the carbon-containing liquid to solid biocoke;
continuously withdrawing the solid biocoke;
continuously returning a recycled portion of the solid biocoke to the kinetic interface reactor, wherein the recycled portion of the solid biocoke is a kinetic interface media comprised within the kinetic interface reactor; and
recovering the solid biocoke as a biocoke product, wherein the biocoke product contains at least 75 wt % fixed carbon, and wherein total carbon within the biocoke product is at least 50% renewable as determined from a measurement of the ¹⁴C/¹²C isotopic ratio of the total carbon,
wherein the process does not result in a spatially continuous solid mass filled within the kinetic interface reactor.

103. A system for continuously producing biocoke, wherein the system comprises a kinetic interface reactor, wherein the kinetic interface reactor comprises a first inlet configured for feeding a heated biogas stream and/or a bioliquid stream into the kinetic interface reactor, wherein the heated biogas stream comprises a carbon-containing vapor, and wherein the bioliquid stream comprises a carbon-containing liquid, wherein the kinetic interface reactor is configured to operate under effective reaction conditions to convert the carbon-containing vapor and/or the carbon-containing liquid to solid biocoke, wherein the kinetic interface reactor comprises a first outlet configured for continuously or semi-continuously withdrawing the solid biocoke, wherein the kinetic interface reactor comprises a second inlet configured for feeding at least some of the solid biocoke that was withdrawn from the outlet, and wherein the first outlet, or a second outlet, is configured for withdrawing and recovering a biocoke product.

104. The system of claim 103, wherein the kinetic interface reactor is a fluidized-bed reactor.

105. The system of claim 103, wherein the kinetic interface reactor is a falling-bed reactor.

106. The system of claim 103, wherein the kinetic interface reactor is a gravity-driven vessel.

107. The system of claim 103, wherein the kinetic interface reactor is a vertical vessel or a slanted vessel.

108. The system of claim 103, wherein the kinetic interface reactor is a horizontal vessel.

109. The system of claim 103, wherein the kinetic interface reactor is a rotary kiln.

110. The system of claim 109, wherein the rotary kiln is configured such that the kinetic interface media tumbles radially and the heated biogas stream and/or the bioliquid stream flows axially.

111. The system of claim 103, wherein the system is configured with a mechanical conveyor to feed the kinetic interface media into and/or through the kinetic interface reactor.

112. The system of claim 111, wherein the mechanical conveyor is a screw conveyor.

113. The system of claim 111, wherein the mechanical conveyor is a belt conveyor.

114. The system of claim 111, wherein the mechanical conveyor is a chain conveyor.

115. The system of claim 111, wherein the mechanical conveyor is a continuous-flow conveyor.

116. The system of claim 111, wherein the mechanical conveyor is a recirculating conveyor.
